(19) United States
(12) Patent Application Publication
(10) Pub. No.: US 2009/0286078 A1
(43) Pub. Date: Nov. 19, 2009

(54) POLYIMIDES DOPE COMPOSITION, PREPARATION METHOD OF HOLLOW FIBER USING THE SAME AND HOLLOW FIBER PREPARED THEREFROM

(75) Inventors: Young-Moo LEE, Seoul (KR); Sang-Hoon Han, Seoul (KR); Chul-Ho Jung, Gwangju (KR); Ho-Bum Park, Ulsan (KR)

Correspondence Address: LEXYOUME IP GROUP, LLC, 5180 PARKSTONE DRIVE, SUITE 175, CHANTILLY, VA, 20151, US

(73) Assignee: Industry-University Cooperation Foundation, HANYANG UNIVERSITY, Seoul (KR)

(21) Appl. No.: 12/248,334

(22) Filed: Oct. 9, 2008

(30) Foreign Application Priority Data
May 19, 2008 (KR) 10-2008-0046127

(51) Int. Cl. D01F 8/00; D01D 5/06; C08G 73/10; D01D 5/24

(52) U.S. Cl. 428/364; 264/205; 264/184; 524/606

(57) ABSTRACT

Disclosed herein are a polyimide dope solution composition, a method for preparing a hollow fiber using the composition and a hollow fiber prepared by the method. More specifically, disclosed are a method for preparing a hollow fiber, comprising preparing a polyimide dope solution composition comprising polyhydroxyimide, polythiolimide or polyaminoimide, spinning the composition to prepare a hollow fiber, and thermally rearranging the hollow fiber, and the hollow fiber prepared by the method.

In accordance with the method, a hollow fiber made of a high free volume polymer membrane can be prepared by spinning the dope solution composition to prepare a hollow fiber and thermally rearranging the hollow fiber via thermal treatment. The hollow fiber thus prepared exhibits excellent gas permeability and selectivity, thus being suitable for use as a gas separation membrane.

### CROSS-REFERENCE TO RELATED APPLICATION

This application claims priority to and the benefit of Korean Patent Application No. 10-2008-0046127 filed in the Korean Intellectual Property Office on May 19, 2008, the entire contents of which are incorporated herein by reference.

### BACKGROUND OF THE INVENTION

(a) Field of the Invention

The present invention relates to a polyimide dope solution composition, a method for preparing a hollow fiber using the same and a hollow fiber prepared by the method. More specifically, the present invention relates to a dope solution composition to prepare hollow fibers that have well-connected microcavities and are thus applicable to gas separation membranes for separating various types of gases via thermal rearrangement, a method for preparing hollow fibers from the composition and hollow fibers prepared by the method.

(b) Description of the Related Art

Separation membranes must satisfy the requirements of superior thermal, chemical and mechanical stability, high permeability and high selectivity so that they can be commercialized and then applied to a variety of industries. The term “permeability” used herein is defined as a rate at which a substance permeates through a separation membrane. The term “selectivity” used herein is defined as a permeation ratio between two different gas components.

Based on the separation performance, separation membranes may be classified into reverse osmosis membranes, ultrafiltration membranes, microfiltration membranes, gas separation membranes, etc. Based on the shape, separation membranes may be largely classified into flat sheet membranes, spiral-wound membranes, composite membranes and hollow fiber membranes. Of these, asymmetric hollow fiber membranes have the largest membrane areas per unit volume and are thus generally used as gas separation membranes.

A process for separating a specific gas component from various ingredients constituting a gas mixture is greatly important. This gas separation process generally employs a membrane process, a pressure swing adsorption process, a cryogenic process and the like. Of these, the pressure swing adsorption process and the cryogenic process are generalized techniques, design and operations methods of which have already been developed, and are now in widespread use. On the other hand, gas separation using the membrane process has a relatively short history.

The gas separation membrane for membrane process application is used to separate and concentrate various gases, e.g., hydrogen (H₂), helium (He), nitrogen (N₂), oxygen (O₂), carbon monoxide (CO), carbon dioxide (CO₂), water vapor (H₂O), ammonia (NH₃), sulfur compounds (SOₓ) and light hydrocarbon gases such as methane (CH₄), ethane (C₂H₆), ethylene (C₂H₄), propane (C₃H₈), propylene (C₃H₆), butane (C₄H₁₀), butylene (C₄H₈). Gas separation may be used in the fields including separation of oxygen or nitrogen present in air, removal of moisture present in compressed air and the like.

The principle for the gas separation using membranes is based on the difference in permeability between respective components constituting a mixture of two or more gases. The gas separation involves a solution-diffusion process, in which a gas mixture comes in contact with a surface of a membrane and at least one component thereof is selectively dissolved. Inside the membrane, selective diffusion occurs. The gas component which permeates the membrane is more rapid than at least one of other components.

Gas components having a relatively low permeability pass through the membrane at a speed lower than at least one component. Based upon such a principle, the gas mixture is divided into two flows, i.e., a selectively permeated gas-containing flow and a non-permeated gas-containing flow. Accordingly, in order to suitably separate gas mixtures, there is a demand for techniques to select a membrane-forming material having high perm-selectivity to a specific gas ingredient and to control the material to have a structure capable of exhibiting sufficient permeability.

In order to selectively separate gases and concentrate the same through the membrane separation method, the separation membrane must generally have an asymmetric structure comprising a dense selective-separation layer arranged on the surface of the membrane and a porous supporter with a minimum permeation resistance arranged on the bottom of the membrane. One membrane property, i.e., selectivity, is determined depending upon the structure of the selective-separation layer. Another membrane property, i.e., permeability, depends on the thickness of the selective-separation layer and the porosity level of the lower structure, i.e., the porous supporter of the asymmetric membrane. Furthermore, to selectively separate a mixture of gases, the separation layer must be free from surface defects and have a pore size not more than 5 Å.

Since a system using a gas separation membrane module was developed in 1977 by the Monsanto Company under the trade name “Prism”, gas separation processes using polymer membranes has been first available commercially. The gas separation process has shown a gradual increase in annual gas separation market share due to low energy consumption and low installation cost, as compared to conventional methods.

Since a cellulose acetate semi-permeation membrane having an asymmetric structure as disclosed in U.S. Pat. No. 3,133,132 was developed, a great deal of research has been conducted on polymeric membranes and various polymers are being prepared into hollow fibers using phase inversion methods.

General methods for preparing asymmetric hollow fiber membranes using phase-inversion are wet-spinning and dry-jet-wet spinning. A representative hollow fiber preparation process using dry-jet-wet spinning comprises the following four steps, (1) spinning hollow fibers with a polymeric dope solution, (2) bringing the hollow fibers into contact with air to evaporate volatile ingredients therefrom, (3) precipitating the resulting fibers in a coagulation bath, and (4) subjecting the fibers to post-treatment including washing, drying and the like.

Organic polymers such as polysulfones, polycarbonates, polypyrrolones, polyarylates, cellulose acetates and polyimides are widely used as hollow fiber membrane materials for gas separation. Various attempts have been made to impart permeability and selectivity for a specific gas to polyimide membranes having superior chemical and thermal stability among these polymer materials for gas separation. However, in general polymeric membrane, permeability and selectivity are inversely proportional.

For example, U.S. Pat. No. 4,880,442 discloses polyimide membranes wherein a large free volume is imparted to polymeric chains and permeability is improved using non-rigid anhydrides. Furthermore, U.S. Pat. No. 4,717,393 discloses crosslinked polyimide membranes exhibiting high gas selectivity and superior stability, as compared to conventional polyimide gas separation membranes. In addition, U.S. Pat. Nos. 4,851,505 and 4,912,197 disclose polyimide gas separation membranes capable of reducing the difficulty of polymer processing due to superior solubility in generally-used solvents. In addition, PCT Publication No. WO 2005/007277 discloses defect-free asymmetric membranes comprising polyimide and another polymer selected from the group consisting of polyvinylpyrrolidones, sulfonated polyetheretherketones and mixtures thereof.

However, polymeric materials having membrane performance available commercially for use in gas separation (in the case of air separation, oxygen permeability is 1 Barrer or higher, and oxygen/nitrogen selectivity is 6.0 or higher) are limited to only a few types. This is because there is considerable limitation in improving polymeric structures, and great compatibility between permeability and selectivity makes it difficult to obtain separation and permeation capabilities beyond a predetermined upper limit.

Furthermore, conventional polymeric membrane materials have a limitation of permeation and separation properties and disadvantages in that they undergo decomposition and aging upon a long-term exposure to high pressure and high temperature processes or to gas mixtures containing hydrocarbon, aromatic and polar solvents, thus causing a considerable decrease in inherent membrane performance. Due to these problems, in spite of their high economic value, gas separation processes are utilized in considerably limited applications to date.

Accordingly, there is an increasing demand for development of polymeric materials capable of achieving both high permeability and superior selectivity, and novel gas separation membranes using the same.

In accordance with such demand, a great deal of research has been conducted to modify polymers into ideal structures that exhibit superior gas permeability and selectivity, and have a desired pore size. As a result of this research, polymeric membranes having superior gas separation performance have remarkably developed.

For example, nanocomposites, hydride materials and composite polymers have been designed, taking into the consideration the fact that the high free volumes of polymers should be imparted to these materials.

In addition, a method for obtaining medium and small pore size distribution has been recently reported [H. B. Park, C. H. Jung, Y. M. Lee, A. J. Hill, S. J. Pas, S. T. Mudie, E. Van Wagner, B. D. Freeman, D. J. Cookson, Polymers with cavities tuned for fast selective transport of small molecules and ions, Science 2007, 318, 254. 38].

The inventors of the present invention suggested that completely aromatic, insoluble, infusible polybenzoxazole (TR-α-PBO) membranes can be prepared by thermally modifying ortho-hydroxyl group-containing polyimide aromatic polymers through thermal rearrangement to molecular rearrangement at 350 to 450° C. [H. B. Park, C. H. Jung, Y. M. Lee, A. J. Hill, S. J. Pas, S. T. Mudie, E. Van Wagner, B. D. Freeman, D. J. Cookson, Polymers with cavities tuned for fast selective transport of small molecules and ions, Science 2007, 318, 254. 38].

TR-A-PBO membranes have advantages of excellent gas separation performance and superior chemical stability and mechanical properties from intramolecular and intermolecular thermal rearrangement, surpassing the limitations of typical polymeric membranes (i.e., the Robeson's upper bound). [L. M. Robeson, Correlation of separation factor versus permeability for polymeric membrane, J. Membr. Sci., 1991, 62, 165, L. M. Robeson, The upper bound revisited, J. Membr. Sci., 2008, 320, 390].

Furthermore, through research on methods for improving gas permeability, the present inventors have disclosed polymer structures acting as permeable sites and suggested polyimide-polybenzoxazole copolymers in which these polymer structures are incorporated in polyimide backbones (PCT/KR2008/001282).

As a result of subsequent diverse research on methods for preparing hollow fibers for gas separation from these polymers, the present inventors have established a novel process. Based on the process, the present invention was completed.

### SUMMARY OF THE INVENTION

Therefore, it is one object of the present invention to provide a dope solution composition suitable for use in preparing hollow fibers made of high free volume polymers by thermally rearranging polyimide hollow fiber via thermal treatment.

It is another object of the present invention to provide a method for preparing hollow fibers with superior gas permeability and selectivity, by preparing polyimide hollow fibers from the dope solution composition, followed by thermal treatment.

It is another object of the present invention to provide hollow fibers that have microcavities, increased polymer backbone strength and high fractional free volumes, thus exhibiting superior gas permeability and selectivity.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a cross-section scanning electron microscope (SEM) image of a hollow fiber prepared in Example 1 of the present invention at 150× magnification;

FIG. 2 is a cross-section scanning electron microscope (SEM) image of a hollow fiber prepared in Example 1 of the present invention at 700× magnification;

FIG. 3 is a cross-section scanning electron microscope (SEM) image of a hollow fiber prepared in Example 1 of the present invention at 2,500× magnification;

FIG. 4 is a cross-section scanning electron microscope (SEM) image of a hollow fiber prepared in Example 8 of the present invention at 100× magnification;

FIG. 5 is a cross-section scanning electron microscope (SEM) image of a hollow fiber prepared in Example 8 of the present invention at 1,000× magnification;

FIG. 6 is a cross-section scanning electron microscope (SEM) image of a sponge-type hollow fiber prepared in Example 8 of the present invention at 5,000× magnification;

FIG. 7 is a graph comparing oxygen permeability (GPU) and oxygen/nitrogen selectivity for hollow fibers prepared in Examples 1 to 18 of the present invention and Comparative Examples 1 to 3 (the numbers 1′ to 3′ indicate Comparative Examples 1 to 3, respectively; and the numbers 1 to 18 indicate Examples 1 to 18, respectively); and

FIG. 8 is a graph comparing carbon dioxide permeability (GPU) and carbon dioxide/methane selectivity for hollow fibers prepared in Examples 1 to 18 of the present invention and Comparative Examples 1 to 3 (the numbers 1′ to 3′ indicate Comparative Examples 1 to 3, respectively; and the numbers 1 to 18 indicate Examples 1 to 18, respectively).

### DETAILED DESCRIPTION OF THE INVENTION

Hereinafter, the present invention will be illustrated in more detail.

In one aspect, the present invention is directed to a dope solution composition comprising: (a) a polymer for forming a hollow fiber, including one selected from the group consisting of polyimides represented by the following Formulae 1 to 4, polyimide copolymers represented by Formulae 5 to 18, copolymers thereof and blends thereof; (b) an organic solvent; and (c) an additive.

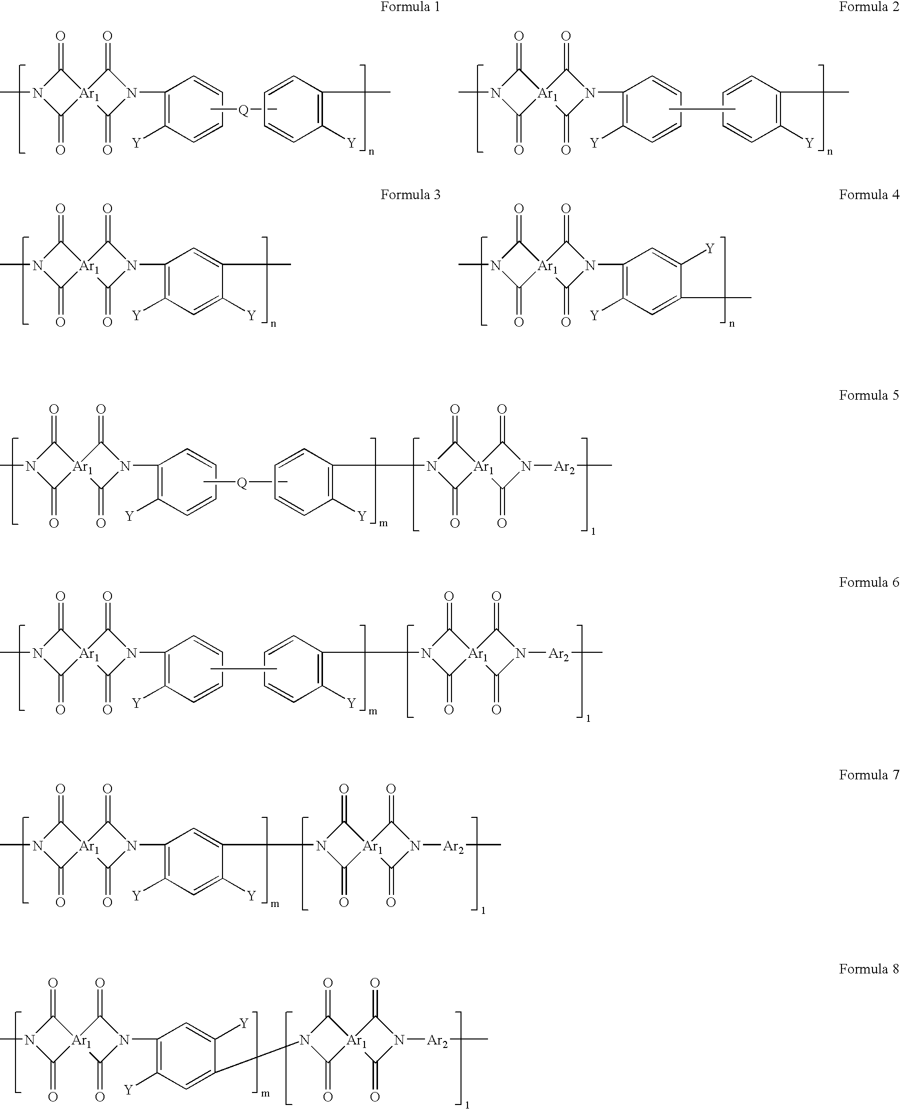

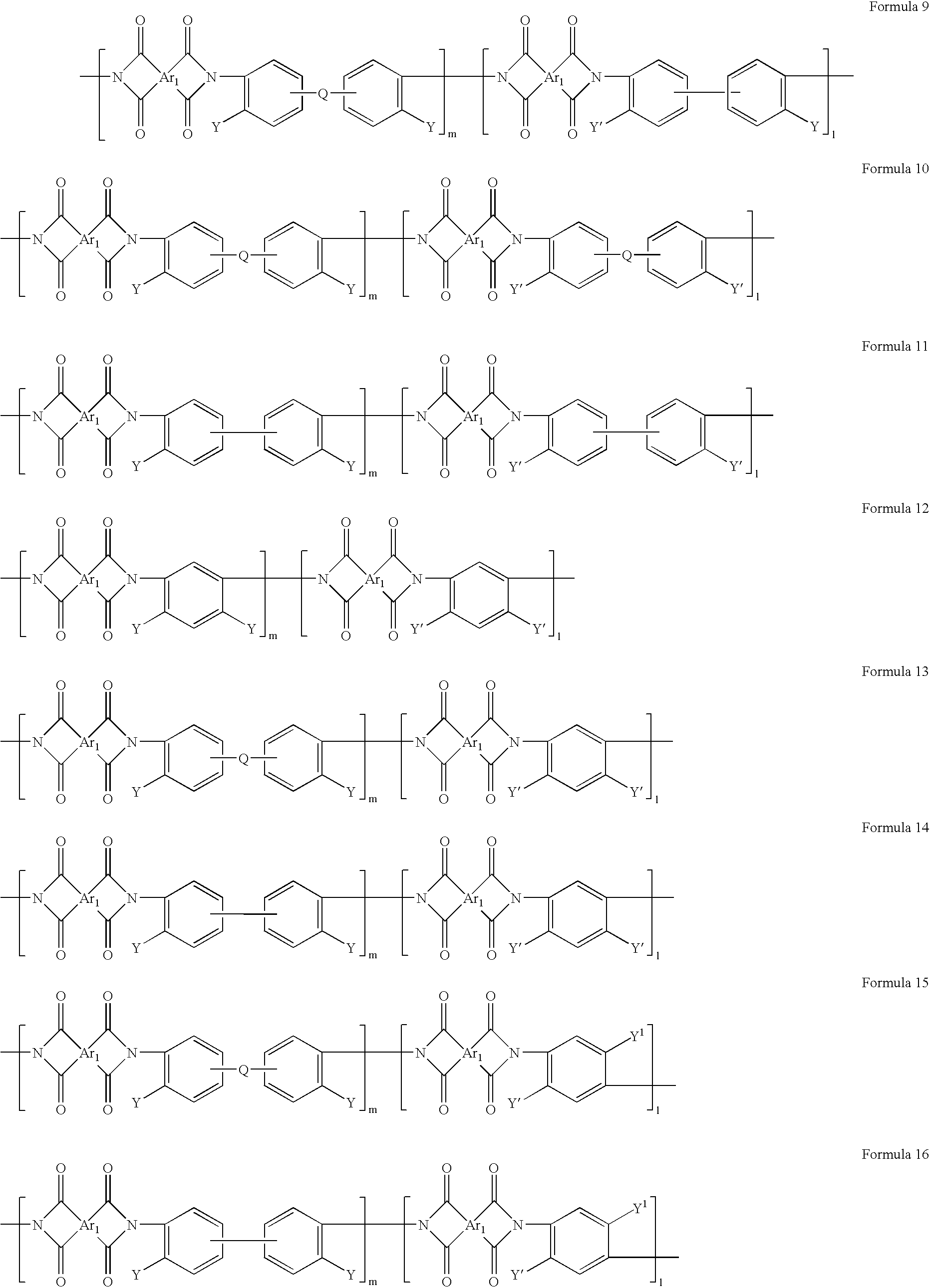

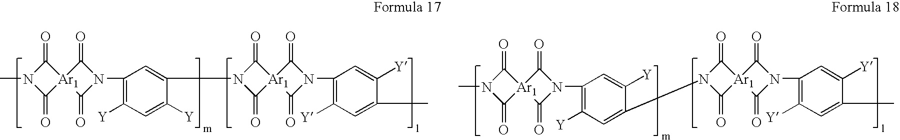

In Formulae 1 to 18,

Ar₁ is a tetravalent C₅-C₂₄ arylene group or a tetravalent C₅-C₂₄ heterocyclic ring, which is substituted or unsubstituted with at least one substituent selected from the group consisting of C₁-C₁₀ alkyl, C₁-C₁₀ alkoxy, C₁-C₁₀ haloalkyl and C₁-C₁₀ haloalkoxy, or two or more of which are fused together to form a condensation ring or covalently bonded to each other via a functional group selected from the group consisting of O, S, C(═O), CH(OH), S(═O)₂, Si(CH₃)₂, (CH₂)ₚ (in which 1≦p≦10), (CF₂)_{q} (in which 1≦q≦10), C(CH₃)₂, C(CF₃)₂ and C(═O)NH;

Ar₂ is a bivalent C₅-C₂₄ arylene group or a bivalent C₅-C₂₄ heterocyclic ring, which is substituted or unsubstituted with at least one substituent selected from the group consisting of C₁-C₁₀ alkyl, C₁-C₁₀ alkoxy, C₁-C₁₀ haloalkyl and C₁-C₁₀ haloalkoxy, or two or more of which are fused together to form a condensation ring or covalently bonded to each other via a functional group selected from the group consisting of O, S, C(═O), CH(OH), S(═O)₂, Si(CH₃)₂, (CH₂)ₚ (in which 1≦p≦10), (CF₂)_{q} (in which 1≦q≦10), C(CH₃)₂, C(CF₃)₂ and C(═O)NH;

Q is O, S, C(═O), CH(OH), S(═O)₂, Si(CH₃)₂, (CH₂)ₚ (in which 1≦p≦110), (CF₂)_{q} (in which 1≦q≦10), C(CH₃)₂, C(CF₃)₂, C(═O)NH, C(CH₃)(CF₃), C₁-C₆ alkyl-substituted phenyl or C₁-C₆ haloalkyl-substituted phenyl in which Q is linked to opposite both phenyl rings in the position of m-m, m-p, p-m or p-p;

Y is —OH, —SH or —NH₂;

Y′ is different from Y and is —OH, —SH or —NH₂;

n is an integer from 20 to 200;

m is an integer from 10 to 400; and

l is an integer from 10 to 400.

Ar₁ and Ar₂ may be the same arylene or heterocyclic ring.

Preferably, Ar₁ is selected from the following compounds and the linkage position thereof includes all of o-, m- and p-positions.

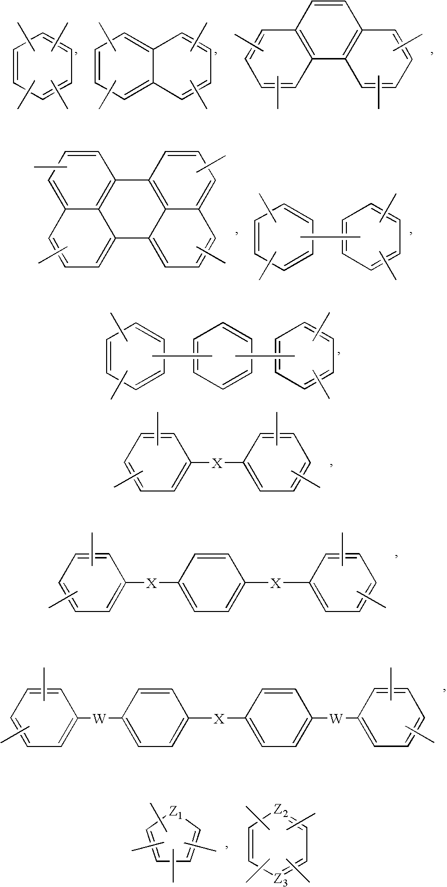

wherein X is O, S, C(═O), CH(OH), S(═O)₂, Si(CH₃)₂, (CH₂)ₚ (in which 1≦p≦110), (CF₂)_{q} (in which 1≦q≦10), C(CH₃)₂, C(CF₃)₂, or C(═O)NH; W is O, S or C(═O); and Z₁, Z₂ and Z₃ are identical to or different from each other and are O, N or S.

More preferably, Ar₁ is selected from the following compounds:

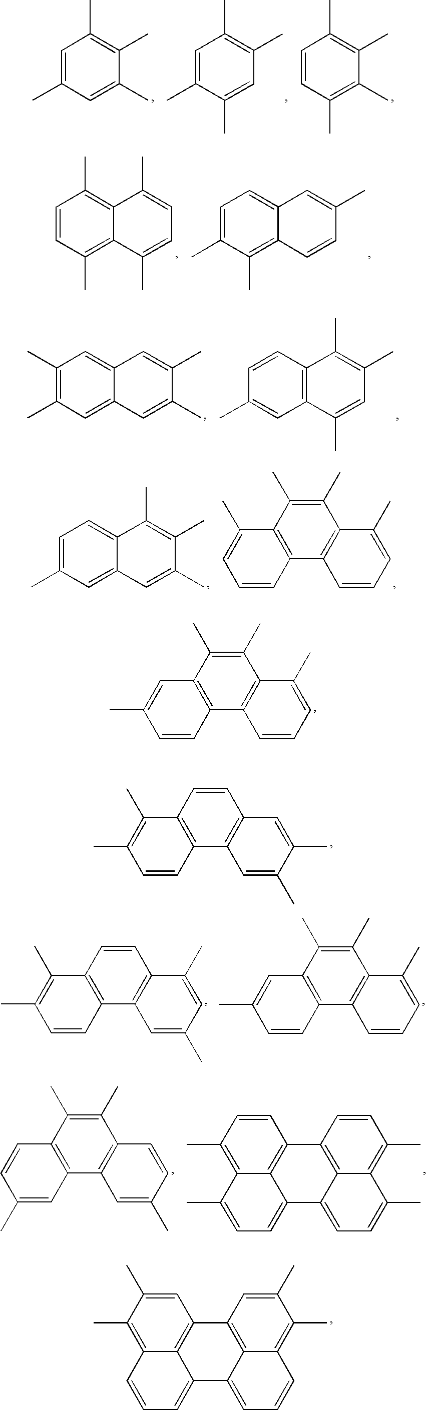

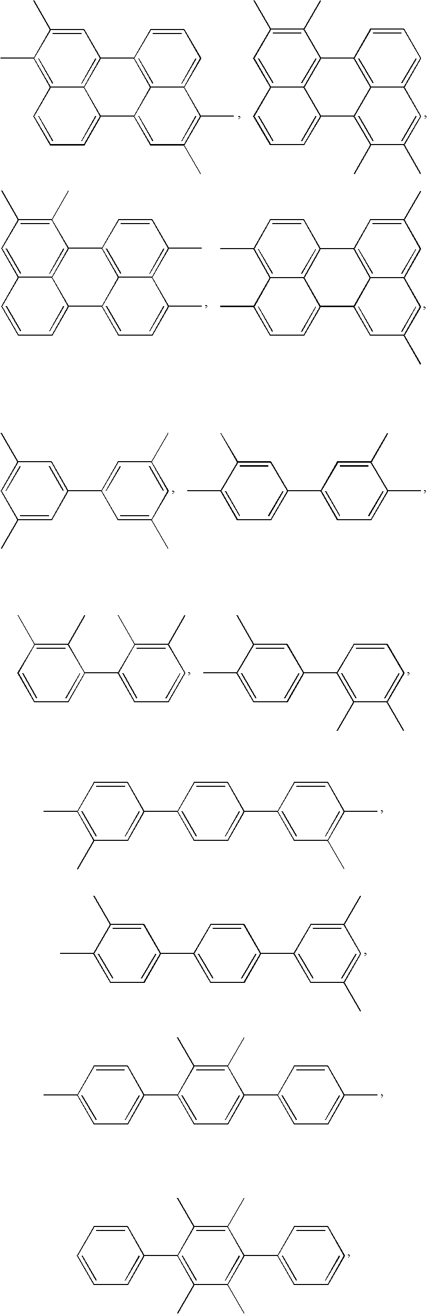

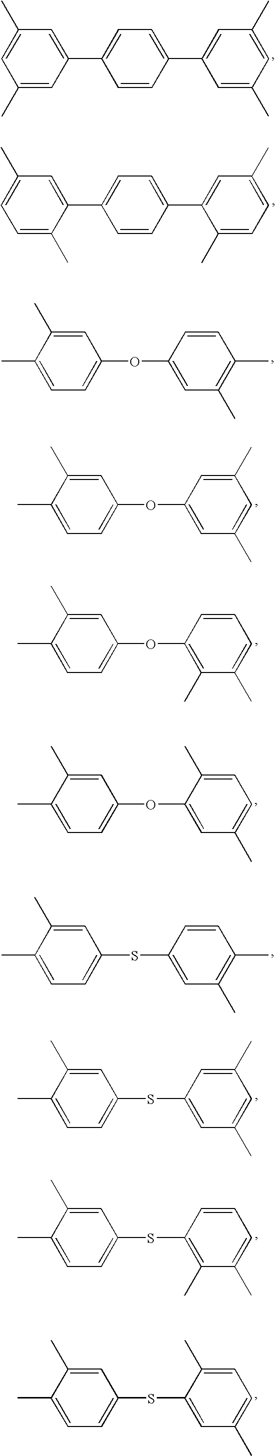

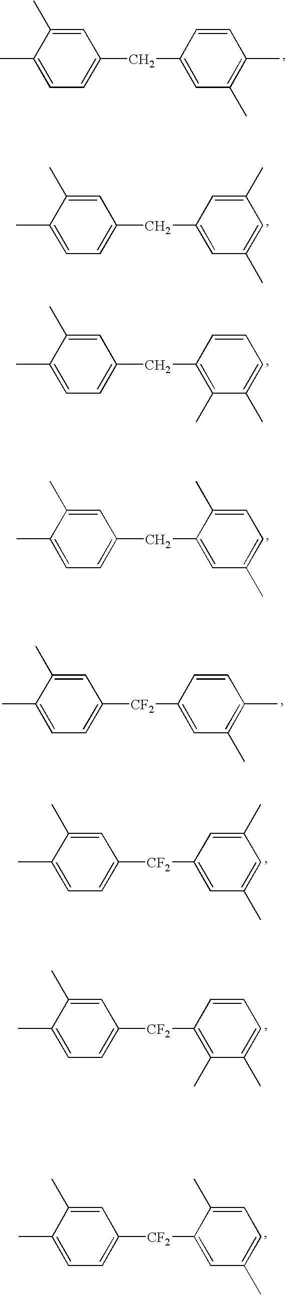

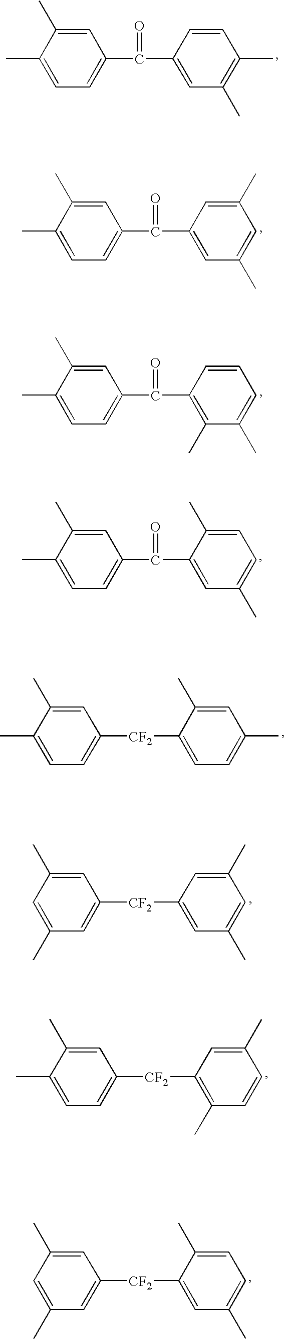

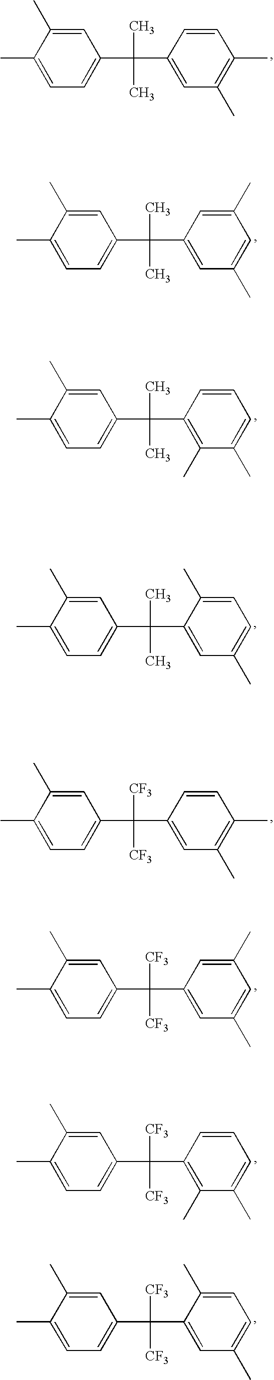

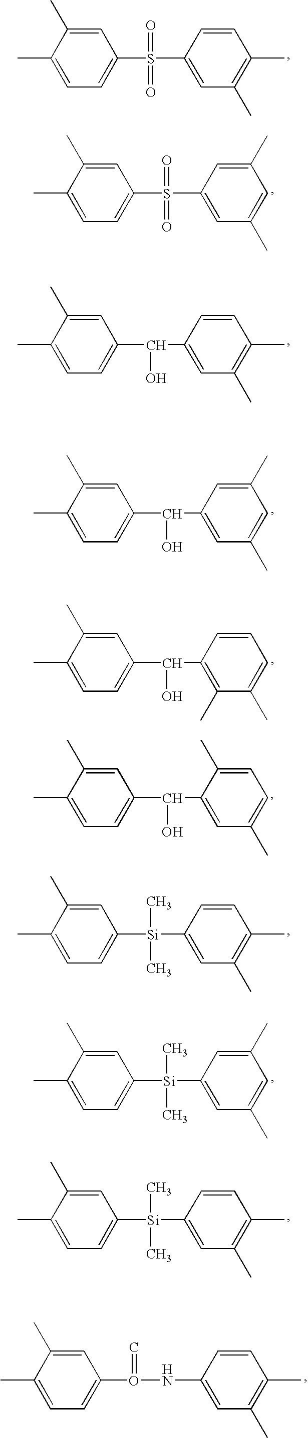

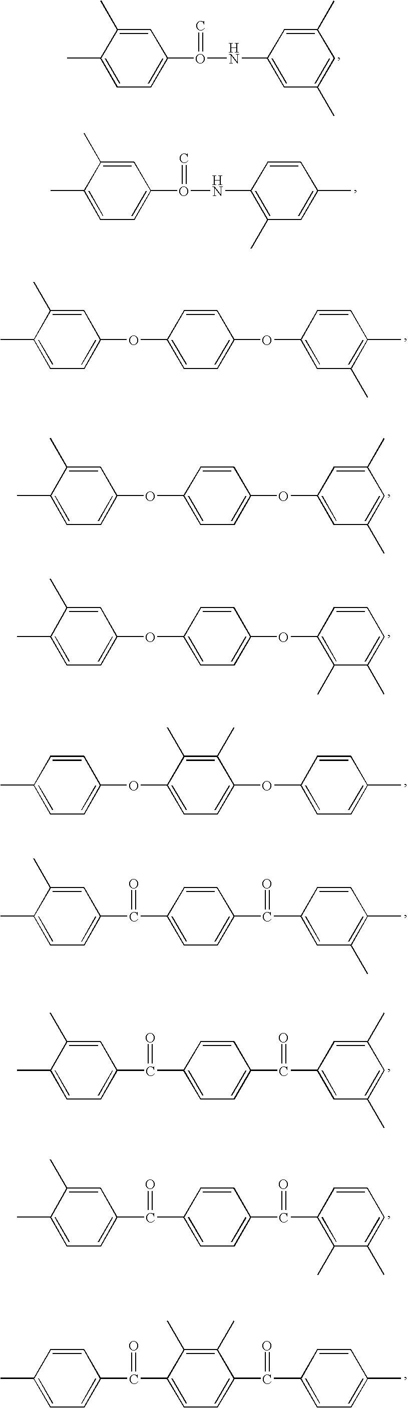

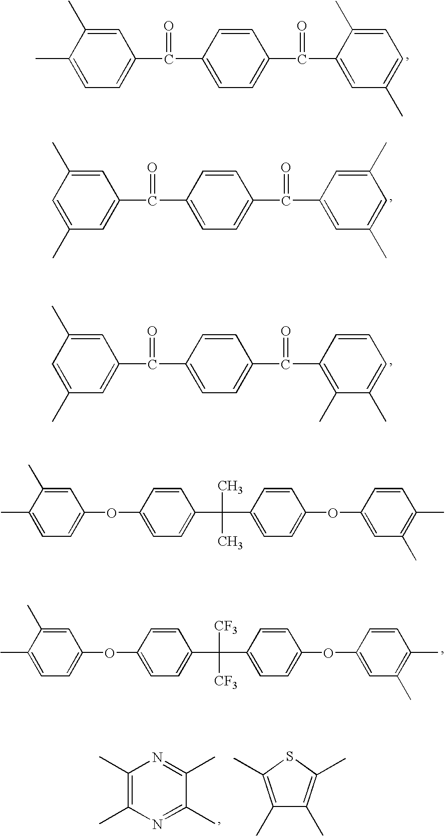

Preferably, Ar₂ is selected from the following compounds and the linkage position thereof includes all of o-, m- and p-positions.

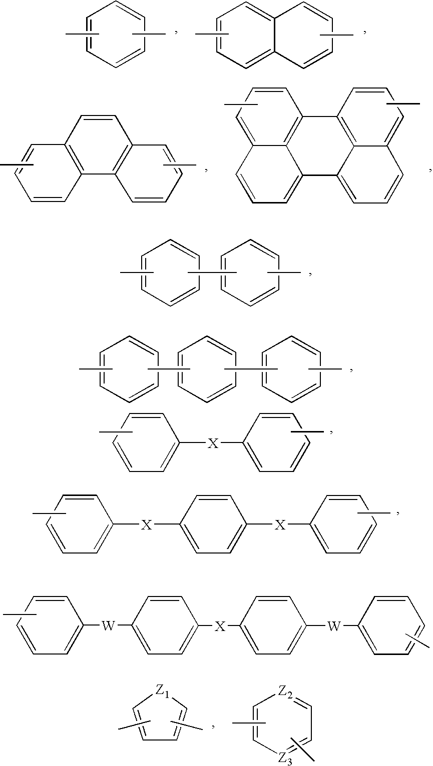

wherein X is O, S, C(═O), CH(OH), S(═O)₂, Si(CH₃)₂, (CH₂)ₚ (in which 1≦p≦110), (CF₂)_{q} (in which 1≦q≦10), C(CH₃)₂, C(CF₃)₂, or C(═O)NH; W is O, S or C(═O); and Z₁, Z₂ and Z₃ are identical to or different from each other and are O, N or S.

More preferably, Ar₂ is selected from the following compounds:

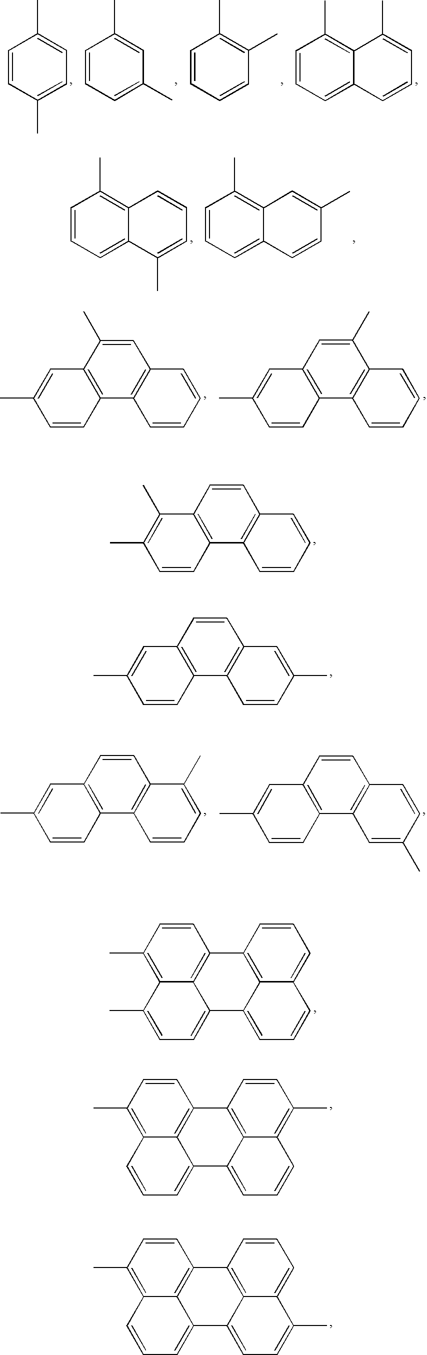

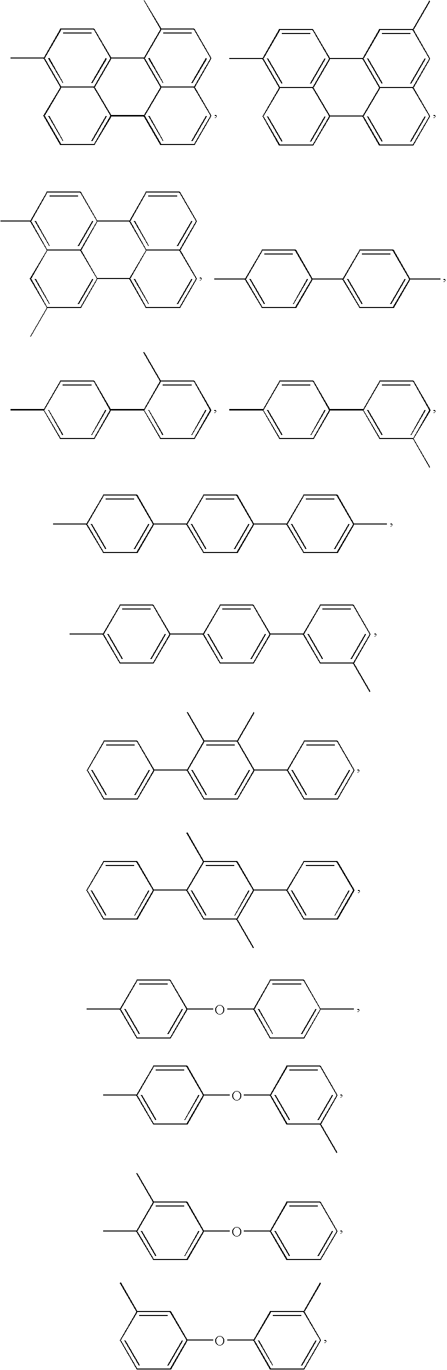

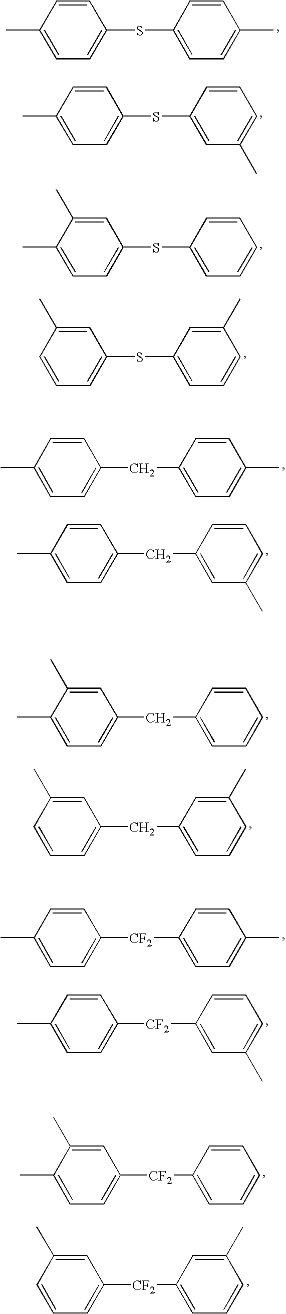

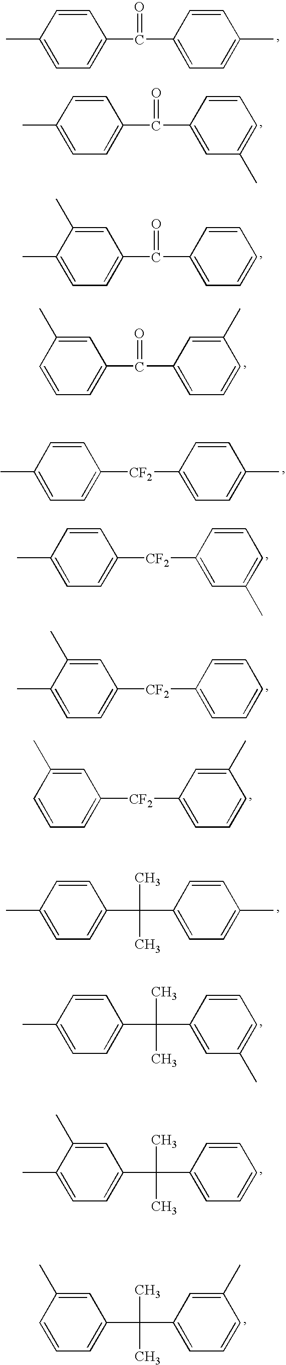

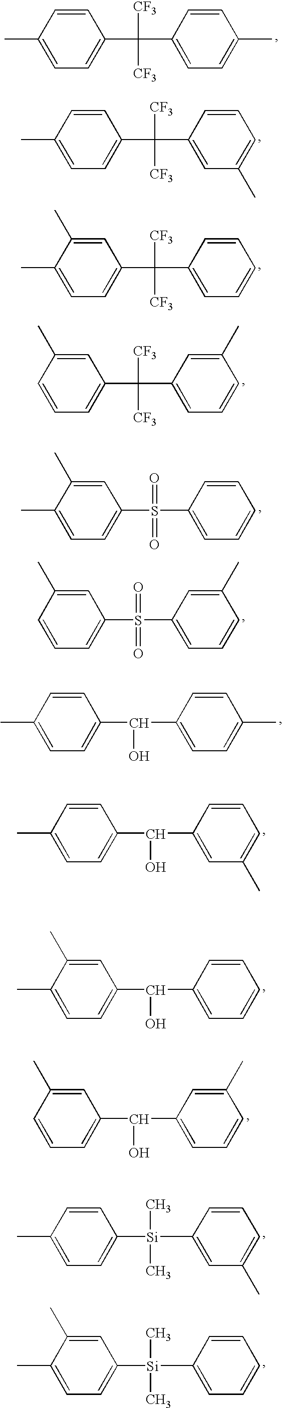

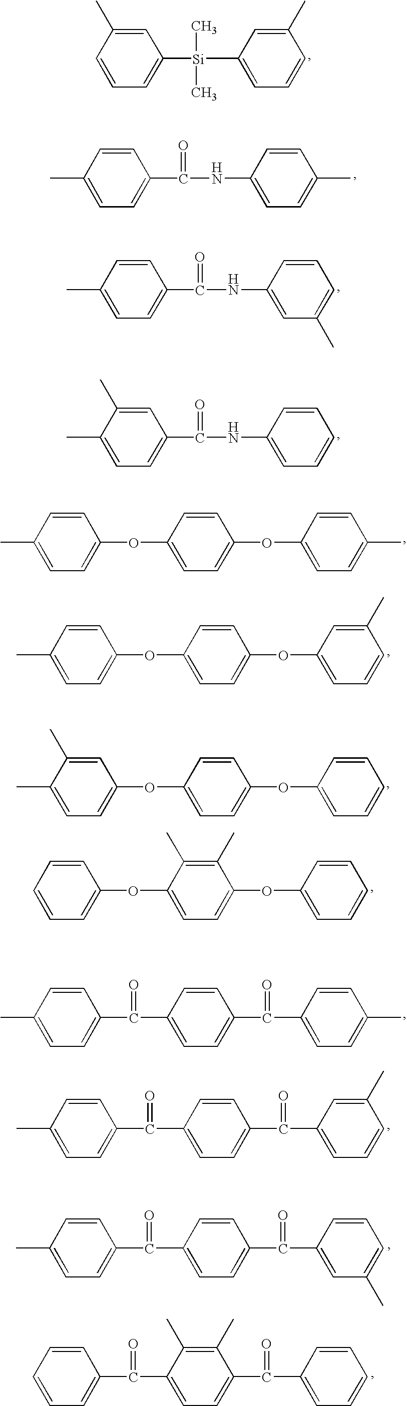

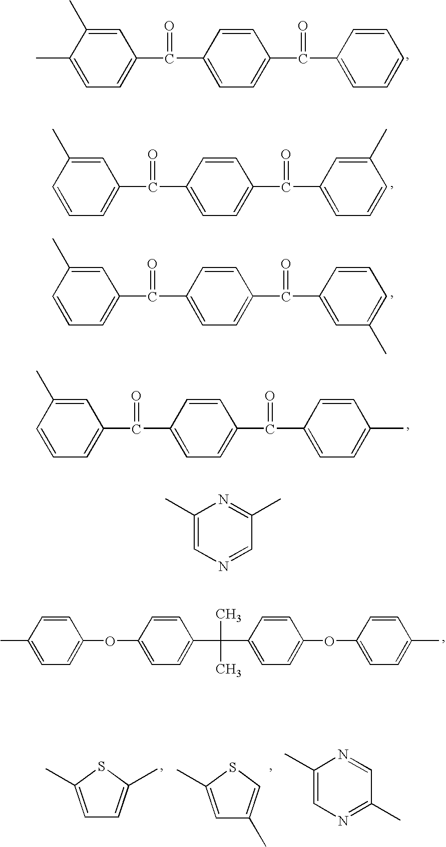

Preferably, Q is CH₂, C(CH₃)₂, C(CF₃)₂, O, S, S(═O)₂ or C(═O).

More preferably, Ar₁ is

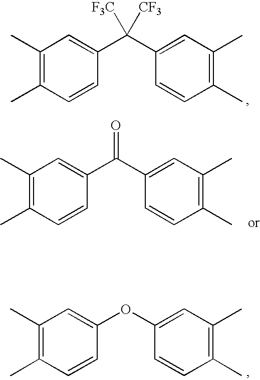

### Ar₂ is

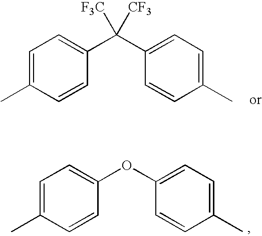

### and Q is C(CF₃)₂.

The polyimides of Formulae 1 to 4 or the polyimide copolymers of Formulae 9 to 18 can be prepared in accordance with methods well known in the art. For example, the polyimide and the polyimide copolymer may be prepared by imidizing and cyclizing hydroxyl group (—OH) containing polyamic acid (i.e., polyhydroxyamic acid), thiol group containing polyamic acid (i.e., polythiolamic acid) or amine group (—NH₂) containing polyamic acid (i.e., polyaminoamic acid) or copolymers thereof.

The polyimides represented by Formulae 1 to 4 are thermally rearranged through a preparation process which will be mentioned later, to form polybenzoxazole, polybenzothiazole and polybenzopyrrolone hollow fibers, each having a high fractional free volume. At this time, the polybenzoxazole hollow fiber is prepared from polyhydroxyimide in which Y is —OH, the polybenzothiazole hollow fiber is prepared from polythiolimide in which Y is —SH, and the polybenzopyrrolone hollow fiber is prepared from polyaminoimide in which Y is —NH₂.

In addition, the polyimide copolymers represented by Formulae 5 to 8 are thermally rearranged to form benzoxazole-imide copolymer, benzothiazole-imide copolymer or benzopyrrolone-imide copolymers which have a high fractional free volume. At this time, it is possible to control physical properties of the prepared hollow fibers by controlling the copolymerization ratio between blocks which will be thermally rearranged into polybenzoxazole, polybenzothiazole and polybenzopyrrolone through intramolecular and intermolecular conversion, and blocks which will be thermally rearranged into polyimides.

In addition, the polyimide copolymer represented by Formulae 9 to 18 are thermally rearranged to form hollow fibers made of copolymers of polybenzoxazole, polybenzothiazole and polybenzopyrrolone, each having a high free volume. At this time, it is possible to control the physical properties of hollow fibers thus prepared can be controlled by controlling the copolymerization ratio between blocks which are thermally rearranged into polybenzoxazole, polybenzothiazole and polybenzopyrrolone.

Preferably, the copolymerization ratio between the blocks, m:l, is from 0.1:9.9 to 9.9:0.1, more preferably 2:8 to 8:2, most preferably 5:5. The copolymerization ratio affects the morphology of the hollow fibers thus prepared. Since such morphologic change is associated with gas permeability and selectivity, it is considerably important to control the copolymerization ratio.

The polymer for forming hollow fiber including one selected from the group consisting of polyimides represented by Formulae 1 to 4, polyimide copolymers represented by Formulae 5 to 18, copolymers thereof and blends thereof is present in an amount of 5 to 45% by weight, based on the total weight of the dope solution composition. When the polymer content is less than the level as defined above, the strength of hollow fibers is decreased. On the other hand, when the polymer content exceeds this range, disadvantageously, gas permeability is difficult to be kept high.

In addition to the polymer for forming hollow fiber, the dope solution composition of the present invention comprises a solvent to dissolve the polymer and an additive to control phase-inversion temperature and viscosity.

Solvents that can be used in the present invention are not particularly limited. Any solvent may be used without particular limitation so long as it can homogeneously dissolve the polymer and additive. For example, the solvent may be selected from the group consisting of dimethyl sulfoxide, N-methyl-2-pyrrolidone, N-methylpyrrolidone, N,N-dimethylformamide, N,N-dimethyacetamide, γ-butyrolactone, cyclohexanone, 3-hexanone, 3-heptanone, 3-octanone and mixtures thereof.

The content of the solvent is 25 to 94% by weight, based on the total weight of the dope solution composition. When the content of the solvent is below 25%, the viscosity of the dope solution is excessively high, thus disadvantageously making it difficult to prepare hollow fibers and causing a decrease in permeability of the prepared hollow fibers. Conversely, when the solvent content exceeds 94%, the viscosity of the dope solution is low, thus disadvantageously making it difficult to prepare continuous hollow fibers.

The present invention is not particularly limited in terms of the additive. Any additive may be used so long as it is used in the art. Representative examples of useful additive may be selected from the group consisting of: water; alcohols including methanol, ethanol, 2-methyl-1-butanol, 2-methyl-2-butanol, glycerol, ethylene glycol, diethylene glycol and propylene glycol; ketons including acetone and methyl ethyl ketone; polymers including polyvinylalcohol, polyacrylic acid, polyacrylamide, polyethylene glycol, polypropylene glycol, chitosan, chitin, dextran and polyvinylpyrrolidone; salts including lithium chloride, sodium chloride, calcium chloride, lithium acetate, sodium sulfate and sodium hydroxide; tetrahydrofuran; trichloroethane; and mixtures thereof.

At this time, the content of the additive is 0.5 to 40% by weight, based on the total weight of the dope solution composition. When the content of the additive is less than 0.5%, surface pores of the hollow fibers are excessively large, thus making it difficult to form dense surface layers. Conversely, when the content of the additive exceeds 40%, the viscosity of the dope solution is excessively high, thus making it difficult to prepare hollow fibers.

In addition, the hollow fiber of the present invention is prepared by (S1) spinning the dope solution composition to prepare a polyimide hollow fiber, (S2) thermally treating the polyimide hollow fiber to induce intramolecular and intermolecular rearrangement and obtain a hollow fiber comprising one selected from polymers represented by the following Formulae 19 to 32 and copolymers thereof.

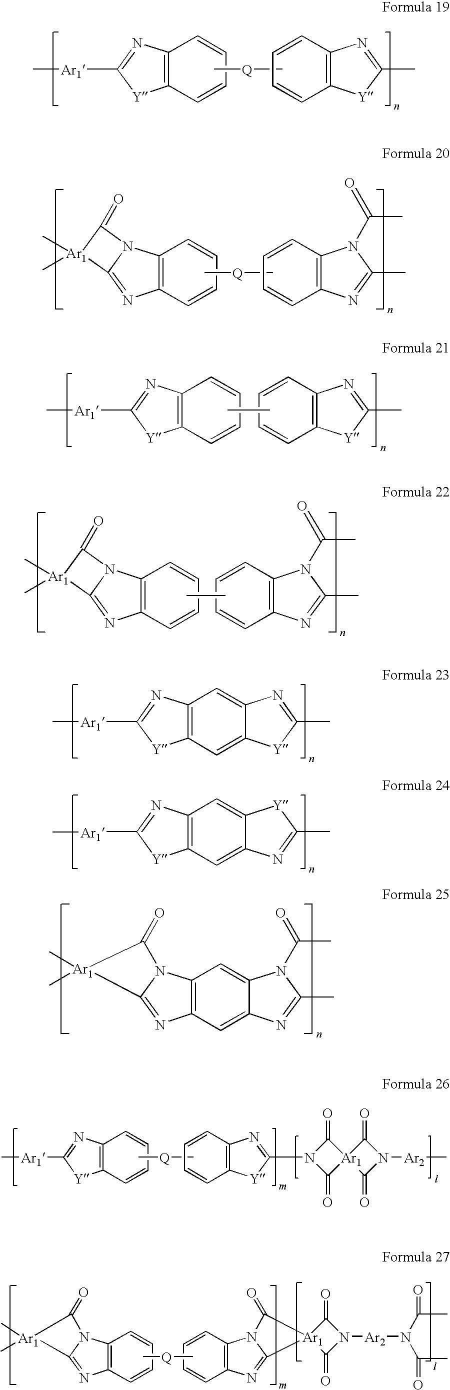

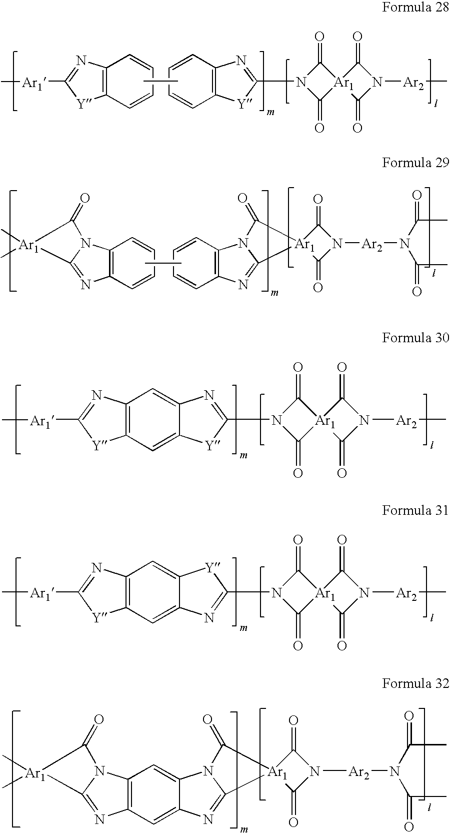

In Formulae 19 to 32,

Ar₁, Ar₂, Q, n, m and l are defined as above;

Ar₁′ is the same as defined in Ar₂ and is identical to or different from Ar₂; and

Y″ is O or S.

First, in the step S1, the dope solution composition is spun and then undergoes phase-inversion to prepare a hollow fiber.

At this time, the spinning may be carried out in accordance with a method well-known in the art and is not particularly limited. In the present invention, dry or dry-jet-wet spinning is used for the preparation of hollow fibers. A solvent-exchange method using solution-spinning is generally used as the hollow fiber preparation method. In accordance with the solvent exchange method, after polymers are dissolved along with an additive in a solvent and spun using a dry or dry-jet-wet spinning method, the solvent and the non-solvent are exchanged in the presence of the non-solvent to form microcavities. In the process in which the solvent is diffused into a coagulation bath as the non-solvent, an asymmetric membrane or a symmetric membrane in which the interior is identical to the exterior was formed.

For example, in a case where dry-jet-wet spinning is used for the preparation of hollow fibers, the dry-jet-wet spinning is achieved through the steps of: a1) preparing a polyimide dope solution composition; a2) bringing the dope solution composition into contact with an internal coagulant, and spinning the composition in air, while coagulating an inside of hollow fiber to form a polyimide hollow fiber; a3) coagulating the hollow fiber in a coagulation bath; a4) washing the hollow fiber with a cleaning solution, followed by drying; and a5) thermally treating the polyimide hollow fiber.

At this time, a flow rate of internal coagulant discharged through an inner nozzle is preferably 1 to 10 ml/min, more preferably 1 to 3 ml/min. In addition, a double nozzle preferably has an outer diameter of 0.1 to 2.5 mm. The flow rate of the internal coagulant and the outer diameter of the double nozzle can be controlled within the range according to the use and conditions of hollow fibers. In addition, the air gap between the nozzle and the coagulation bath is preferably 0.1 to 200 cm, more preferably 5 to 50 cm.

The phase-inversion is induced in a coagulation bath by passing the hollow fiber through a high-temperature spinning nozzle, while maintaining a spinning temperature of 5 to 120° C. and a spinning rate of 5 to 100 m/min. The spinning temperature and spinning rate may be varied within the range depending upon the use and operation conditions of hollow fibers.

At this time, when the spinning temperature is below the above range, the viscosity of the dope solution is increased, thus making it difficult to perform rapid spinning, and on the other hand, when the spinning temperature exceeds the above range, solvent evaporation and the viscosity of the dope solution are decreased, thus disadvantageously making it impossible to continuously prepare hollow fibers. In addition, when the spinning rate is below the above range, the surface layer is thickened and a flow rate is then decreased, and on the other hand, when the spinning rate exceeds the above range, the mechanical properties of hollow fibers thus produced are deteriorated, thus disadvantageously making it impossible to smoothly perform hollow fiber spinning. Accordingly, it is preferable that the spinning rate be maintained within the range.

At this time, the temperature of the coagulation bath is preferably 0 to 50° C. When the coagulation bath temperature is below this range, phase-inversion is delayed, thus making it difficult to form surface layers, and on the other hand, when the temperature exceeds this range, the solvent present in the coagulation bath evaporates, thus disadvantageously making it impossible to smoothly prepare hollow fibers.

As the external coagulant present in the coagulation bath, any type may be used so long as it does not dissolve polymeric materials and is compatible with the solvent and additive. Representative examples of useful external coagulants include water, ethanol, methanol and mixtures thereof. Water is preferred.

To remove the solvent, additive, and the coagulated solution that remain inside the coagulated hollow fibers and on the surface thereof, washing and drying processes may be performed. Water or hot-water may be used as the cleaning solution. The washing time is not particularly limited. Preferably, the washing is carried out for 1 to 24 hours.

After the washing, the drying is performed at a temperature ranging from 20 to 100° C. for 3 to 72 hours.

Subsequently, in the step S2), the polyimide hollow fiber is thermally treated to obtain hollow fibers including polymers represented by Formulae 19 to 32 or copolymers thereof.

Through the thermal-rearrangement using thermal treatment, it is possible to obtain hollow fibers including polymers represented by Formulae 19 to 32 or copolymers thereof that have a decreased density, an increased fractional free volume (FFV) and an increased d-spacing due to an increased microcavity size, and thus exhibit improved gas permeability, as compared to polyimide hollow fibers.

The thermal treatment is carried out under an inert atmosphere at 350 to 500° C., preferably 400 to 450° C., for 1 minute to 12 hours, preferably 10 minutes to 2 hours at a heating rate of 1 to 20° C./min. When the temperature is below this range, the thermal rearrangement is not completed and the polyimide precursor remains unreacted, causing deterioration in purity. On the other hand, when the temperature exceeds this range, polyimide is disadvantageously converted into a carbon substance as an inorganic due to polymer carbonization. Accordingly, it is preferable that the thermal treatment be suitably performed within this temperature range.

The thermal treatment of step S2) will be illustrated in detail with reference to Reaction Schemes 1 and 2 below:

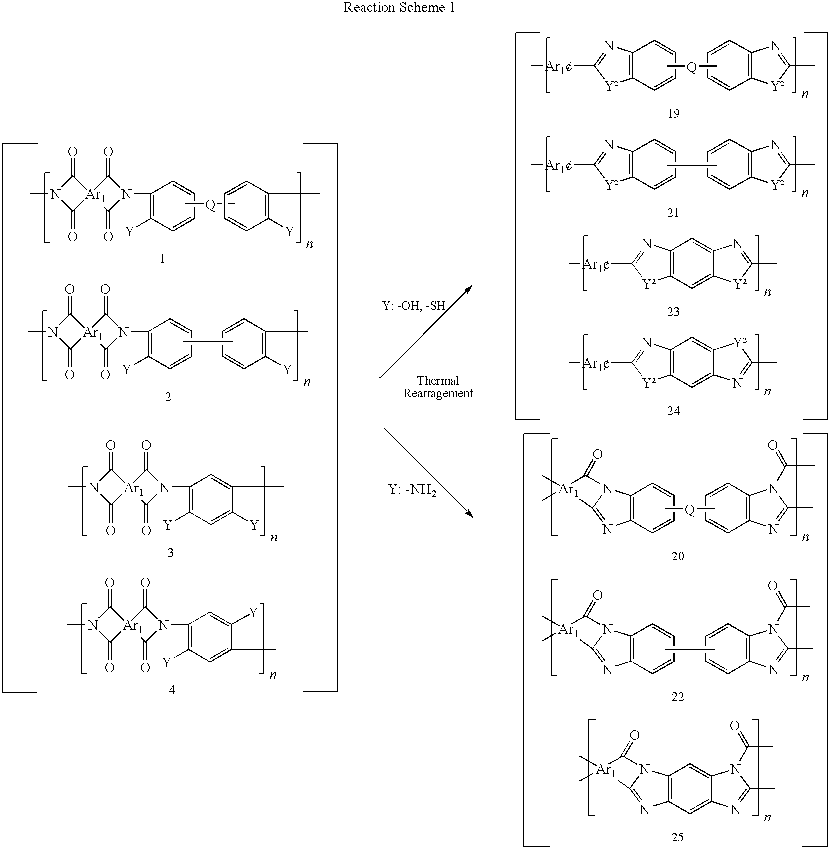

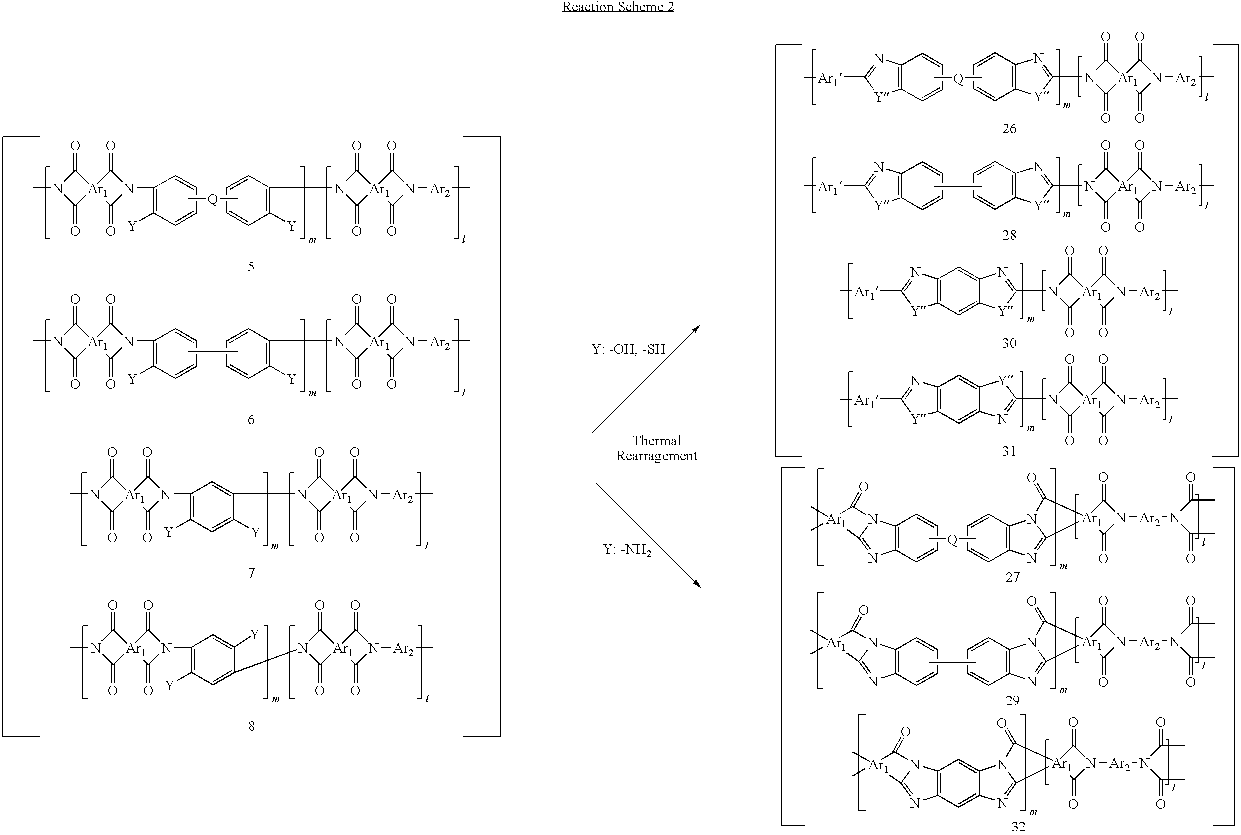

In Reaction Schemes 1 and 2, Ar₁, Ar₁′, Ar₂, Q, Y, Y″, n, m, and l are defined as above.

As can be seen from Reaction Scheme 1, hollow fibers made of polyimides represented by the Formulae 1 to 4 are converted through thermal treatment into hollow fibers made of polybenzoxazole, polybenzethiazole, polybenzopyrrolone represented by Formulae 19 to 25. The conversion of polyimide hollow fibers into the polymers is carried out through the removal reaction of CO₂ present in the polymers of Formulae 1 to 4.

At this time, polyimides of Formulae 1 to 4 in which Y is —OH or —SH are thermally rearranged into polybenzoxazoles (Y″═O) or polybenzothiazoles (Y″═S) of Formula 19, Formula 21, Formula 23 and Formula 24. In addition, polyimides of Formulae 1 to 4 in which Y is —NH₂ are thermally rearranged into polybenzopyrrolones of Formulae 20, 22 and 25.

As can be seen from Reaction Scheme 2, through the afore-mentioned thermal treatment, hollow fibers made of polyimide copolymers of Formulae 5 to 8 are converted through the removal reaction of CO₂ present in the polyimides into polymers of Formulae 26 to 32.

At this time, polyimides of Formulae 5 to 8 in which Y is —OH or —SH are thermally rearranged into benzoxazole(Y″═O)-imide copolymers or benzothiazole(Y″═S)-imide copolymers of Formulae 26, 28, 30 and 31. In addition, polyimides of Formulae 5 to 8 in which Y is —NH₂ are thermally rearranged into benzopyrrolone-imide copolymers of Formulae 27, 29 and 32.

The blocks constituting the hollow fibers made of polyimide copolymers represented by Formulae 9 to 18 are thermally rearranged into polybenzoxazole, polybenzothiazole and polybenzopyrrolone, depending upon the type of Y to form hollow fibers made of copolymers thereof, i.e., copolymers of polymers represented by Formulae 19 to 25.

At this time, by controlling the preparation process, the hollow fibers are prepared in the form of a macropore-formed finger or a sponge that has a macropore-free selective layer and thus exhibits stable membrane performance. Alternatively, the hollow fibers may be prepared in a symmetric or asymmetric form by controlling the preparation process. Furthermore, by controlling polymer design while taking into consideration the characteristics of Ar₁, Ar₁′ Ar₂ and Q present in the chemical structure, permeability and selectivity for various gas types can be controlled.

The polyimides of Formulae 1 to 4, polyimide copolymers of Formulae 5 to 18 can be prepared in accordance with methods well known in the art.

According to examples of the present invention, as depicted in Reaction Schemes 3 and 4 below, polyamic acids represented by Formulae 33 to 50 are imidized are then prepared into polyimides represented by Formulae 1 to 4, polyimide copolymers represented by Formulae 5 to 18.

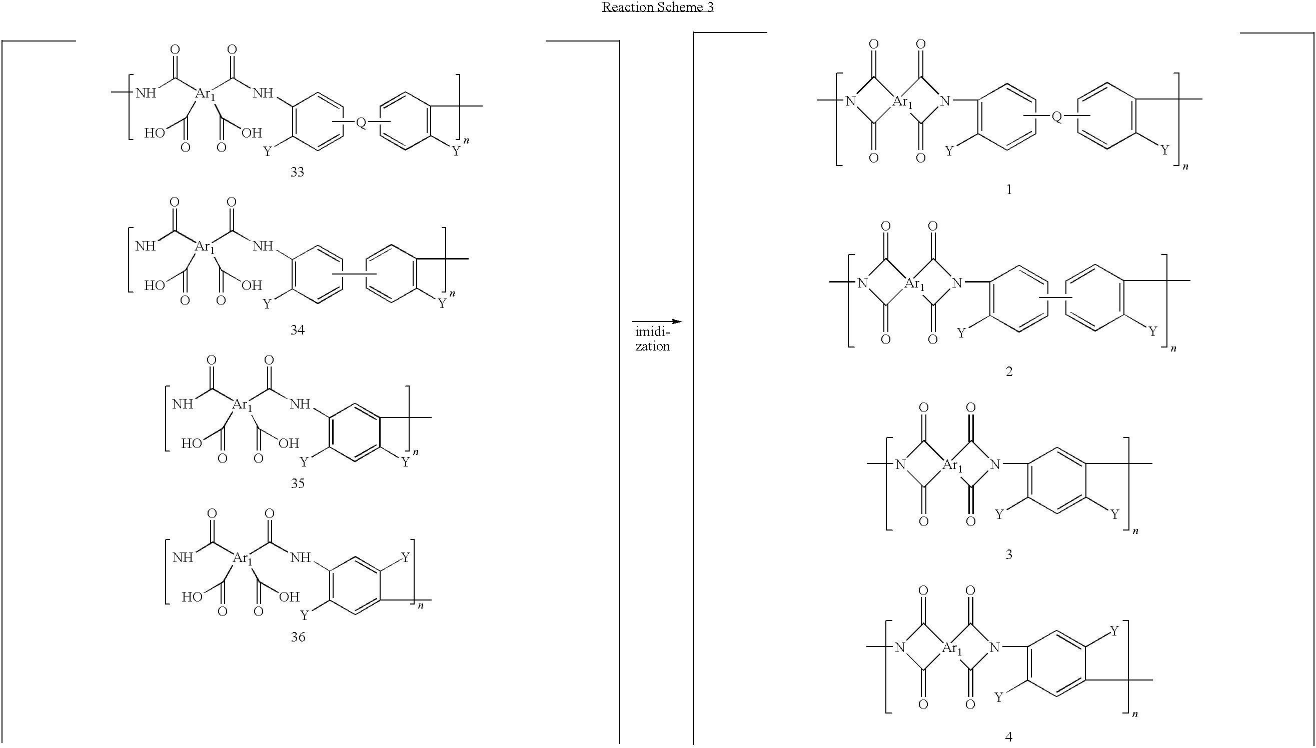

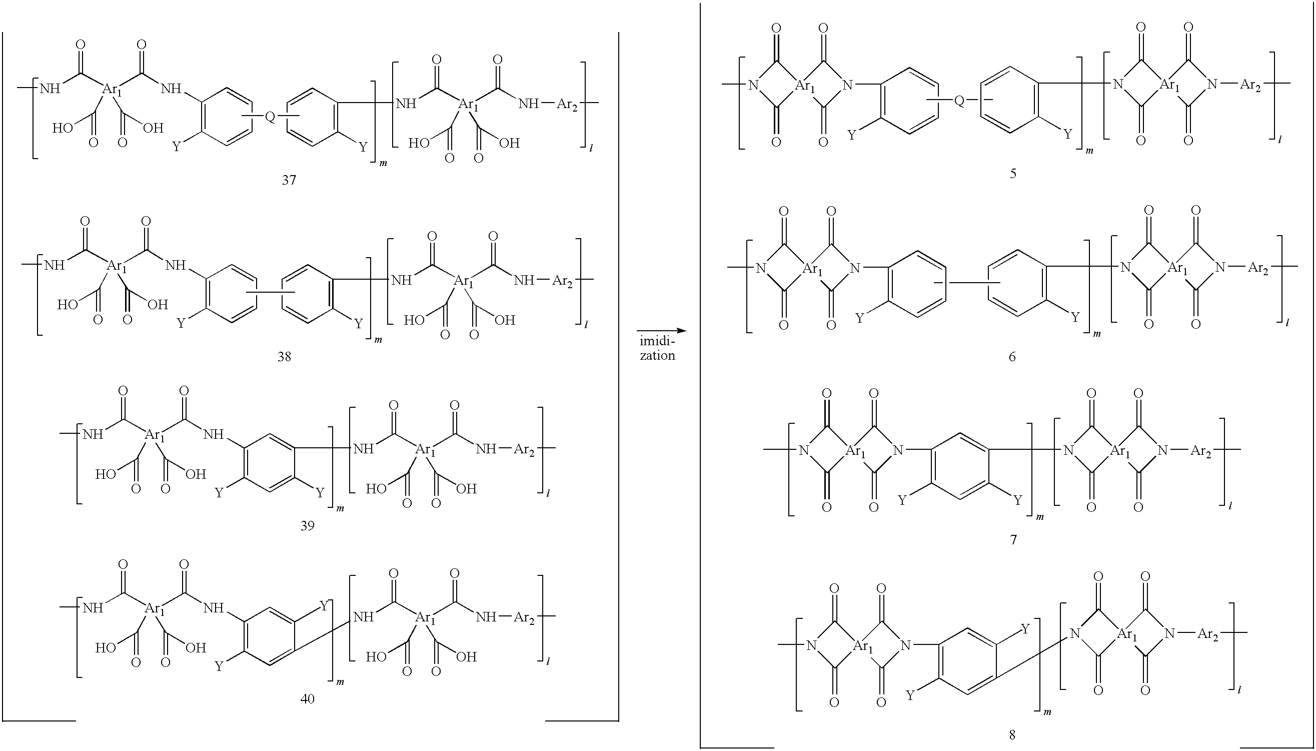

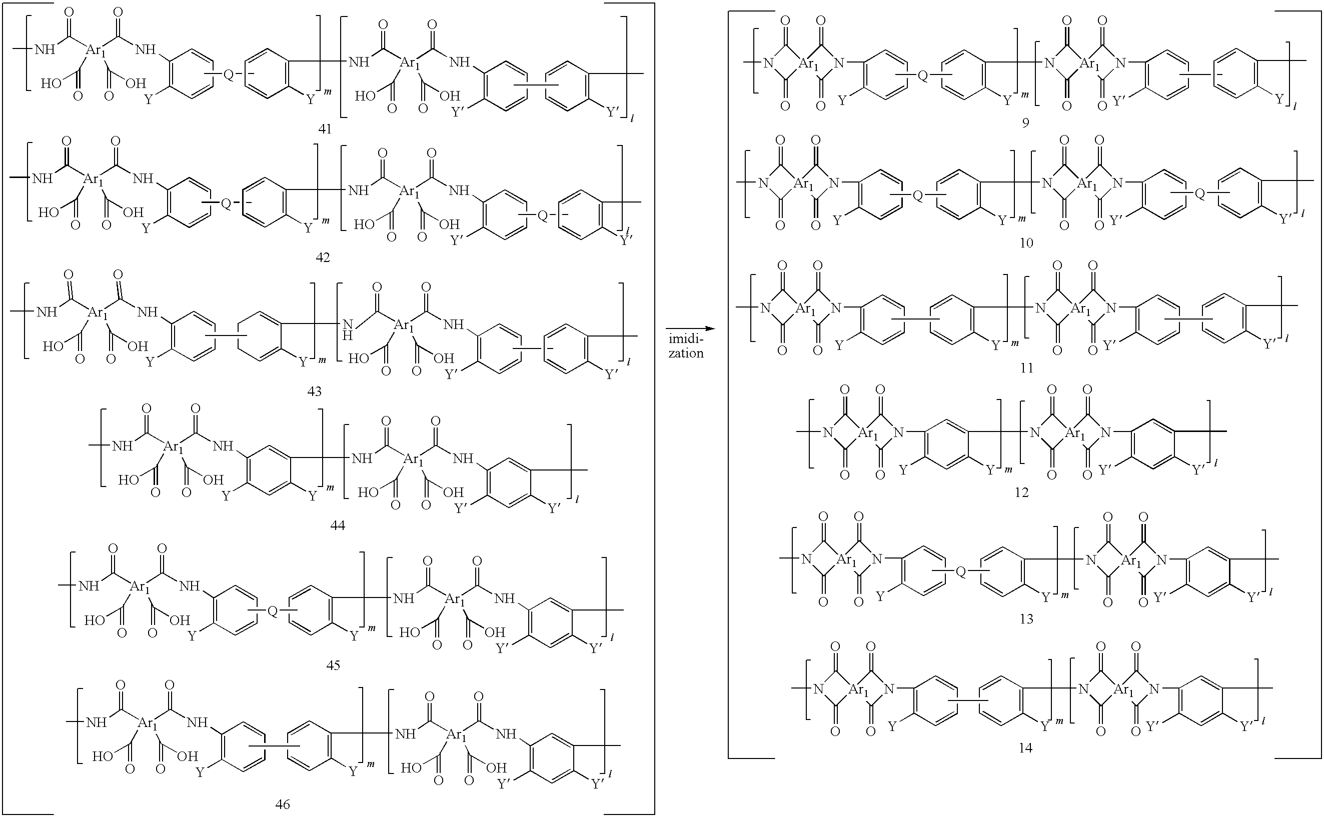

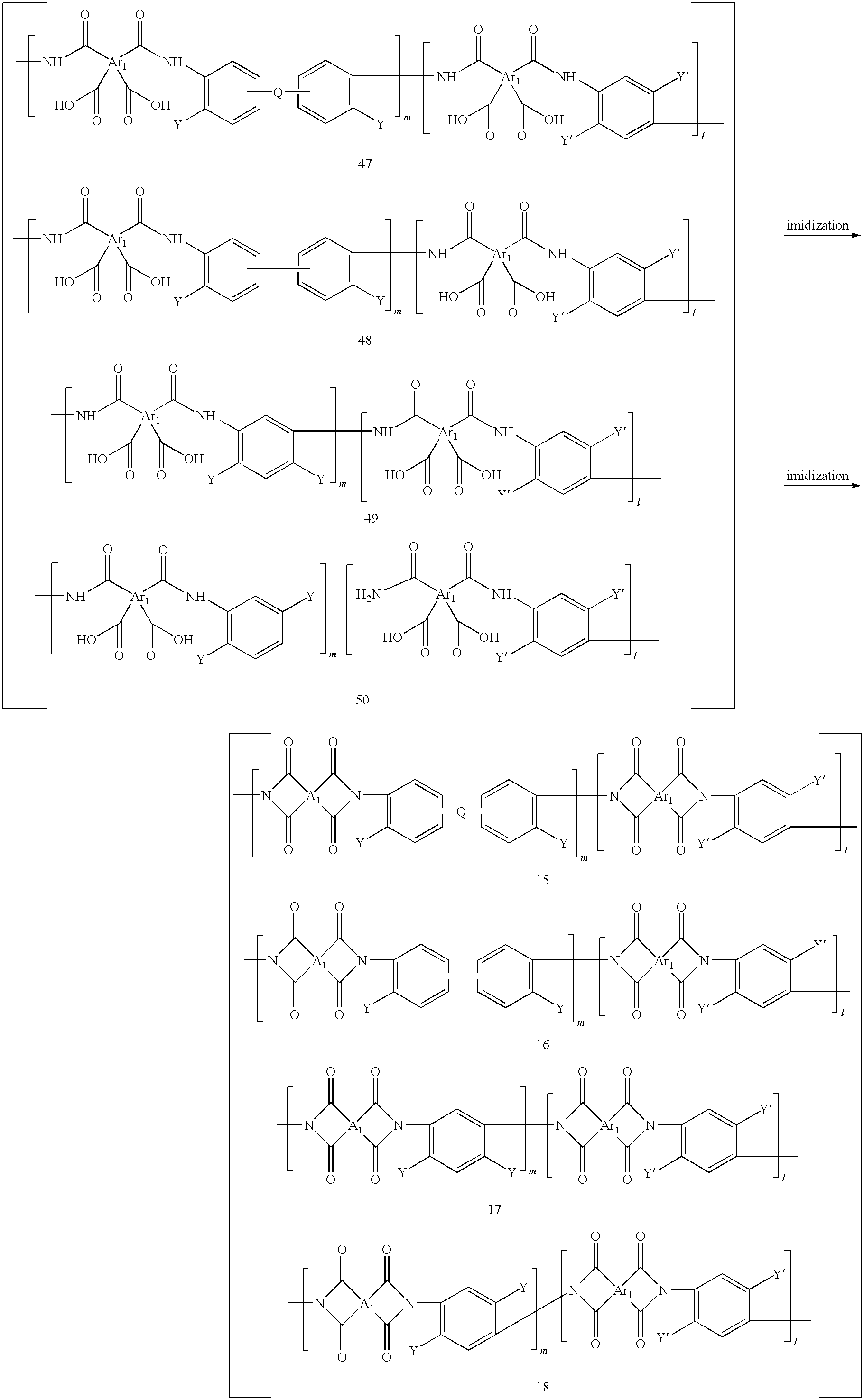

As can be seen from Reaction Scheme 3, polyamic acids (polyhydroxyamic acid, polythiolamic acid, polyaminoamic acid) represented by the Formula 33, Formula 34, Formula 35 and Formula 36 are converted through imidization i.e., cyclization reaction into polyimides represented by Formula 1, Formula 2, Formula 3 and Formula 4, respectively.

In addition, polyamic acid copolymers represented by the Formula 37, Formula 38, Formula 39 and Formula 40 are converted through imidization into polyimide copolymers represented by Formula 5, Formula 6, Formula 7 and Formula 8, respectively.

As can be seen from Reaction Scheme 4, polyamic acid copolymers represented by the Formulae 41 to 50 are converted through imidization into polyimide copolymers represented by Formulae 9 to 18.

The imidization can be conducted in accordance with methods well known in the art. Representative examples of the imidization include chemical imidization and solution-thermal imidization.

Preferably, the chemical imidization is carried out at 60 to 180° C. for 1 to 48 hours. At this time, acetic anhydride can be added to remove water as a byproduct along with pyridine as a catalyst. In addition, preferably, the solution-thermal imidization is carried out in solution at 150 to 250° C. for 1 to 48 hours.

When the imidization temperature is below this range, polyamic acid as a precursor is only slightly imidized, and on the other hand, when the imidization temperature exceeds this range, significant effects cannot be obtained and economic efficiency is thus very low. The imidization conditions may be suitably controlled within the range according to the functional groups, Ar₁, Ar₂, Q and Y.

The hollow fibers thus prepared comprise polymers represented by Formula 19 to Formula 32 or copolymers thereof.

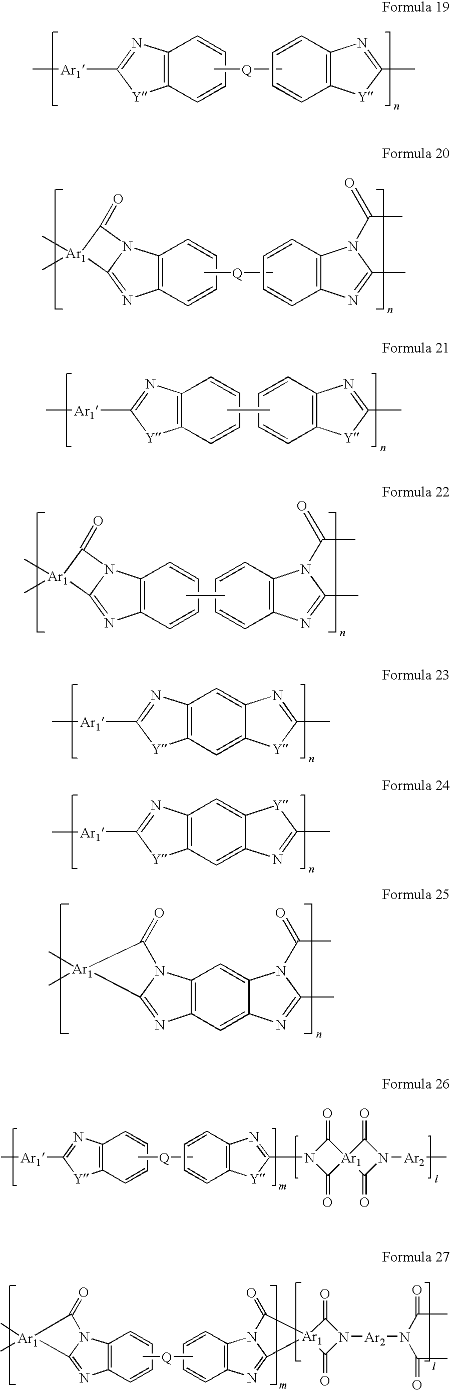

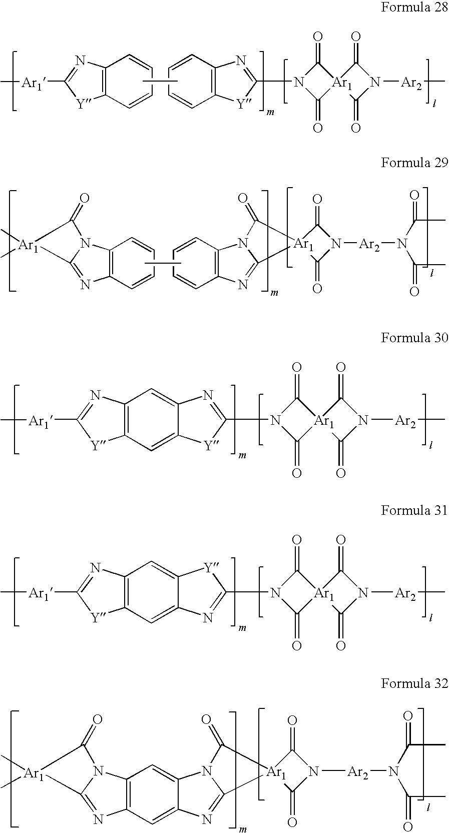

In Formulae 19 to 32, Ar₁, Ar₁′, Ar₂, Q, Y″, n, m and l are defined as above.

At this time, Ar₁, Ar₁′ and Ar₂ may be the same arylene or heterocyclic ring.

Preferably, Ar₁ is selected from the following compounds and the linkage position thereof includes all of o-, m- and p-positions.

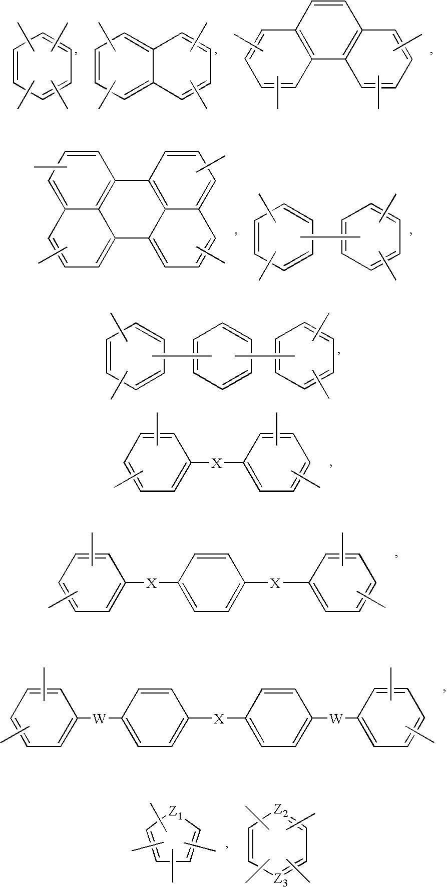

wherein X is O, S, C(═O), CH(OH), S(═O)₂, Si(CH₃)₂, (CH₂)ₚ (in which 1≦p≦110), (CF₂)_{q} (in which 1≦q≦10), C(CH₃)₂, C(CF₃)₂, or C(═O)NH; W is O, S or C(═O); and Z₁, Z₂ and Z₃ are identical to or different from each other and are O, N or S.

More preferably, Ar₁ is selected from the following compounds:

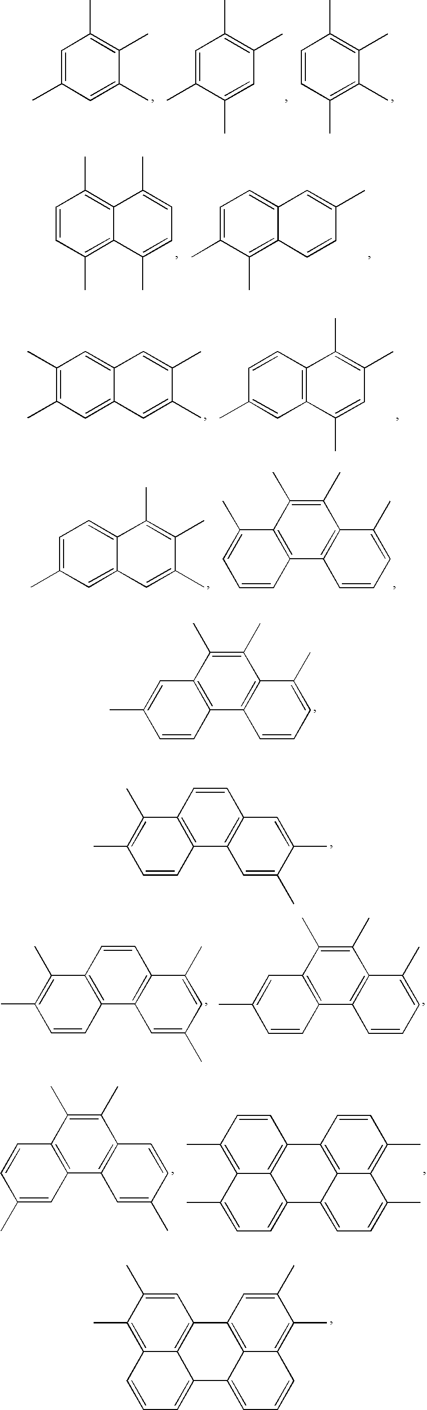

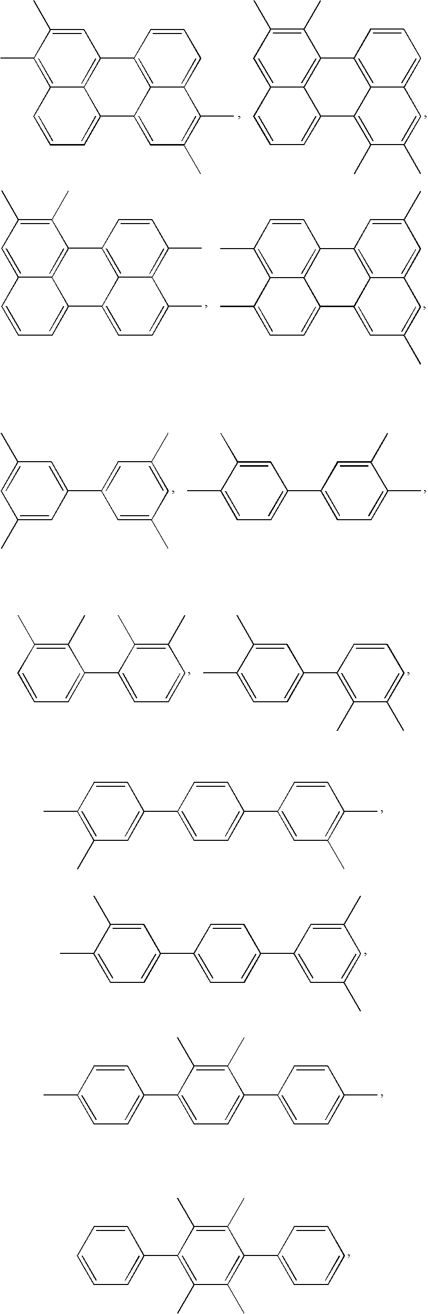

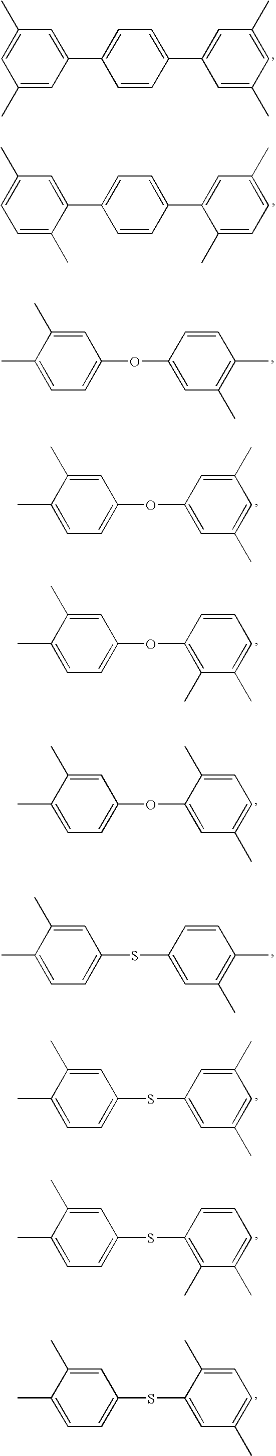

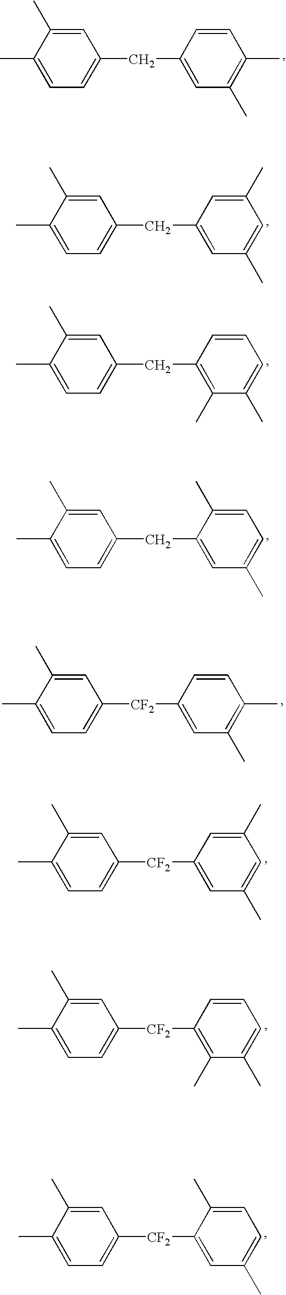

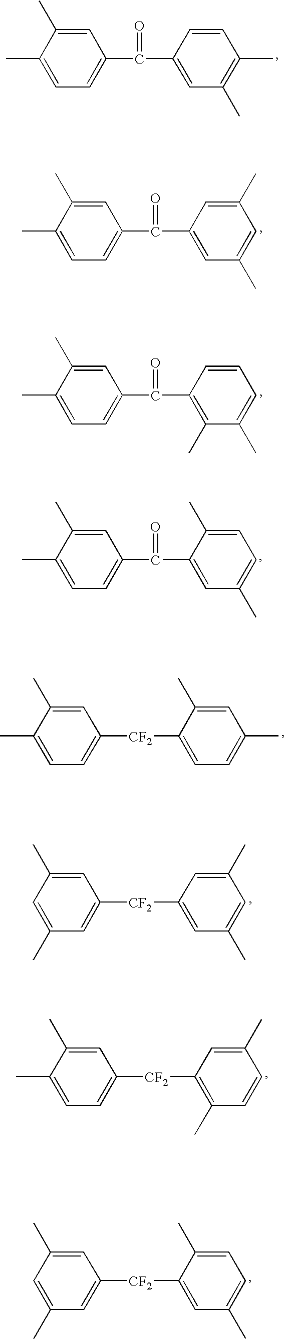

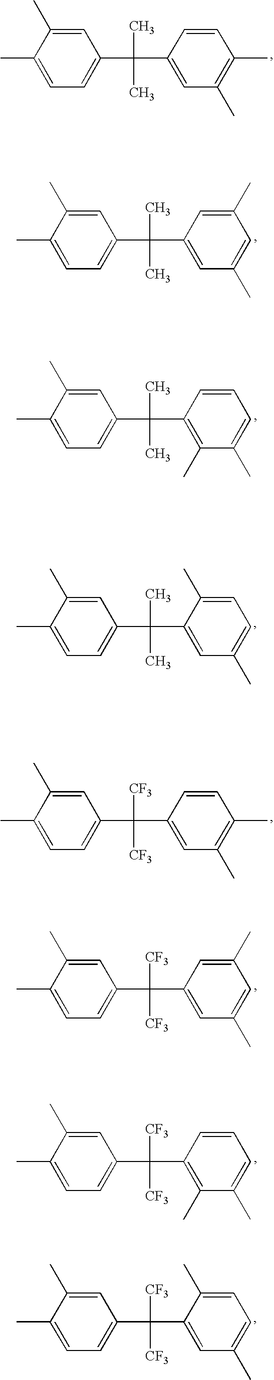

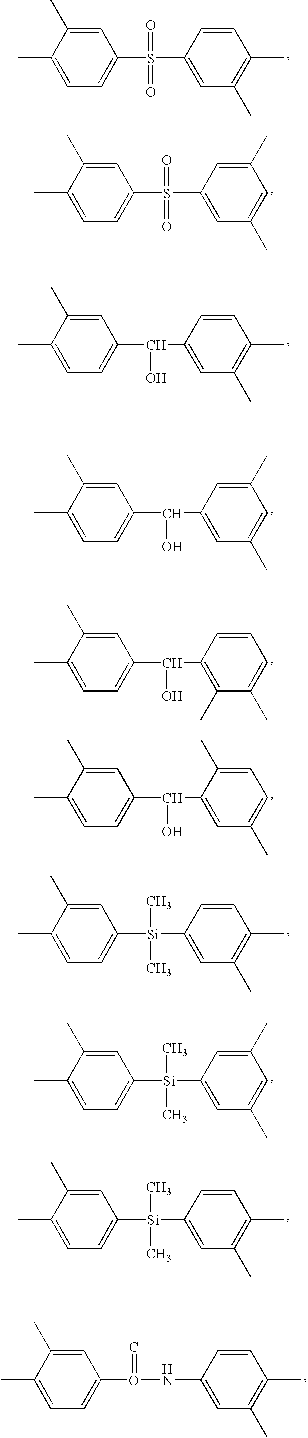

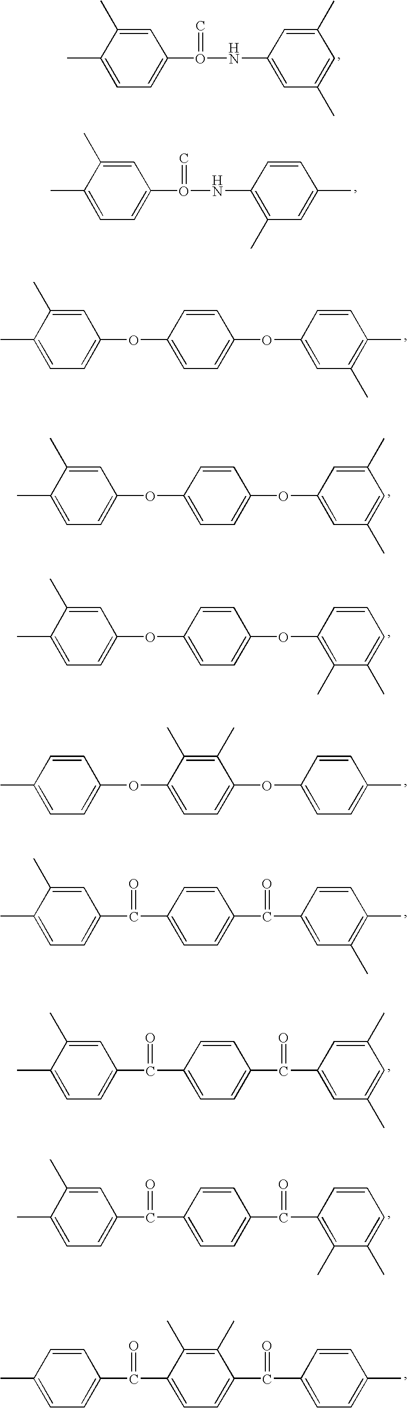

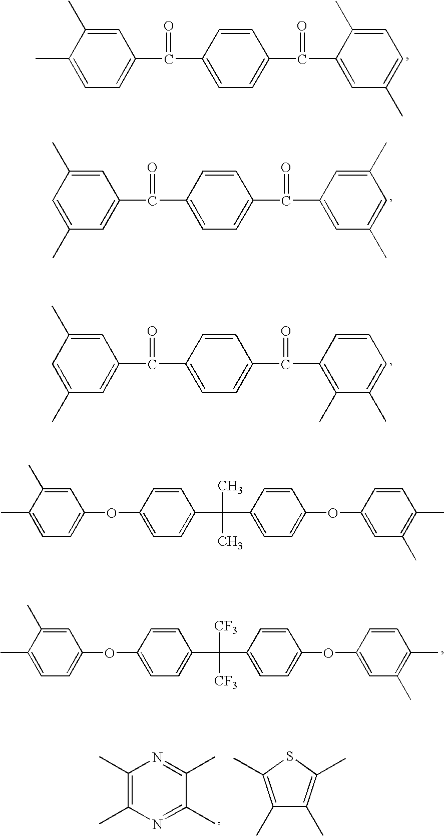

In addition, preferably, Ar₁′ and Ar₂ are selected from the following compounds and the linkage position thereof includes all of o-, m- and p-positions.

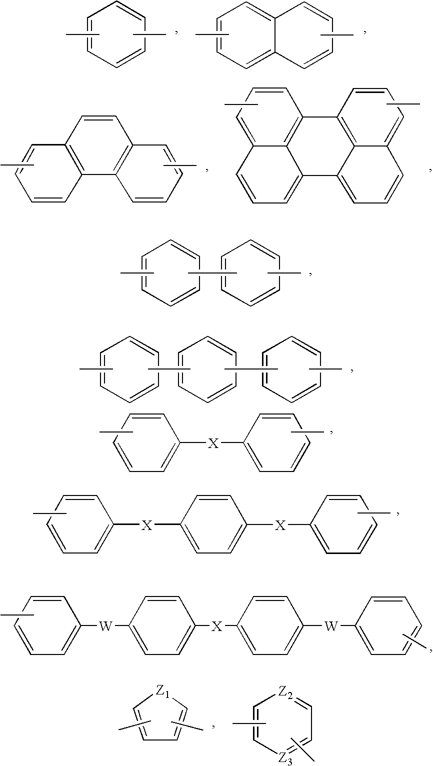

wherein X is O, S, C(═O), CH(OH), S(═O)₂, Si(CH₃)₂, (CH₂)ₚ (in which 1≦p≦110), (CF₂)_{q} (in which 1≦q≦10), C(CH₃)₂, C(CF₃)₂, or C(═O)NH; W is O, S or C(═O); and Z₁, Z₂ and Z₃ are identical to or different from each other and are O, N or S.

More preferably, Ar₁′ and Ar₂ are selected from the following compounds:

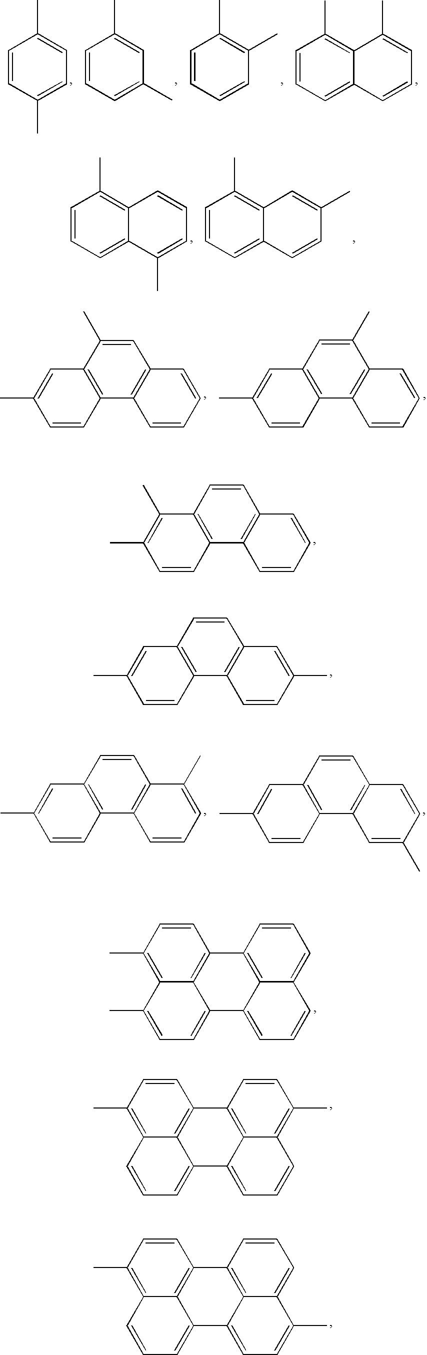

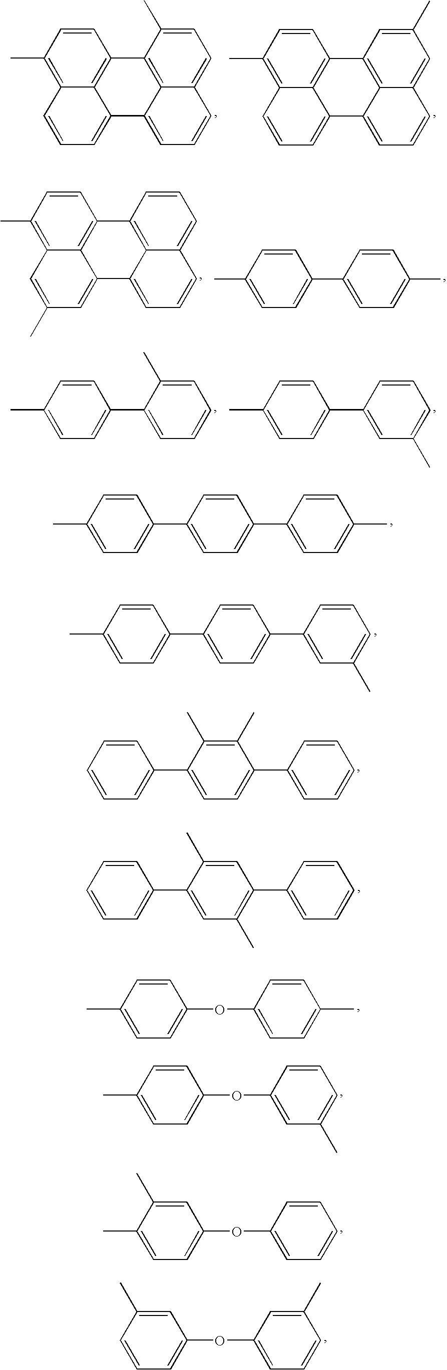

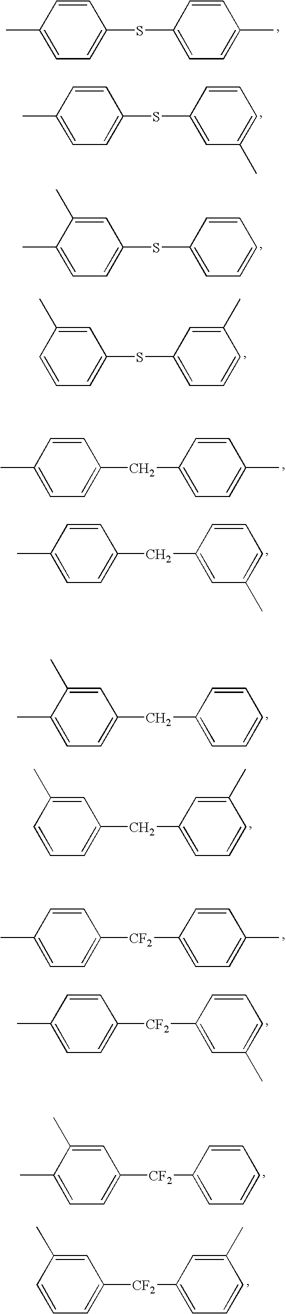

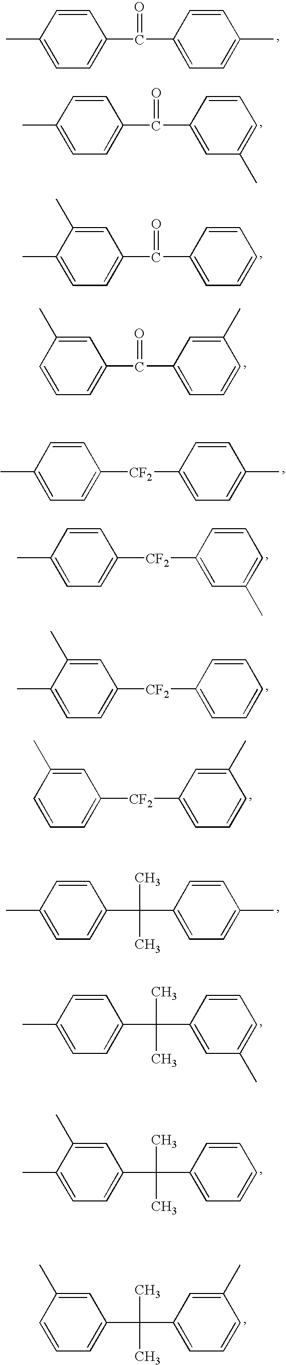

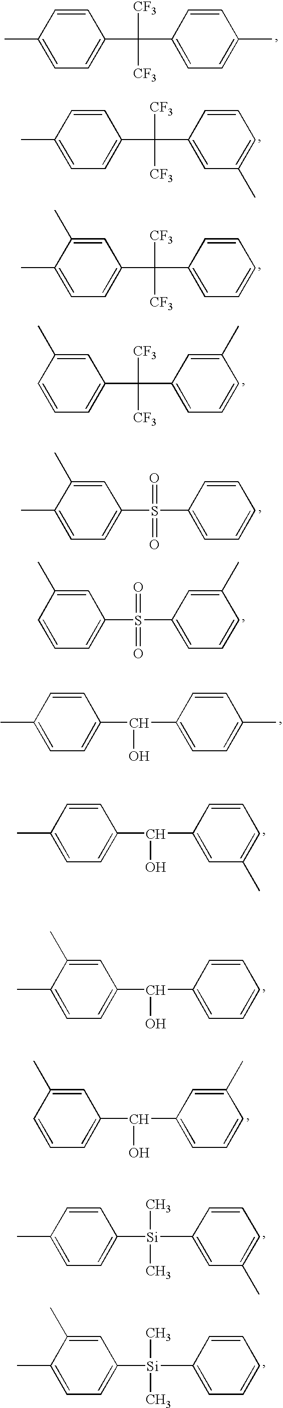

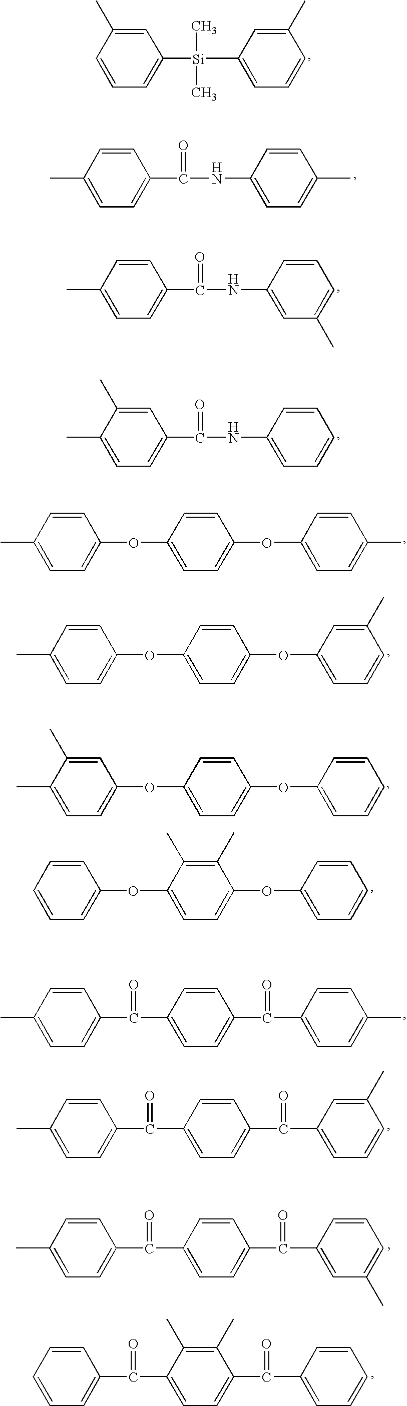

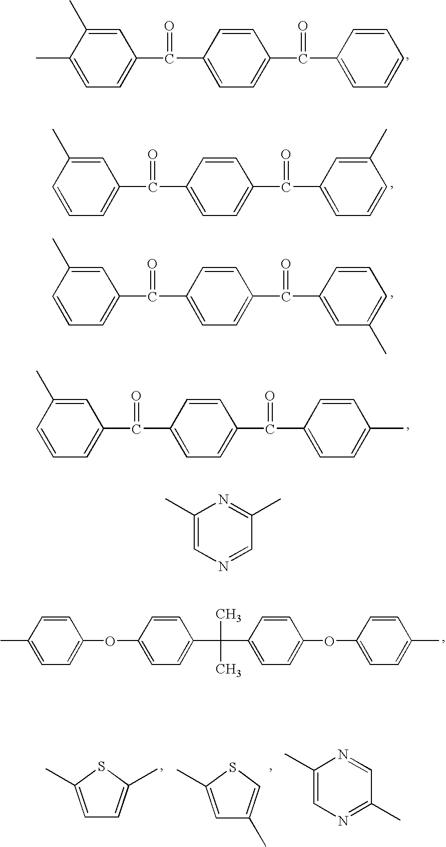

Preferably, Q is CH₂, C(CH₃)₂, C(CF₃)₂, O, S, S(═O)₂ or C(═O).

More preferably, Ar₁ is

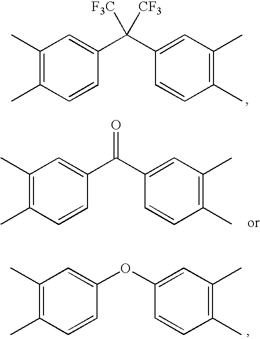

### Ar₁′ is

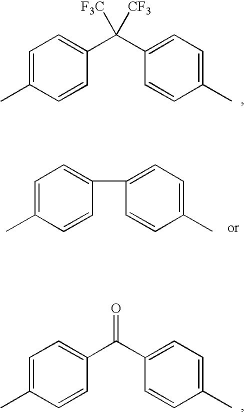

### Ar₂ is

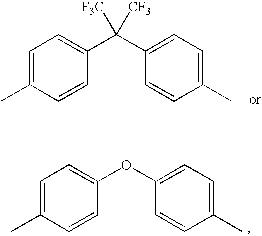

### and Q is C(CF₃)₂.

The hollow fibers of the present invention can endure not only mild conditions, but also harsh conditions such as long operation time, acidic conditions and high humidity, due to rigid backbones present in the polymers.

The polymers represented by Formulae 19 to 32 or copolymers thereof are designed to have a desired molecular weight, preferably, a weight average molecular weight of 10,000 to 200,000 Da. When the molecular weight is less than 10,000 Da, the physical properties of the polymers are poor, and when the molecular weight exceeds 200,000 Da, the viscosity of the dope solution is greatly increased, thus making it difficult to spin the dope solution using a pump.

In addition, the hollow fibers of the present invention have well-connected microcavities and a high free volume, thus exhibiting superior permeability for CO₂ and O₂ and superior selectivity for mixed gas pair of H₂/N₂, H₂/CH₄, H₂/O₂, H₂/CO₂, O₂/CO₂, N₂/CH₄, O₂/N₂, CO₂/CH₄ and CO₂/N₂. At this time, the hollow fibers of the present invention exhibit O₂/N₂ selectivity of 3 or higher and CO₂/CH₄ selectivity of 20 or higher at 25° C., preferably, O₂/N₂ selectivity of 3 to 30 and CO₂/CH₄ selectivity of 20 to 100 at 25° C.

In accordance with the method of the present invention, a hollow fiber with superior polymeric backbone strength and improved free volume is prepared by thermally rearranging a polyimide hollow fiber through intramolecular and intermolecular conversion via thermal treatment.

The hollow fiber thus prepared exhibits superior gas permeability and selectivity, thus being suitable for use in gas separation membranes. Furthermore, the hollow fiber can endure harsh conditions such as long operation time, acidic conditions and high humidity, due to rigid backbones present in the polymers constituting the hollow fiber.

### EXAMPLES

Hereinafter, preferred examples will be provided for a further understanding of the invention. These examples are for illustrative purposes only and are not intended to limit the scope of the present invention.

### Example 1

As depicted in Reaction Scheme 5 below, a hollow fiber comprising polybenzoxazole represented by Formula 51 are prepared from the polyhydroxyamic acid-containing dope solution.

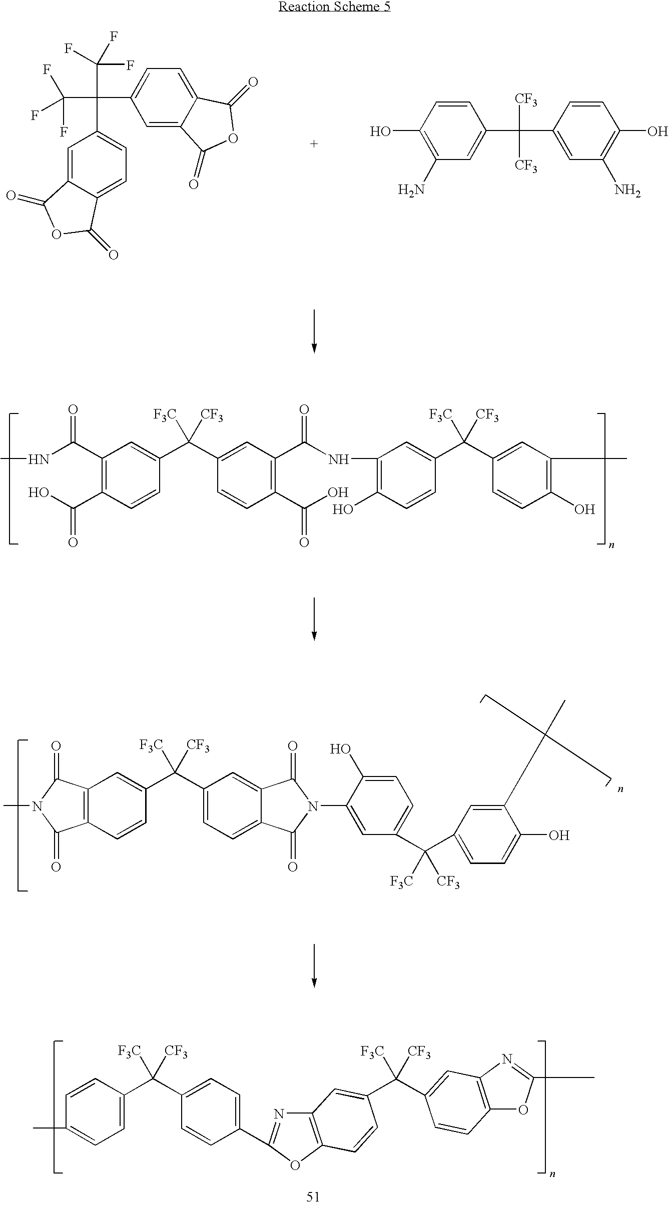

(1) Preparation of Polyhydroxyimide

A 250 ml reactor fitted with a teflon stirring system, an inlet for an inert gas, such as nitrogen, and placed in an oil bath to constantly maintain the reaction temperature at −15° C. The reactor was charged with 3.66 g (0.1 mol) of 2,2′-bis(3-amino-4-hydroxy-phenyl)hexafluoropropane and N-methylpyrrolidone (NMP) as a solvent. 44.4 g (0.1 mol) of 4,4′-(hexafluoroisopropylidene)diphthalic anhydride was slowly added into the solution. Then, the solution was allowed to react for about 4 hours to prepare a pale yellow viscous polyhydroxyamic acid. Subsequently, the oil bath was heated to temperature of 80° C. and 16.1 ml (0.2 mol) of pyridine and 18.9 ml (0.2 mol) of acetic anhydride was added into the solution and allowed to react for about 12 hours at 180° C. to prepare a pale yellow viscous polyhyroxyimide.

(2) Preparation of Dope Solution

The resulting polyhydroxyimide and 10% by weight of ethanol as an additive were added to 243 g (75 wt %) of NMP and then mixed to prepare a homogeneous dope solution.

(3) Preparation of Hollow Fiber

The dope solution thus prepared was defoamed at ambient temperature under reduced pressure for 24 hours, and foreign materials were removed using a glass filter (pore diameter: 60 μm). Subsequently, the resulting solution was allowed to stand at 25° C. and was then spun through a double-ring nozzle.

At this time, distilled water was used as an internal coagulating solution and an air gap was set at 50 cm. The spun hollow fiber was coagulated in a coagulation bath-containing water at 25° C. and was then wound at a rate of 20 m/min. The resulting hollow fiber was washed, air-dried at ambient temperature for 3 days, thermally treated under an inert atmosphere at 450° C. for one hour to prepare a hollow fiber thermally rearranged into polybenzoxazole represented by Formula 51.

The hollow fiber thus prepared had a weight average molecular weight of 48,960 Da. As a result of FT-IR analysis, characteristic bands of polybenzoxazole at 1,553 cm⁻¹, 1,480 cm⁻¹ (C═N) and 1,058 cm⁻¹ (C—O) which were not detected in polyimide were confirmed.

### Example 2

A hollow fiber was prepared in the same manner as in Example 1, except that the polyhydroxyimide was prepared without pyridine and acetic anhydride by solution-thermal imidization at 200° C. for 12 hour in solution.

The hollow fiber thus prepared had a weight average molecular weight of 19,240 Da. As a result of FT-IR analysis, characteristic bands of polybenzoxazole at 1,553 cm⁻¹, 1,480 cm⁻¹ (C═N) and 1,058 cm⁻¹ (C—O) which were not detected in polyimide were confirmed.

### Example 3

A hollow fiber comprising a polybenzothiazole represented by Formula 52 was prepared through the following reactions.

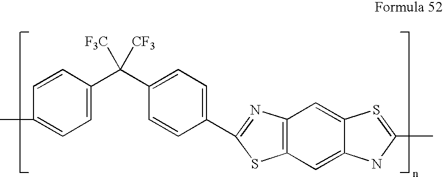

A hollow fiber thermally rearranged into polybenzothiazole represented by Formula 52 was prepared in the same manner as in Example 1, except that 20.8 g (0.1 mol) of 2,5-diamino-1,4-benzenedithiol dihydrochloride and 44.4 g (0.1 mol) of 4,4′-(hexafluoroisopropylidene)diphthalic anhydride as starting materials were reacted to prepare thiol group (—SH)-containing polyimide.

The hollow fiber thus prepared had a weight average molecular weight of 32,290 Da. As a result of FT-IR analysis, characteristic bands of polybenzothiazole at 1,484 cm⁻¹ (C—S) and 1,404 cm⁻¹ (C—S) which were not detected in polyimide were confirmed.

### Example 4

A hollow fiber comprising polybenzopyrrolone represented by Formula 53 was prepared through the following reactions.

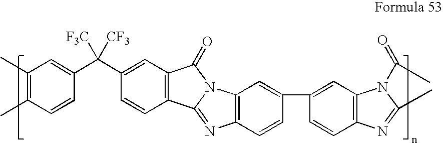

A hollow fiber thermally rearranged into polybenzopyrrolone represented by Formula 53 was prepared in the same manner as in Example 1, except that 21.4 g (0.1 mol) of 3,3′-diaminobenzidine as a starting material was reacted with 44.4 g (0.1 mol) of 4,4′-(hexafluoroisopropylidene)diphthalic anhydride to prepare an amine group (—NH₂)-containing polyimide.

The prepared hollow fiber had a weight average molecular weight of 37,740 Da. As a result of FT-IR analysis, characteristic bands of polybenzopyrrolone at 1,758 cm⁻¹ (C═O) and 1,625 cm⁻¹ (C═N) which were not detected in polyimide were confirmed.

### Example 5

A hollow fiber comprising polybenzoxazole represented by Formula 54 was prepared through the following reactions.

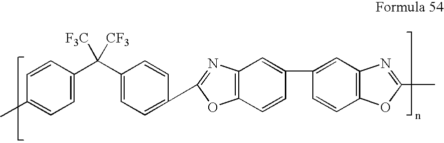

A hollow fiber thermally rearranged into polybenzoxazole represented by Formula 54 was prepared in the same manner as in Example 1, except that 21.6 g (0.1 mol) of 3,3′-dihydroxybenzidine as starting materials was reacted with 44.4 g (0.1 mol) of 4,4′-(hexafluoroisopropylidene)diphthalic anhydride to prepare an hydroxy group (—OH)-containing polyimide.

The hollow fiber thus prepared had a weight average molecular weight of 21,160 Da. As a result of FT-IR analysis, characteristic bands of polybenzoxazole at 1,553 cm⁻¹, 1,480 cm⁻¹ (C═N) and 1,052 cm⁻¹ (C—O) which were not detected in polyimide were confirmed.

### Example 6

A hollow fiber comprising polybenzopyrrolone represented by Formula 55 was prepared through the following reactions.

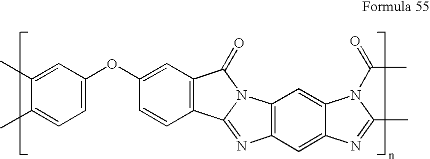

A hollow fiber thermally rearranged into polybenzopyrrolone represented by Formula 55 was prepared in the same manner as in Example 1, except that 28.4 g (0.1 mol) of benzene-1,2,4,5-tetramine tetrahydrochloride as a starting material was reacted with 31.0 g (0.1 mol) of 4,4′-oxydiphthalic anhydride to prepare an amine group (—NH₂)-containing polyimide.

The hollow fiber thus prepared had a weight average molecular weight of 33,120 Da. As a result of FT-IR analysis, characteristic bands of polybenzopyrrolone at 1,758 cm⁻¹ (C═O) and 1,625 cm⁻¹ (C═N), which were not detected in polyimide were confirmed.

### Example 7

A hollow fiber comprising a benzoxazole copolymer represented by Formula 56 was prepared through the following reactions.

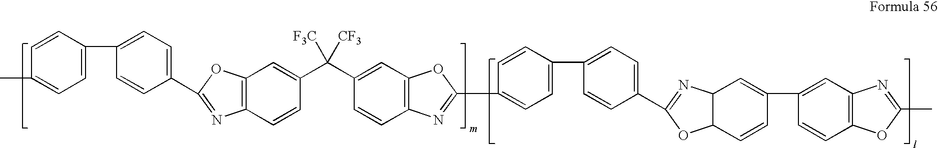

A hollow fiber thermally rearranged into a benzoxazole copolymer (molar ratio of benzoxazole:benzoxazole=5:5) represented by Formula 56 was prepared in the same manner as in Example 1, except that 36.6 g (0.1 mol) of 2,2′-bis(3-amino-4-hydroxy-phenyl)hexafluoropropane and 21.6 g (0.1 mol) of 3,3′-dihydroxybenzidine as starting materials were reacted with 58.8 g (0.2 mol) of 4,4′-biphthalic anhydride to prepare a polyhydroxyimide copolymer.

The hollow fiber thus prepared had a weight average molecular weight of 24,860 Da. As a result of FT-IR analysis, characteristic bands of polybenzoxazole at 1,553 cm⁻¹, 1,480 cm⁻¹ (C═N) and 1,058 cm⁻¹ (C—O) which were not detected in polyimide were confirmed.

### Example 8

A hollow fiber comprising a benzoxazole-imide copolymer represented by Formula 57 was prepared through the following reactions.

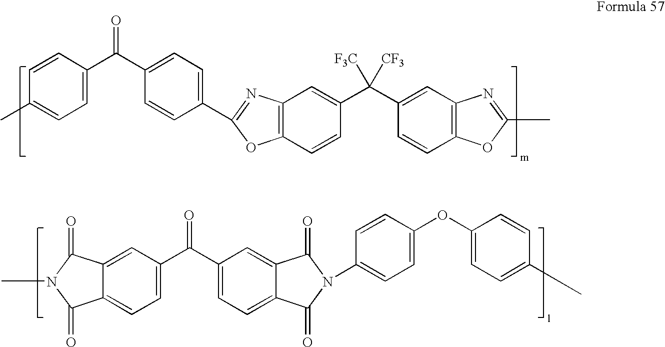

A hollow fiber thermally rearranged into a benzoxazole-imide copolymer (molar ratio of benzoxazole:imide=8:2) represented by Formula 57 was prepared in the same manner as in Example 1, except that 58.60 g (0.16 mol) of 2,2′-bis(3-amino-4-hydroxy-phenyl)hexafluoropropane and 8.01 g (0.04 mol) of 4,4′-diaminodiphenylether as starting materials were reacted with 64.45 g (20 mol) of 3,3′,4,4′-benzophenonetetracarboxylic dianhydride to prepare a polyimide copolymer.

The hollow fiber thus prepared had a weight average molecular weight of 35,470 Da. As a result of FT-IR analysis, characteristic bands of polybenzoxazole at 1,553 cm⁻¹, 1,480 cm⁻¹ (C═N) and 1,058 cm⁻¹ (C—O), and characteristic bands of polyimide at 1,720 cm⁻¹ (C═O) and 1,580 cm⁻¹ (C═O).

### Example 9

A hollow fiber comprising a benzopyrrolone-imide copolymer represented by Formula 58 was prepared through the following reactions.

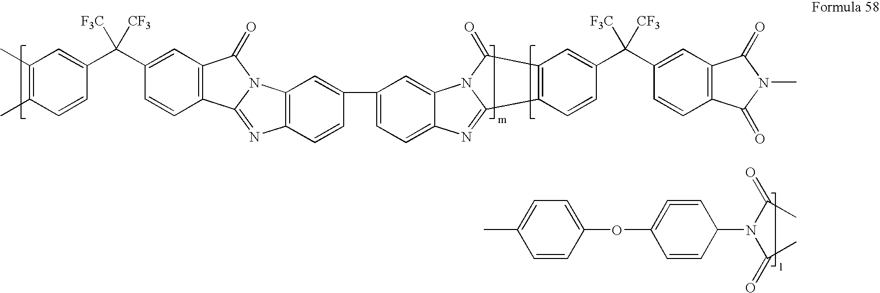

A hollow fiber thermally rearranged into a benzopyrrolone-imide copolymer (molar ratio of benzopyrrolone:imide=8:2) represented by Formula 58 was prepared in the same manner as in Example 1, except that 17.1 g (0.08 mol) of 3,3′-diaminobenzidine and 4.0 g (0.02 mol) of 4,4′-diaminidiphenylether as starting materials were reacted with 44.4 g (0.1 mol) of 4,4′-(hexafluoroisopropylidene)diphthalic anhydride to prepare a polyimide copolymer.

The hollow fiber thus prepared had a weight average molecular weight of 52,380 Da. As a result of FT-IR analysis, characteristic bands of polypyrrolone at 1,758 cm⁻¹ (C═O) and 1,625 cm⁻¹ (C═N) and characteristic bands of polyimide at 1,720 cm⁻¹ (C═O) and 1,580 cm⁻¹ (C═O).

### Example 10

A hollow fiber comprising a benzothiazole-imide copolymer represented by Formula 59 was prepared through the following reactions.

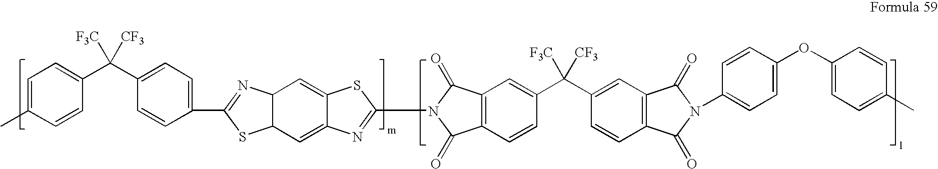

A hollow fiber thermally rearranged into a benzothiazole-imide copolymer (molar ratio of benzothiazole:imide=8:2) represented by Formula 59 was prepared in the same manner as in Example 1, except that 33.30 g (0.16 mol) of 2,5-diamino-1,4-benzenedithiol dihydrochloride and 8.0 g (0.04 mol) of 4,4′-diaminodiphenylether as starting materials were reacted with 88.8 g (0.1 mol) of 4,4′-(hexafluoroisopropylidene)diphthalic anhydride to prepare a polyimide copolymer.

The hollow fiber thus prepared had a weight average molecular weight of 18,790 Da. As a result of FT-IR analysis, characteristic bands of polybenzothiazole at 1,484 cm⁻¹ (C—S) and 1,404 cm⁻¹ (C—S) and characteristic bands of polyimide at 1,720 cm⁻¹ (C═O) and 1,580 cm⁻¹ (C═O).

### Example 11

A hollow fiber comprising a benzoxazole-benzothiazole copolymer represented by Formula 60 was prepared through the following reactions.

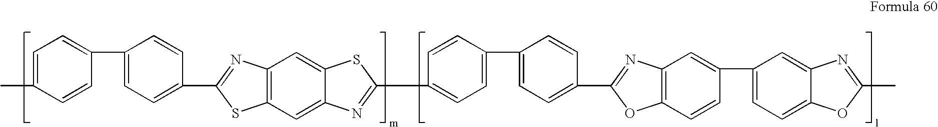

A hollow fiber thermally rearranged into a benzoxazole-benzothiazole copolymer (molar ratio of benzoxazole:benzothiazole=5:5) represented by Formula 60 was prepared in the same manner as in Example 1, except that 10.8 g (0.05 mol) of 3,3′-dihydroxybenzidine and 10.9 g (0.05 mol) of 2,5-diamino-1,4-benzenedithiol dihydrochloride as starting materials were reacted with 44.4 g (10 mmol) of 4,4′-(hexafluoroisopropylidene)diphthalic anhydride to prepare a polyimide copolymer.

The hollow fiber thus prepared had a weight average molecular weight of 13,750 Da. As a result of FT-IR analysis, characteristic bands of polybenzoxazole at 1,553 cm⁻¹, 1,480 cm⁻¹ (C═N) and 1,052 cm⁻¹ (C—O), and characteristic bands of polybenzothiazole at 1,484 cm⁻¹ (C—S) and 1,404 cm⁻¹ (C—S) which were not detected in polyimide were confirmed.

### Example 12

A hollow fiber comprising a benzopyrrolone copolymer represented by Formula 61 was prepared through the following reactions.

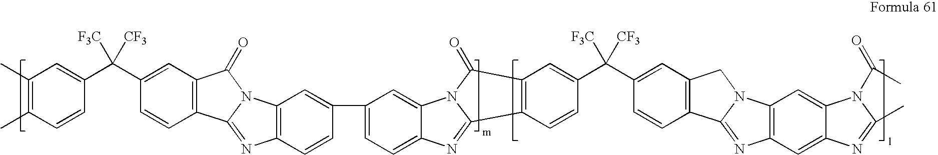

A hollow fiber thermally rearranged into a benzopyrrolone copolymer (molar ratio of benzopyrrolone:benzopyrrolone=8:2) represented by Formula 61 was prepared in the same manner as in Example 1, except that 34.2 g (0.16 mol) of 3,3′-diaminobenzidine and 11.4 g (0.04 mol) of benzene-1,2,4,5-tetramine tetrahydrochloride as starting materials were reacted with 88.8 g (20 mmol) of 4,4′-(hexafluoroisopropylidene)diphthalic anhydride to prepare a polyaminoimide copolymer.

The hollow fiber thus prepared had a weight average molecular weight of 64,820 Da. As a result of FT-IR analysis, characteristic bands of polybenzopyrrolone at 1,758 cm⁻¹ (C═O) and 1,625 cm⁻¹ (C═O) which were not detected in polyimide were confirmed.

### Example 13

A hollow fiber comprising a benzoxazole-benzothiazole copolymer represented by Formula 62 was prepared through the following reactions.

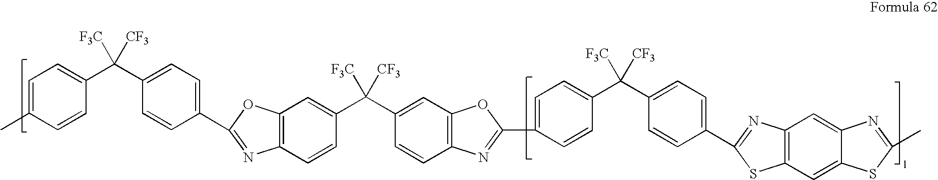

A hollow fiber thermally rearranged into a benzoxazole-benzothiazole copolymer (molar ratio of benzoxazole:benzothiazole=8:2) represented by Formula 62 was prepared in the same manner as in Example 1, except that 21.8 g (0.1 mol) of 2,5-diamino-1,4-benzenedithiol dihydrochloride and 36.6. g (0.16 mol) of 2,2′-bis(3-amino-4-hydroxyphenyl)hexafluoropropane as starting materials were reacted with 88.8 g (20 mmol) of 4,4′-(hexafluoroisopropylidene)diphthalic anhydride to prepare a polyhydroxyimide-polythiolimide copolymer.

The hollow fiber thus prepared had a weight average molecular weight of 46,790 Da. As a result of FT-IR analysis, characteristic bands of polybenzoxazole at 1,553 cm⁻¹, 1,480 cm⁻¹ (C═N) and 1,058 cm⁻¹ (C—O), and characteristic bands of polybenzothiazole at 1,484 cm⁻¹ (C—S) and 1,404 cm⁻¹ (C—S) which were not detected in polyimide were confirmed.

### Example 14

A hollow fiber was prepared in the same manner as in Example 1, except that 5% by weight of tetrahydrofurane and 15% by weight of propylene glycol as additives were added and then mixed to prepare a homogeneous solution.

### Example 15

A hollow fiber was prepared in the same manner as in Example 1, except that 5% by weight of tetrahydrofurane and 15% by weight of ethanol as additives were added and then mixed to prepare a homogeneous solution.

### Example 16

A hollow fiber was prepared in the same manner as in Example 1, except that 15% by weight of polyethylene glycol (Aldrich, pore controller, molecular weight: 2,000) was added as an additive and mixed to prepare a homogeneous solution.

### Example 17

A hollow fiber was prepared in the same manner as in Example 1, except that thermal treatment was performed at 400° C. for one hour.

### Example 18

A hollow fiber was prepared in the same manner as in Example 1, except that thermal treatment was performed at 350° C. for one hour.

### Comparative Example 1

As disclosed in Korean Patent Laid-open No. 2002-0015749, 35% by weight of polyether sulfone (Sumitomo, sumikaexcel) was dissolved in 45% by weight of NMP, 5% by weight of tetrahydrofurane and 15% by weight of ethanol as additives were added thereto to prepare a homogeneous solution. Then, the solution was spun through a double nozzle with a 10 cm air gap. The resulting solution was washed with flowing water for 2 days and dried under vacuum for 3 hours or more to prepare a hollow fiber.

### Comparative Example 2

A hollow fiber was prepared in the same manner as in Example 1, except that thermal treatment was not performed.

### Comparative Example 3

As disclosed in PCT Patent Publication No. WO2005/007277, a 19% by weight solution of a polyamic acid (PAA) was prepared from 4,4′-diaminodiphenyl ether (ODA) and benzophenone tetracarboxylic dianhydride (BTDA) in N-methylpyrrolidone (NMP) as a solvent. A solution containing 50% by weight of polyvinylpyrrolidone (PVP) in NMP was added to the PAA solution. Then, glycerol and NMP were added to the solution. The final solution had a composition of PAA/PVP/GLY/NMP of 13/1/17/69 by wt %. The solution was mixed for a period of about 12 hours prior to spinning.

20° C. water was used as an internal coagulant and the spinning solution was spun through a spinneret. The flow rate of the internal coagulant was adjusted to 12 ml/min. The hollow fiber was spun at a rate of 4 cm/s such that the retention time in an air cap was adjusted to 6 seconds. At this time, the hollow fiber membrane was coagulated in 100% water at 30° C. Subsequently, the membrane was washed with water for 2 to 4 hours at ambient temperature until the remaining solvent and glycerol were completely extracted. In addition, the membrane was dried in air. Then, the membrane was imidized in an oven equipped with a nitrogen purge. The membrane was heated to 150° C. over a period of three hours, heated at 150° C. for one hour, heated to 250° C. over a period of two hours, heated at 250° C. for two hours and slowly cooled to ambient temperature over a period of 4 hours. The polyimide/PVP membrane thus prepared had an outer diameter of 2.2 mm and a thickness of 0.3 mm.

### Experimental Example 1

### Scanning Electron Microscopy

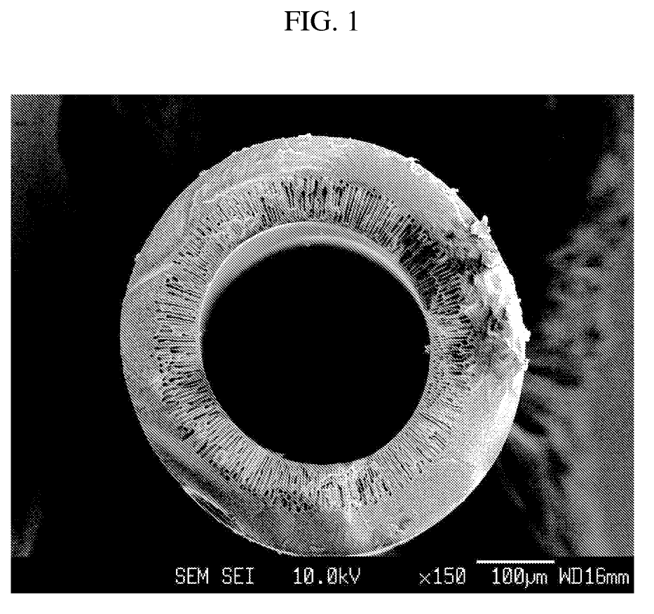

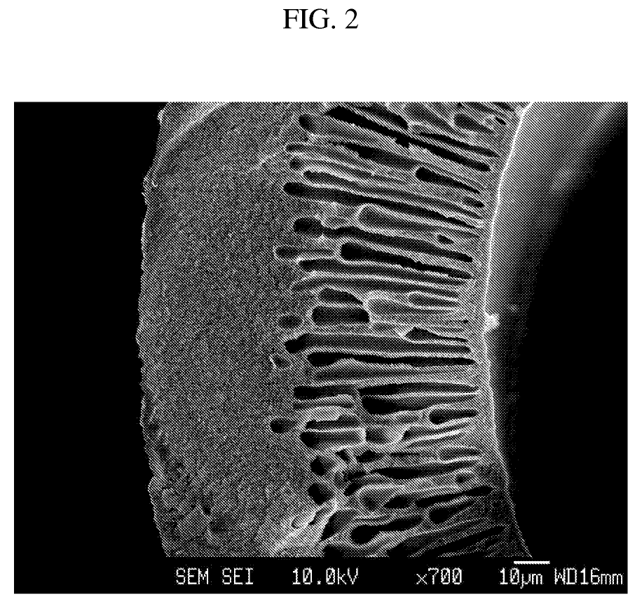

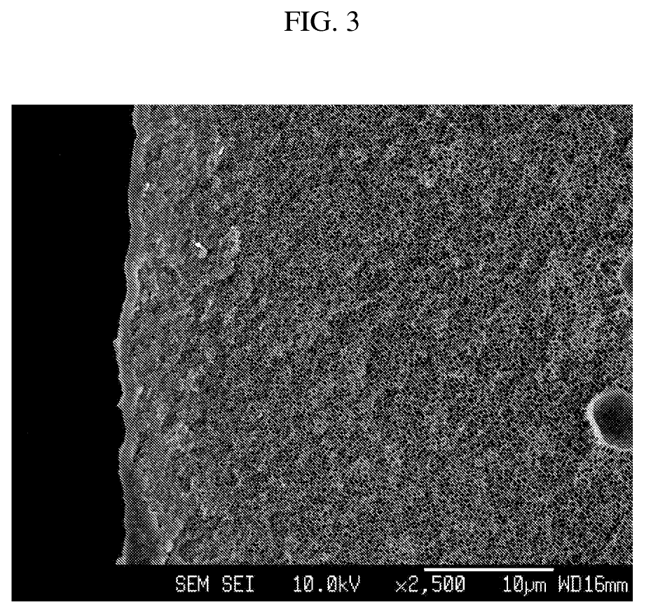

FIGS. 1, 2 and 3 are cross-section scanning electron microscope (SEM) images of hollow fibers prepared in Example 1 of the present invention at 150×, 700× and 2,500× magnifications, respectively.

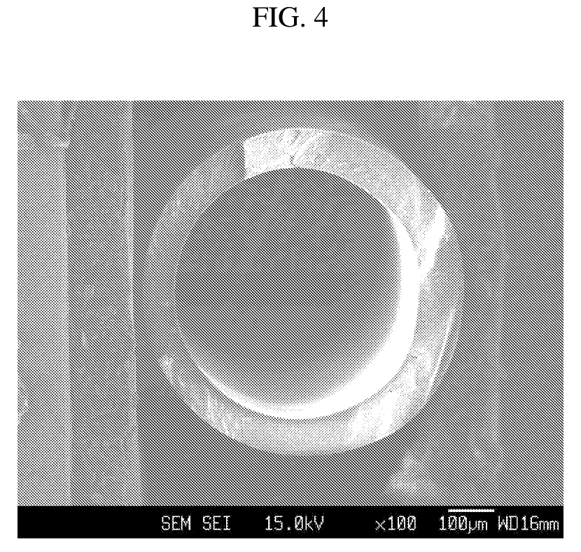

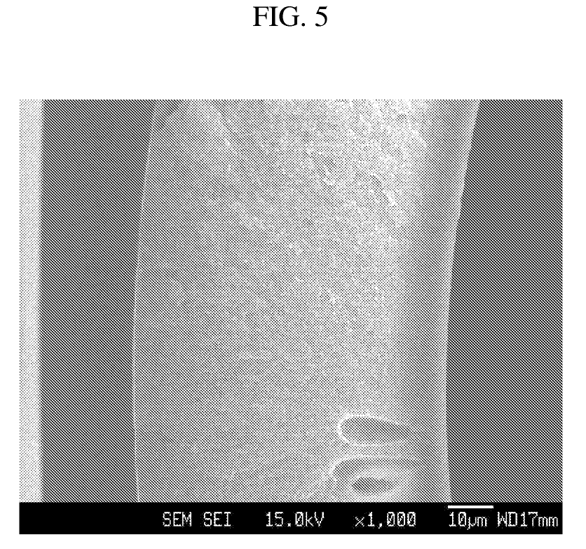

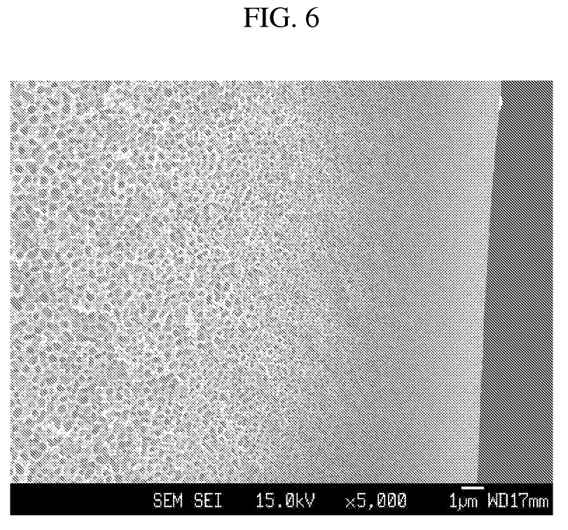

FIGS. 4, 5 and 6 are cross-section scanning electron microscope (SEM) images of hollow fibers prepared in Example 8 of the present invention at 100×, 1,000× and 5,000× magnifications, respectively.

As can be seen from FIGS. 1 to 6, the hollow fibers of the present invention have surface defect-free separation layers.

### Experimental Example 2

### Measurement of Permeability and Selectivity

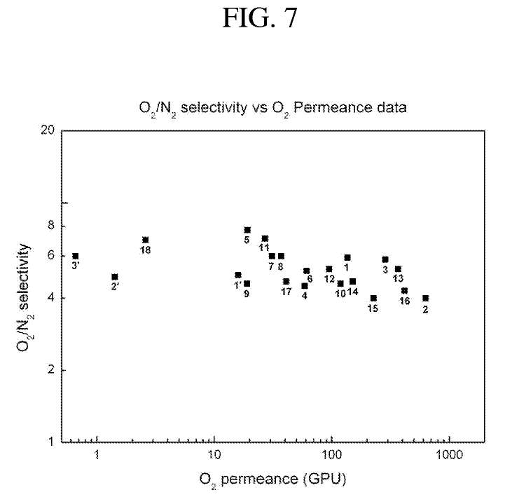

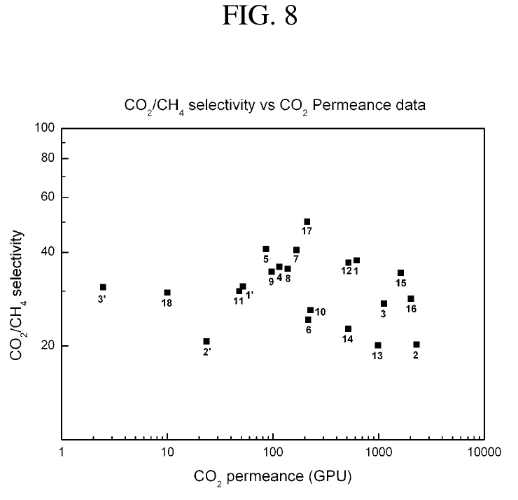

In order to ascertain gas permeability and selectivity of the hollow fibers prepared in Examples 1 to 18 and Comparative Examples 1 to 3, the following processes were performed. The results are shown in Table 1 and FIGS. 7 and 8.

The term “gas permeability” is an index indicating a speed at which a gas permeates through a membrane. A separation membrane module for gas permeability measurement was prepared from the prepared hollow fiber and gas permeation flow was calculated using the following Equation 1. The gas permeation unit used herein was GPU (Gas Permeation Unit, 1×10⁻⁶ cm³/cm²·sec·cmHg).

“Selectivity” was derived from a permeability ratio between respective gases measured with the same membrane.

$$P = \frac{d p}{d t} [ \frac{{VT}_{0}}{{P}_{0} {TP}_{f} {A}_{eff}} ] \qquad Equation 1$$

wherein P is a gas permeability; dp/dt is a pressure increase rate in a normal state; V is lower part volume; P_{f} is pressure difference between the upper and lower parts; T is temperature upon measurement; A_{eff} is an effective area; and P₀ and T₀ are standard pressure and standard temperature, respectively.

TABLE 1

| | H₂ | O₂ | CO₂ | O₂/N₂ | |
|---|---|---|---|---|---|
| | permeability | permeability | permeability | selec- | CO₂/CH₄ |
| | (GPU) | (GPU) | (GPU) | tivity | selectivity |
| Ex. 1 | 542 | 136 | 619 | 5.9 | 37.7 |
| Ex. 2 | 1680 | 630 | 2280 | 4.0 | 20.2 |
| Ex. 3 | 1270 | 286 | 985 | 5.8 | 20.1 |
| Ex. 4 | 116 | 59 | 115 | 4.5 | 35.9 |
| Ex. 5 | 131 | 19.2 | 86 | 7.7 | 41.0 |
| Ex. 6 | 292 | 61 | 216 | 5.2 | 24.3 |
| Ex. 7 | 165 | 31 | 167 | 6.0 | 40.7 |
| Ex. 8 | 215 | 37 | 138 | 6.0 | 35.4 |
| Ex. 9 | 85 | 19 | 97 | 4.6 | 34.6 |
| Ex. 10 | 615 | 119 | 227 | 4.6 | 26.1 |
| Ex. 11 | 86 | 27 | 48 | 7.1 | 30.0 |
| Ex. 12 | 419 | 95 | 519 | 5.3 | 37.1 |
| Ex. 13 | 1320 | 368 | 1125 | 5.3 | 27.4 |
| Ex. 14 | 875 | 151 | 516 | 4.7 | 22.7 |
| Ex. 15 | 1419 | 227 | 1619 | 4.0 | 34.4 |
| Ex. 16 | 1824 | 418 | 2019 | 4.3 | 28.4 |
| Ex. 17 | 211 | 41 | 211 | 4.7 | 50.2 |
| Ex. 18 | 35 | 2.6 | 10 | 7.0 | 29.7 |
| Comp. | 65 | 16 | 52 | 5.0 | 31.1 |
| Ex. 1 | | | | | |
| Comp. | 21.7 | 1.42 | 23.6 | 4.9 | 20.7 |
| Ex. 2 | | | | | |
| Comp. | 12.1 | 0.66 | 2.47 | 6.0 | 30.9 |
| Ex. 3 | | | | | |

As can be seen from Table 1, the hollow fiber of the present invention exhibited superior permeability to gas species such as H₂, O₂ and CO₂, as compared to the Comparative Examples.

FIG. 7 is a graph comparing oxygen permeability (GPU) and oxygen/nitrogen selectivity for hollow fibers prepared in Examples 1 to 18 of the present invention and Comparative Examples 1 to 3.

FIG. 8 is a graph comparing carbon dioxide permeability (GPU) and carbon dioxide/methane selectivity for hollow fibers prepared in Examples 1 to 18 of the present invention and Comparative Examples 1 to 3.

As can be seen from FIGS. 7 and 8, the hollow fibers of the present invention exhibited similar oxygen/nitrogen selectivity or carbon dioxide/methane selectivity, but showed superior permeability, as compared to the Comparative Examples.

What is claimed is:

1. A dope solution composition comprising:
(a) a polymer for forming a hollow fiber, including one selected from the group consisting of polyimides represented by the following Formulae 1 to 4, polyimide copolymers represented by Formulae 5 to 8, copolymers thereof and blends thereof;
(b) an organic solvent; and
(c) an additive. 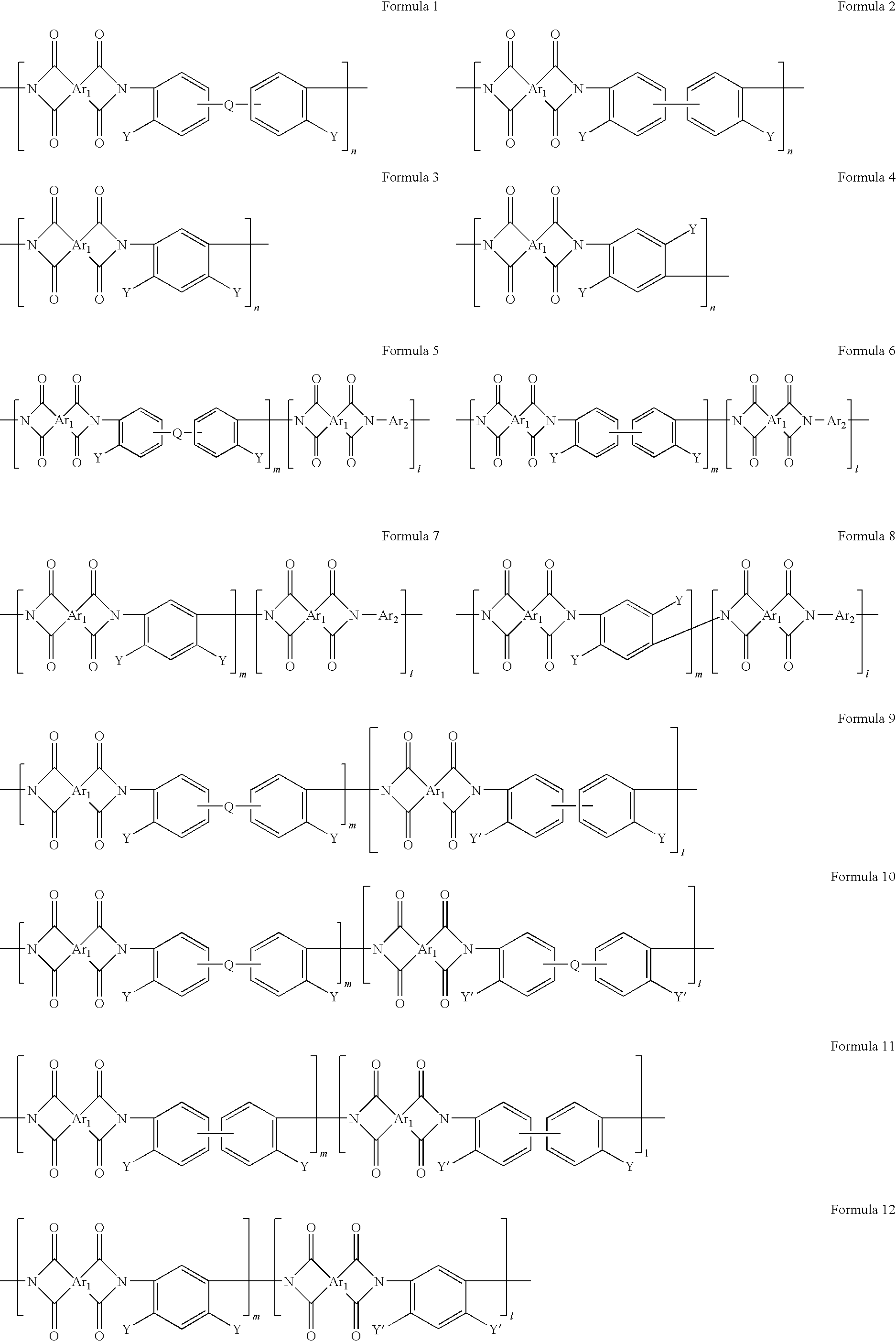 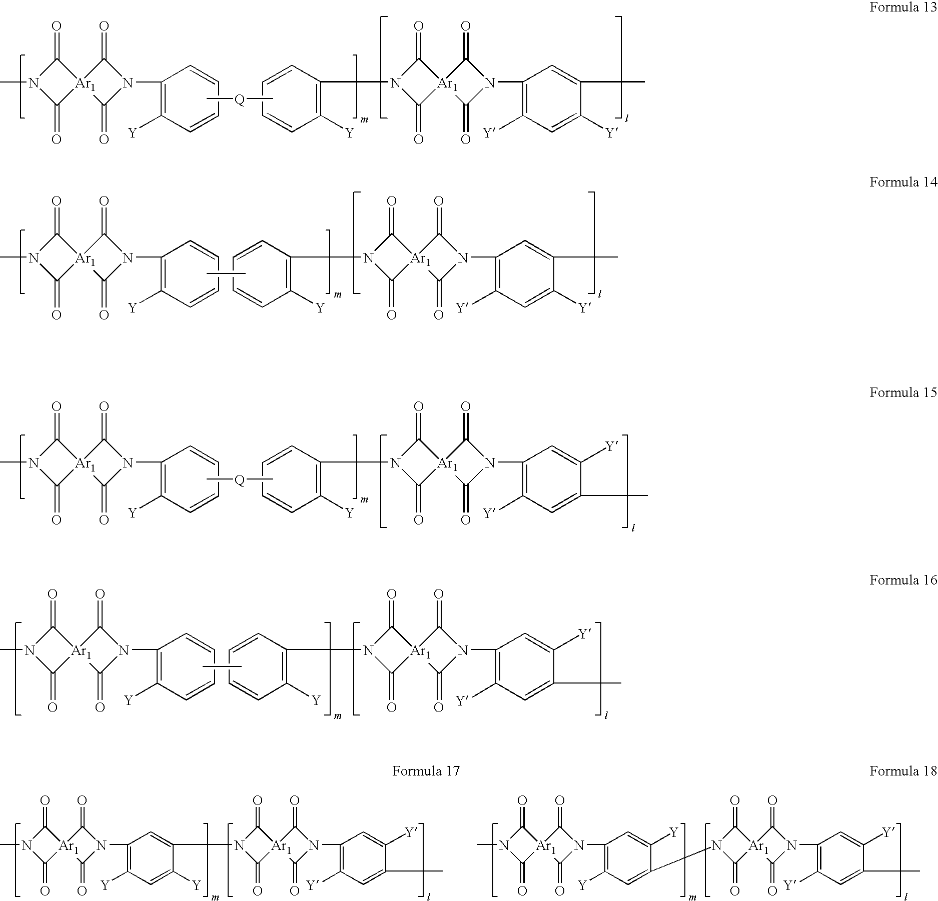
In Formulae 1 to 18,
Ar₁ is a tetravalent C₅-C₂₄ arylene group or a tetravalent C₅-C₂₄ heterocyclic ring, which is substituted or unsubstituted with at least one substituent selected from the group consisting of C₁-C₁₀ alkyl, C₁-C₁₀ alkoxy, C₁-C₁₀ haloalkyl and C₁-C₁₀ haloalkoxy, or two or more of which are fused together to form a condensation ring or covalently bonded to each other via a functional group selected from the group consisting of O, S, C(═O), CH(OH), S(═O)₂, Si(CH₃)₂, (CH₂)ₚ (in which 1≦p≦110), (CF₂)_{q} (in which 1≦q≦10), C(CH₃)₂, C(CF₃)₂ and C(═O)NH;
Ar₂ is a bivalent C₅-C₂₄ arylene group or a bivalent C₅-C₂₄ heterocyclic ring, which is substituted or unsubstituted with at least one substituent selected from the group consisting of C₁-C₁₀ alkyl, C₁-C₁₀ alkoxy, C₁-C₁₀ haloalkyl and C₁-C₁₀ haloalkoxy, or two or more of which are fused together to form a condensation ring or covalently bonded to each other via a functional group selected from the group consisting of O, S, C(═O), CH(OH), S(═O)₂, Si(CH₃)₂, (CH₂)ₚ (in which 1≦p≦10), (CF₂)_{q} (in which 1≦q≦10), C(CH₃)₂, C(CF₃)₂ and C(═O)NH;
Q is O, S, C(═O), CH(OH), S(═O)₂, Si(CH₃)₂, (CH₂)ₚ (in which 1≦p≦110), (CF₂)_{q} (in which 1≦q≦10), C(CH₃)₂, C(CF₃)₂, C(═O)NH, C(CH₃)(CF₃), C₁-C₆ alkyl-substituted phenyl or C₁-C₆ haloalkyl-substituted phenyl in which Q is linked to opposite both phenyl rings in the position of m-m, m-p, p-m or p-p;
Y is —OH, —SH or —NH₂;
Y′ is different from Y and is —OH, —SH or —NH₂;
n is an integer from 20 to 200;
m is an integer from 10 to 400; and
l is an integer from 10 to 400.

2. The dope solution composition according to claim 1, wherein Ar₁ is selected from the following compounds: 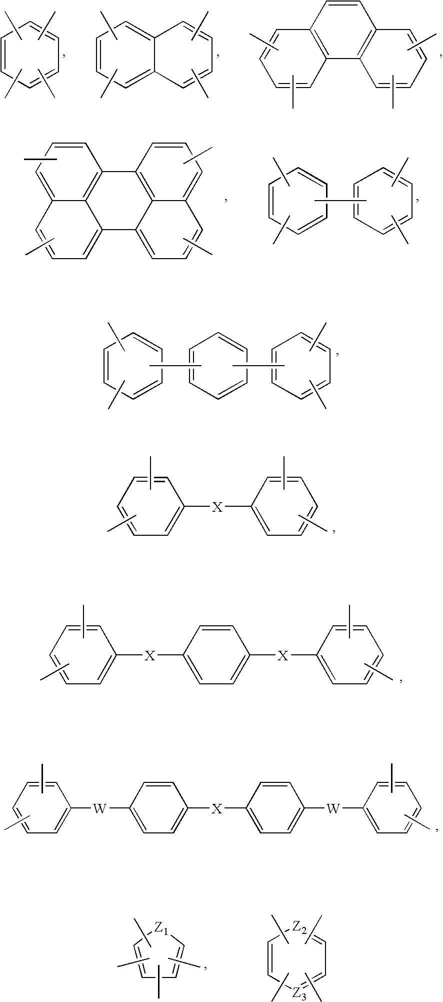
wherein X is O, S, C(═O), CH(OH), S(═O)₂, Si(CH₃)₂, (CH₂)ₚ (in which 1≦p≦110), (CF₂)_{q} (in which 1≦q≦10), C(CH₃)₂, C(CF₃)₂, or C(═O)NH; W is O, S or C(═O); and Z₁, Z₂ and Z₃ are identical to or different from each other and are O, N or S.

3. The dope solution composition according to claim 1, wherein Ar₁ is selected from the following compounds:

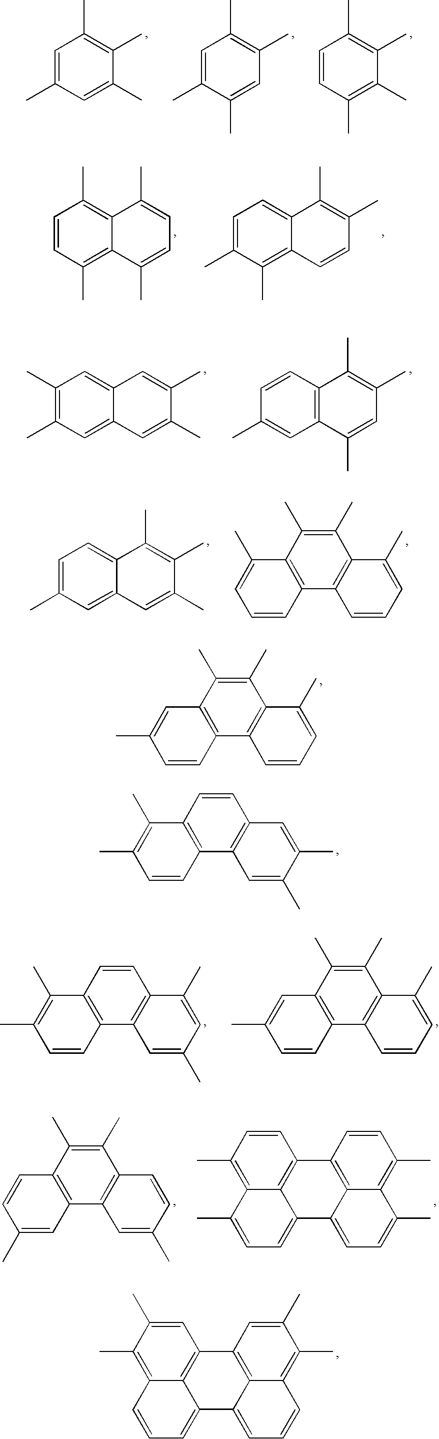

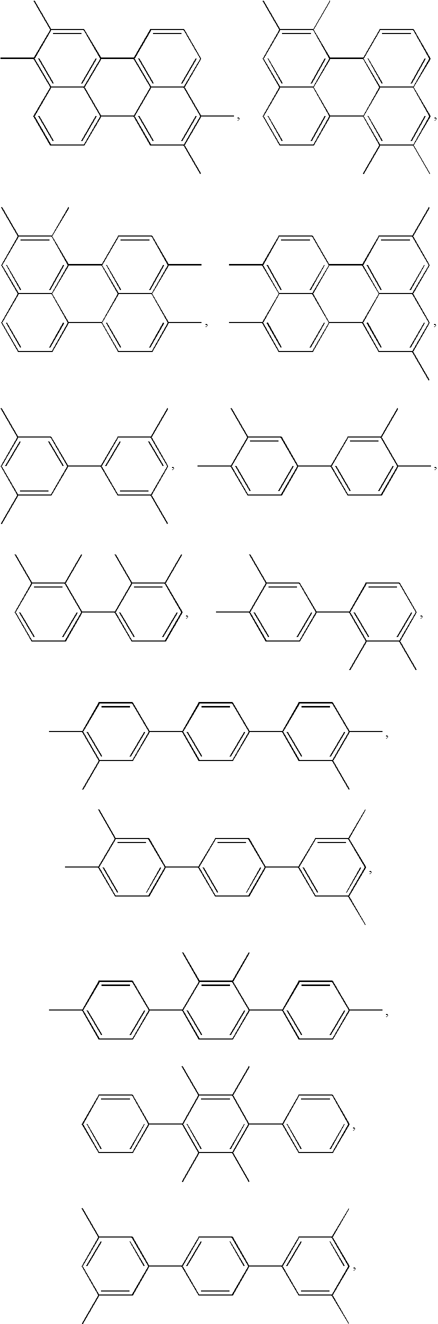

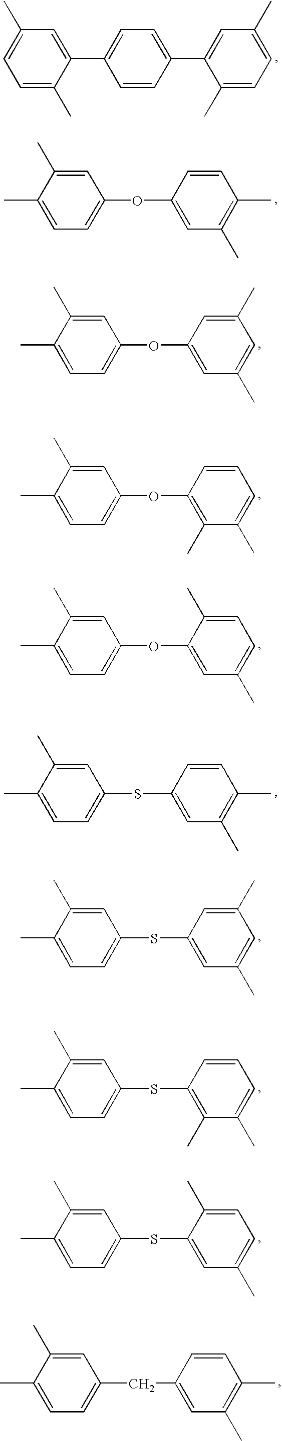

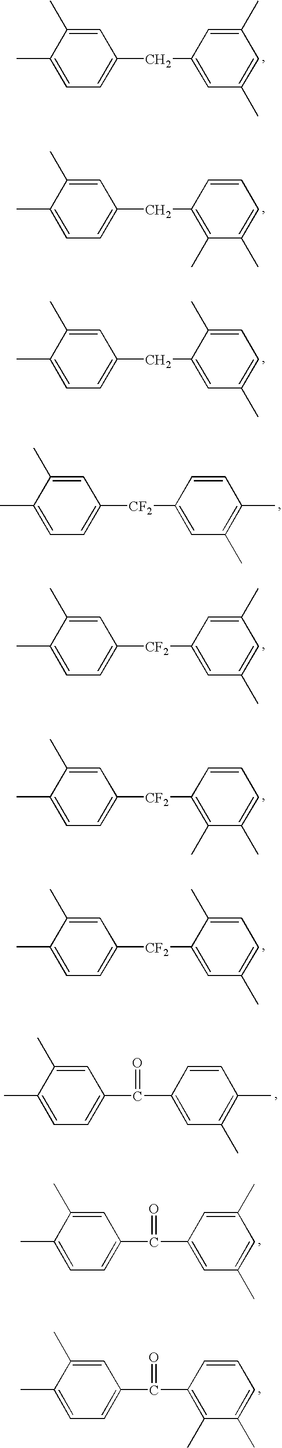

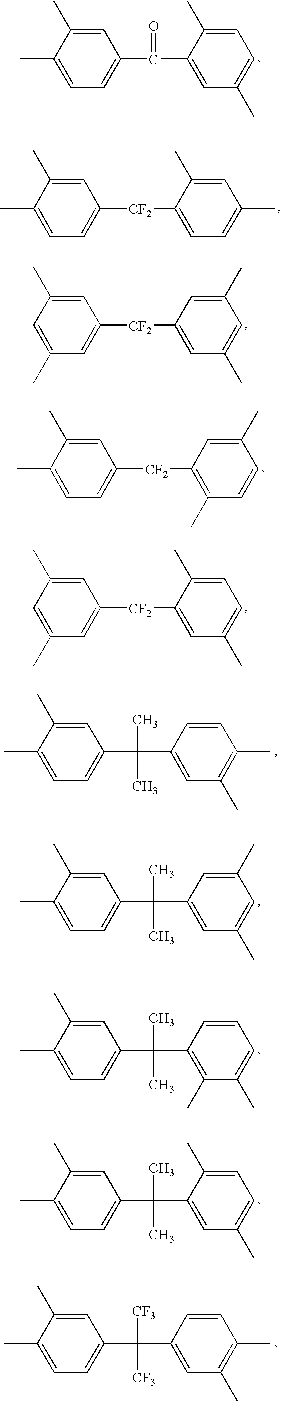

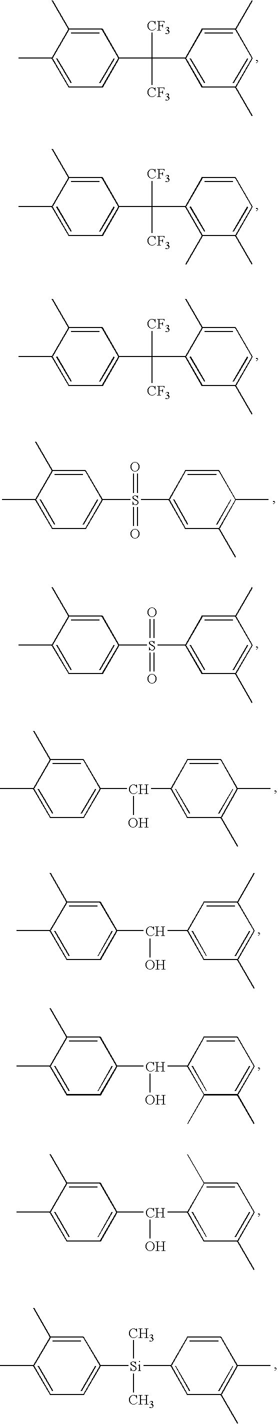

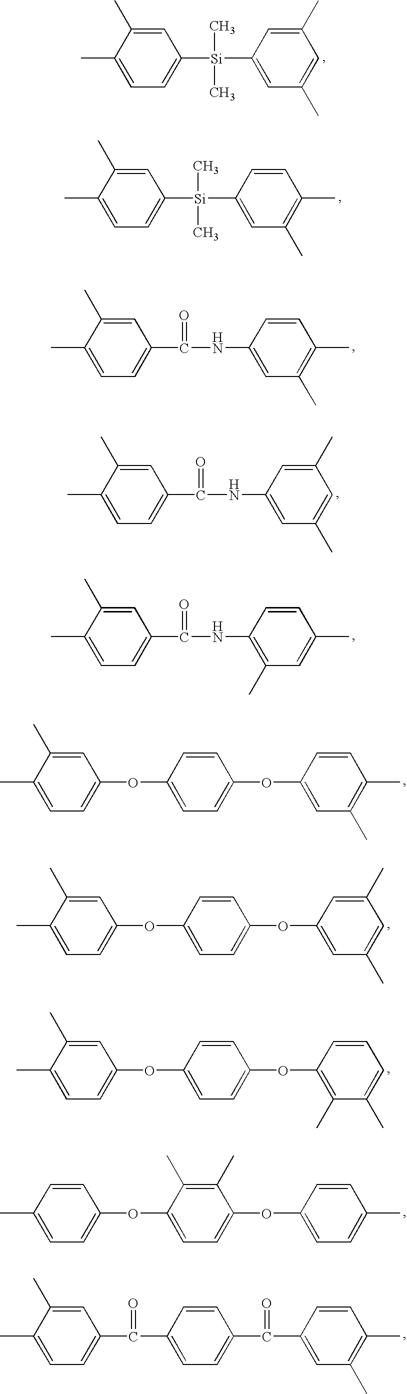

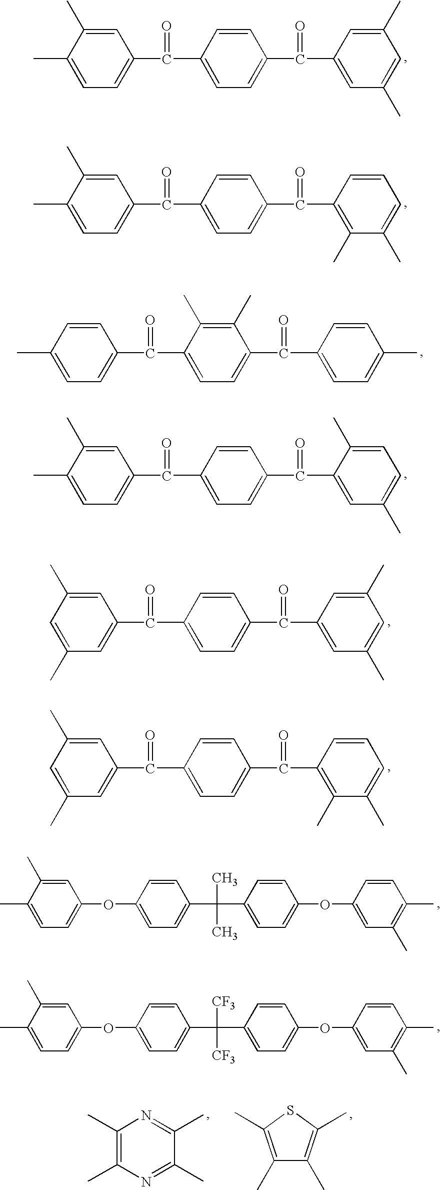

4. The dope solution composition according to claim 1, wherein Ar₂ is selected from the following compounds: 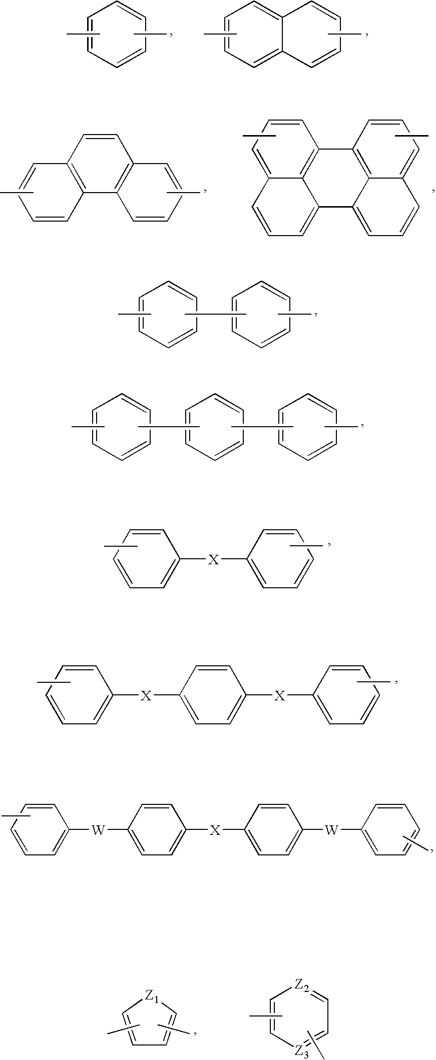
wherein X is O, S, C(═O), CH(OH), S(═O)₂, Si(CH₃)₂, (CH₂)ₚ (in which 1≦p≦110), (CF₂)_{q} (in which 1≦q≦10), C(CH₃)₂, C(CF₃)₂, or C(═O)NH; W is O, S or C(═O); and Z₁, Z₂ and Z₃ are identical to or different from each other and are O, N or S.

5. The dope solution composition according to claim 1, wherein Ar₂ is selected from the following compounds:

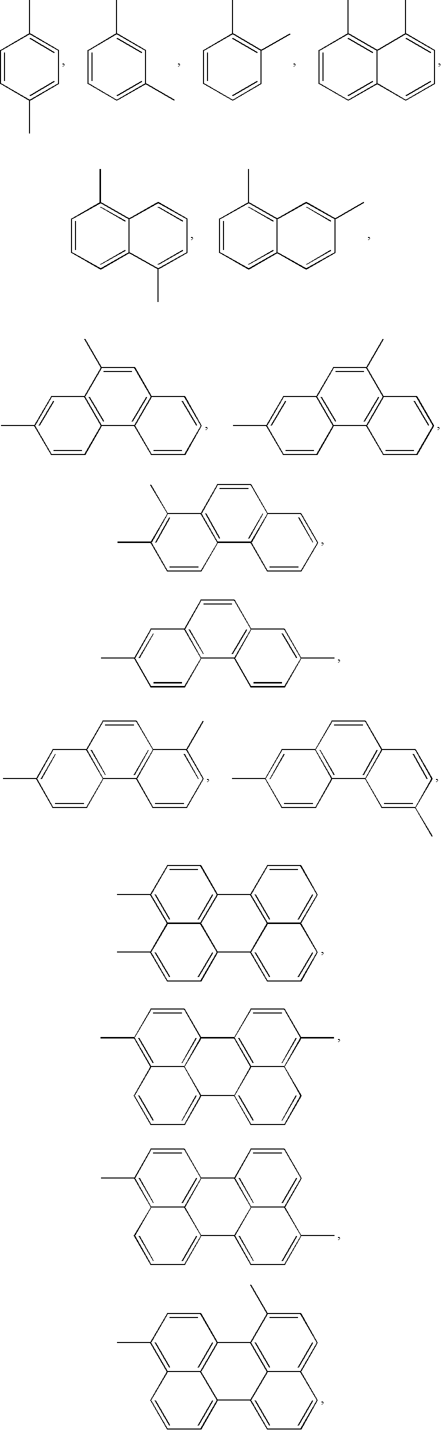

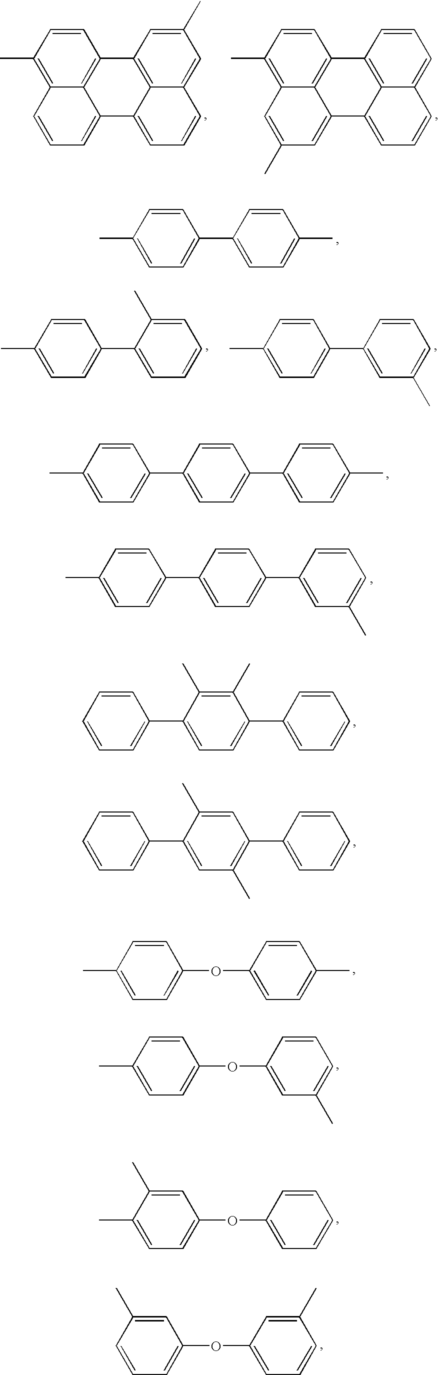

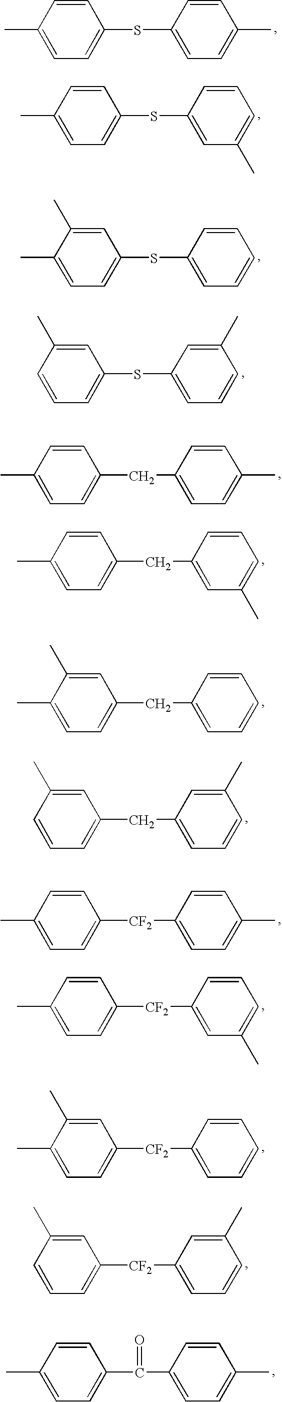

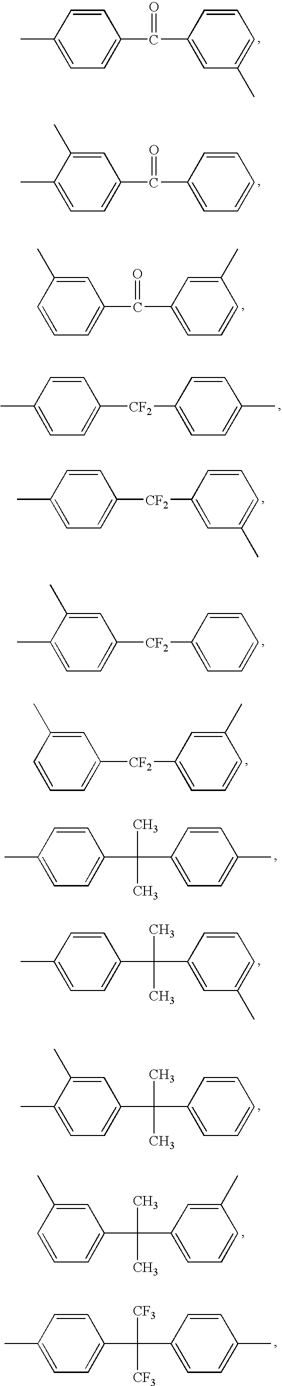

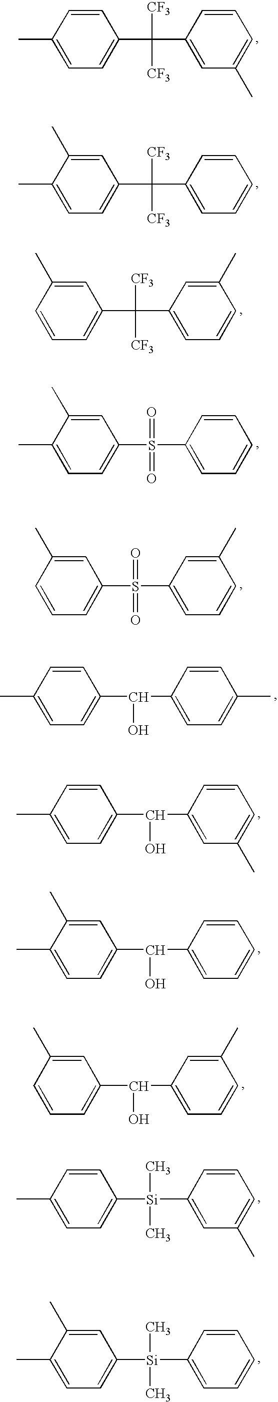

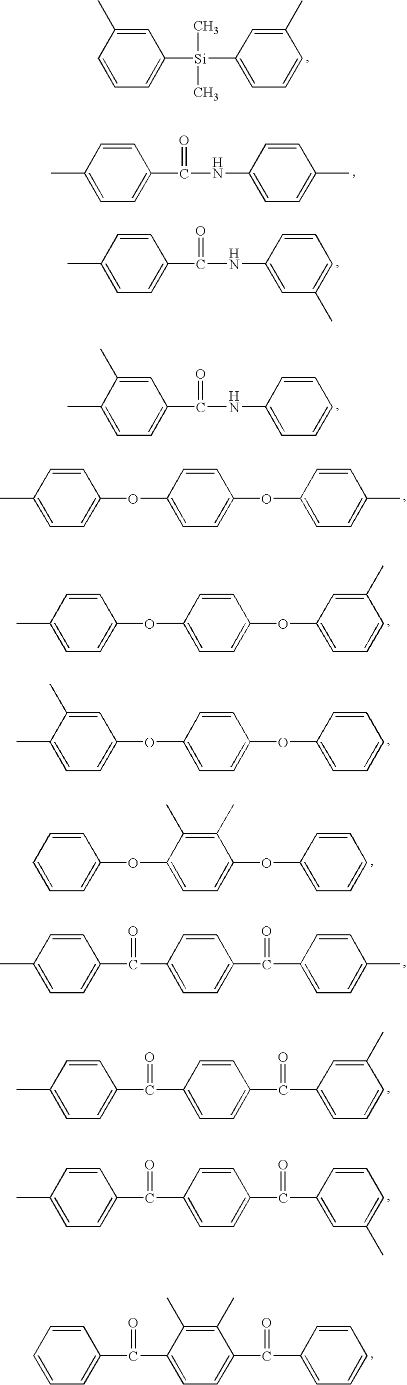

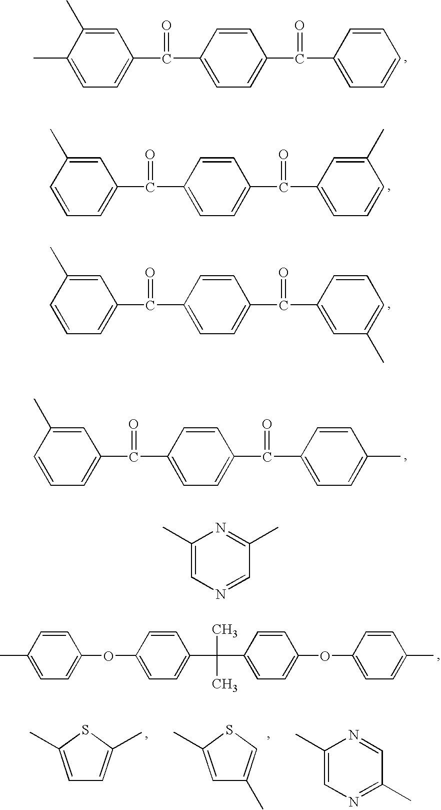

6. The dope solution composition according to claim 1, wherein Q is selected from the group consisting of CH₂, C(CH₃)₂, C(CF₃)₂, O, S, S(═O)₂ and C(═O).

7. The dope solution composition according to claim 1, wherein Ar₁ is 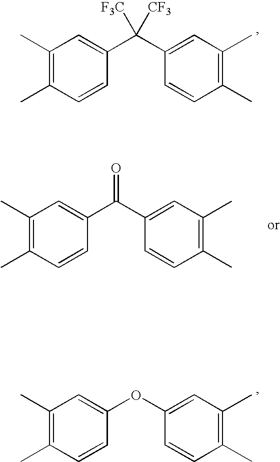
Ar₂ is 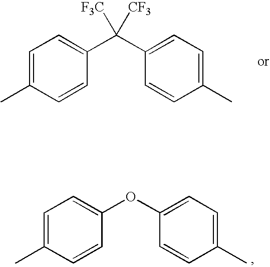
and Q is C(CF₃)₂.

8. The dope solution composition according to claim 1, wherein the copolymerization ratio (m:l) of the copolymers of Formulae 5 to 18 is from 0.1:9.9 to 9.9:0.1.

9. The dope solution composition according to claim 1, wherein the dope solution composition comprises 5 to 45% by weight of the polymer for forming a hollow fiber, 25 to 94% by weight of the organic solvent and 0.5 to 40% by weight of the additive.

10. The dope solution composition according to claim 1, wherein the organic solvent is selected from the group consisting of dimethyl sulfoxide, N-methyl-2-pyrrolidone, N-methylpyrrolidone, N,N-dimethylformamide, N,N-dimethyacetamide, γ-butyrolactone, cyclohexanone, 3-hexanone, 3-heptanone, 3-octanone and mixtures thereof.

11. The dope solution composition according to claim 1, wherein the additive is selected from the group consisting of: water; alcohols including methanol, ethanol, 2-methyl-1-butanol, 2-methyl-2-butanol, glycerol, ethylene glycol, diethylene glycol, and propylene glycol; ketones including acetone and methyl ethyl ketone; polymers including polyvinylalcohol, polyacrylic acid, polyacrylamide, polyethylene glycol, polypropylene glycol, chitosan, chitin, dextran and polyvinylpyrrolidone; and salts including lithium chloride, sodium chloride, calcium chloride, lithium acetate, sodium sulfate and sodium hydroxide; tetrahydrofuran; trichloroethane; and mixtures thereof.

12. A method for preparing a hollow fiber comprising:
(S1) spinning the dope solution composition according to claim 1 to prepare a polyimide hollow fiber;
(S2) thermal-treating the polyimide hollow fiber to induce intramolecular and intermolecular rearrangement and obtain a hollow fiber comprising one selected from polymers represented by the following Formulae 19 to 32 and copolymers thereof. 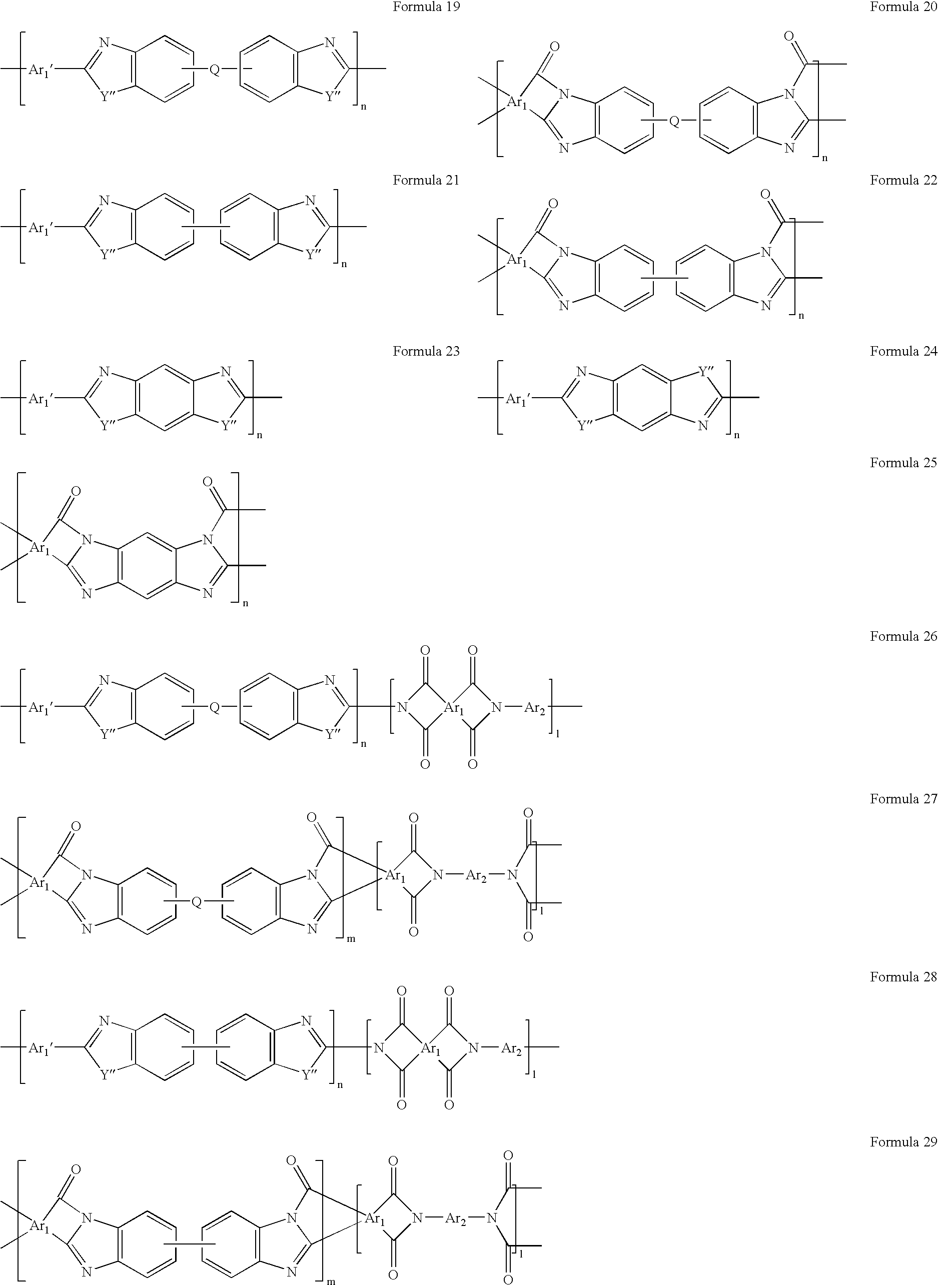 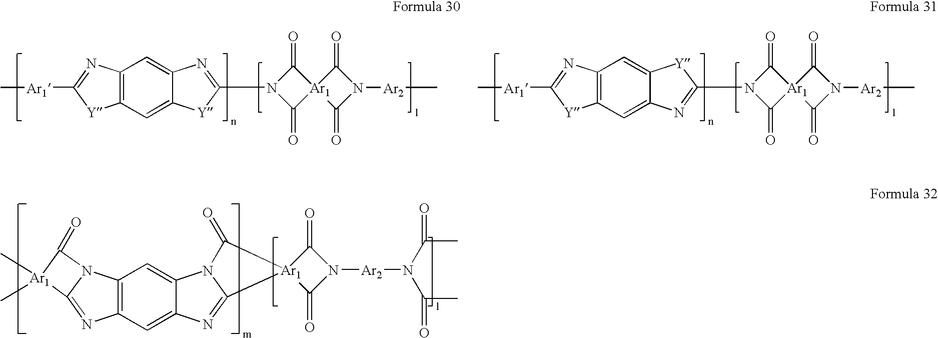
In Formulae 19 to 32,
Ar₁ is a tetravalent C₅-C₂₄ arylene group or a tetravalent C₅-C₂₄ heterocyclic ring, which is substituted or unsubstituted with at least one substituent selected from the group consisting of C₁-C₁₀ alkyl, C₁-C₁₀ alkoxy, C₁-C₁₀ haloalkyl and C₁-C₁₀ haloalkoxy, or two or more of which are fused together to form a condensation ring or covalently bonded to each other via a functional group selected from the group consisting of O, S, C(═O), CH(OH), S(═O)₂, Si(CH₃)₂, (CH₂)ₚ (in which 1≦p≦110), (CF₂)_{q} (in which 1≦q≦10), C(CH₃)₂, C(CF₃)₂ and C(═O)NH;
Ar₁′ and Ar₂ are identical to or different from each other and are each independently a bivalent C₅-C₂₄ arylene group or a bivalent C₅-C₂₄ heterocyclic ring, which is substituted or unsubstituted with at least one substituent selected from the group consisting of C₁-C₁₀ alkyl, C₁-C₁₀ alkoxy, C₁-C₁₀ haloalkyl and C₁-C₁₀ haloalkoxy, or two or more of which are fused together to form a condensation ring or covalently bonded to each other via a functional group selected from the group consisting of O, S, C(═O), CH(OH), S(═O)₂, Si(CH₃)₂, (CH₂)ₚ (in which 1≦p≦10), (CF₂)_{q} (in which 1≦q≦10), C(CH₃)₂, C(CF₃)₂ and C(═O)NH;
Q is O, S, C(═O), CH(OH), S(═O)₂, Si(CH₃)₂, (CH₂)ₚ (in which 1≦p≦110), (CF₂)_{q} (in which 1≦q≦10), C(CH₃)₂, C(CF₃)₂, C(═O)NH, C(CH₃)(CF₃), C₁-C₆ alkyl-substituted phenyl or C₁-C₆ haloalkyl-substituted phenyl in which Q is linked to opposite both phenyl rings in the position of m-m, m-p, p-m or p-p;
Y″ is —O or S;
n is an integer from 20 to 200;
m is an integer from 10 to 400; and
l is an integer from 10 to 400.

13. The method according to claim 12, wherein in the step S1, the spinning is dry-jet-wet spinning or wet-spinning.

14. The method according to claim 12, wherein in the step S2, the thermal-treating is carried out under an inert atmosphere at 350 to 500° C. for 1 minute to 12 hours.

15. The method according to claim 12, wherein in the step S2, the thermal-treating is carried out under an inert atmosphere at 400 to 450° C. for 10 minutes to 2 hours.

16. The method according to claim 12, wherein the polymers represented by Formulae 1 to 18 are obtained by imidizing polyhydroxyamic acid represented by Formulae 33 to 50 below: 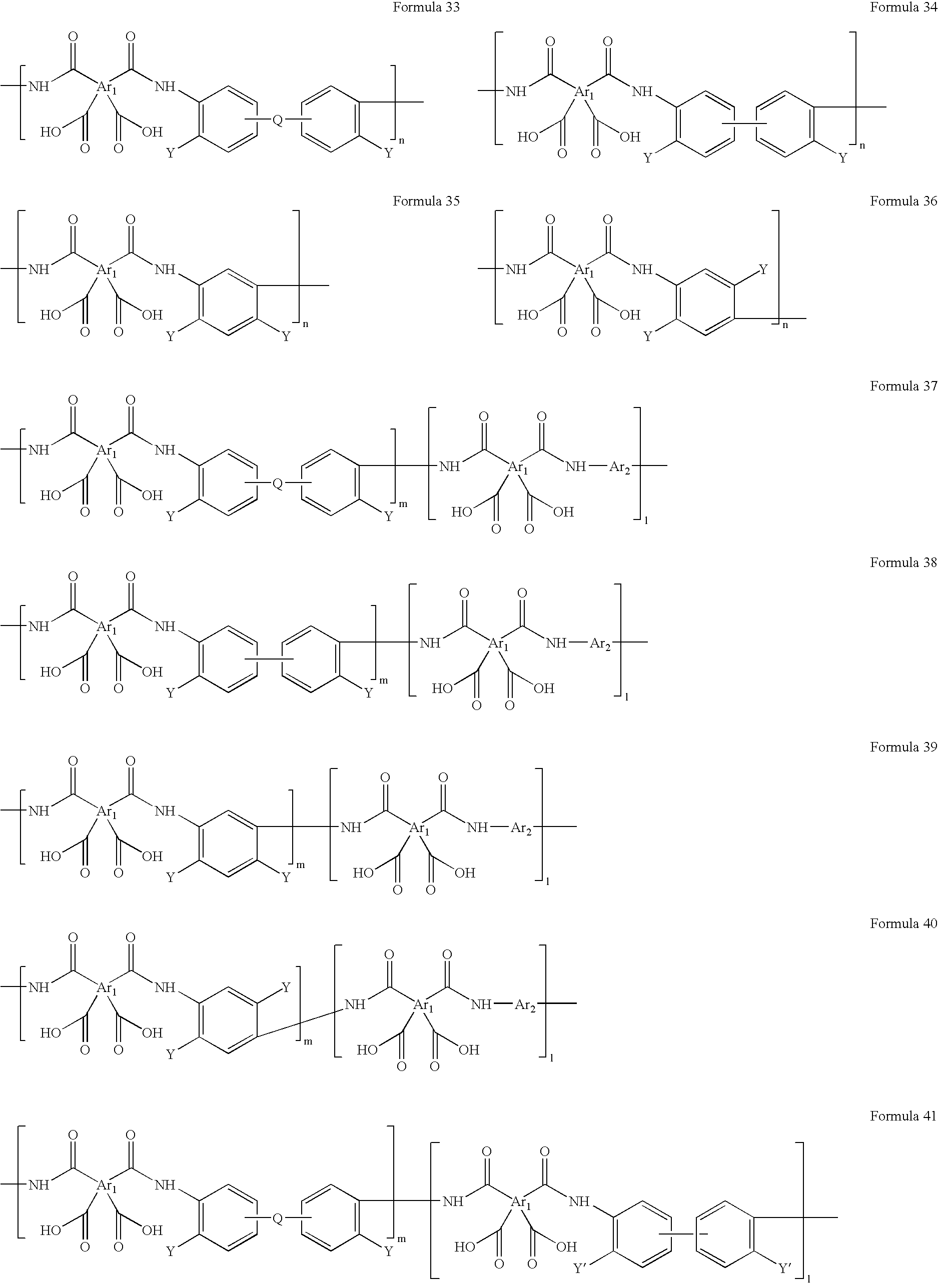 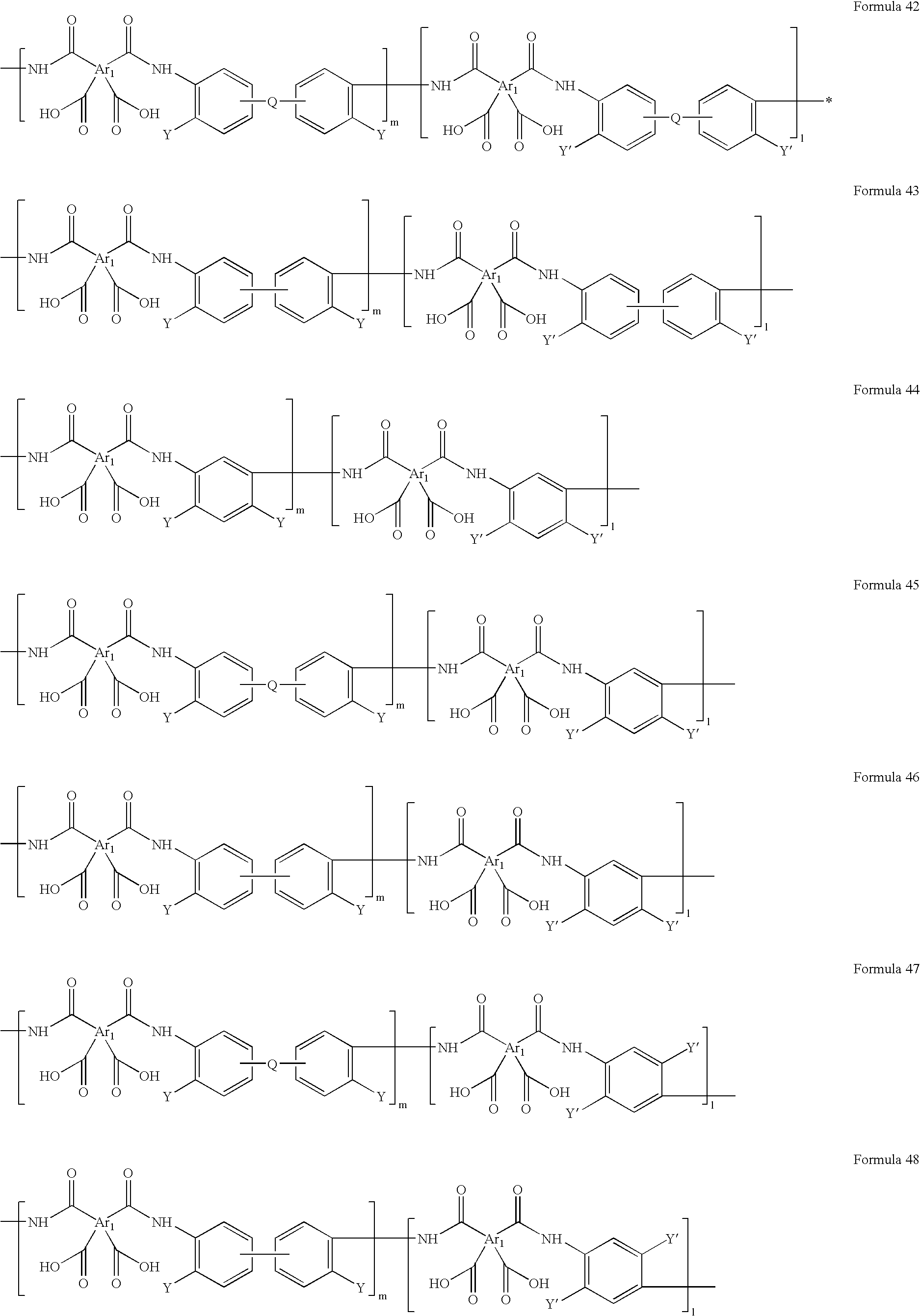 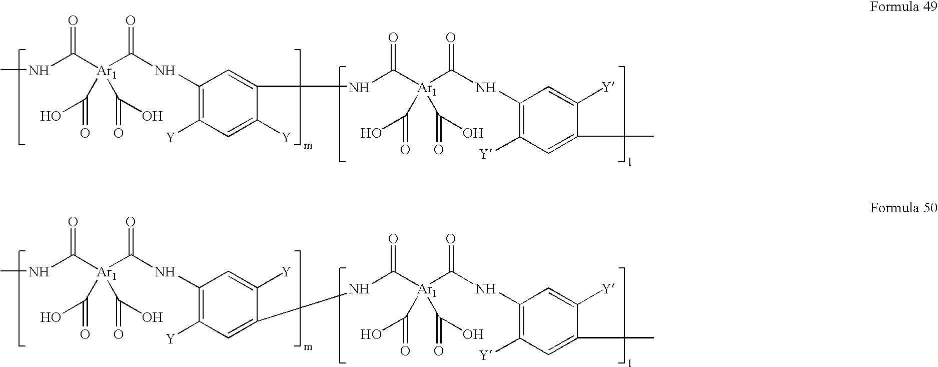
In Formulae 33 to 50,
Ar₁, Ar₂, Q, Y, n, m and l are defined as above; and
Y′ is different from Y and is —OH, —SH or —NH₂.

17. The method according to claim 16, wherein the imidization is chemical imidization or solution-thermal imidization.

18. The method according to claim 17, wherein the chemical imidization is carried out at 60 to 180° C. for 1 to 48 hours.

19. The method according to claim 17, wherein the solution-thermal imidization is carried out at 150 to 250° C. for 1 to 48 hours in solution.

20. The method according to claim 12, wherein the method comprises:
a1) preparing a polyimide dope solution composition according to claim 1;
a2) bringing the dope solution composition into contact with an internal coagulant and spinning the composition in air, while coagulating an inside of hollow fiber, to form a polyimide hollow fiber;
a3) coagulating the hollow fiber in a coagulation bath;
a4) washing the hollow fiber with a cleaning solution, followed by drying; and
a5) thermally treating the polyimide hollow fiber.

21. The method according to claim 20, wherein the spinning is carried out at a spinning temperature of 5 to 120° C. and a spinning rate of 5 to 100 m/min.

22. The method according to claim 20, wherein the coagulation bath has a temperature of 0 to 50° C.

23. The method according to claim 20, wherein the internal coagulant has a flow rate of 1 to 10 ml/min.

24. A hollow fiber comprising one selected from polymers represented by Formulae 19 to 32 and copolymers thereof: 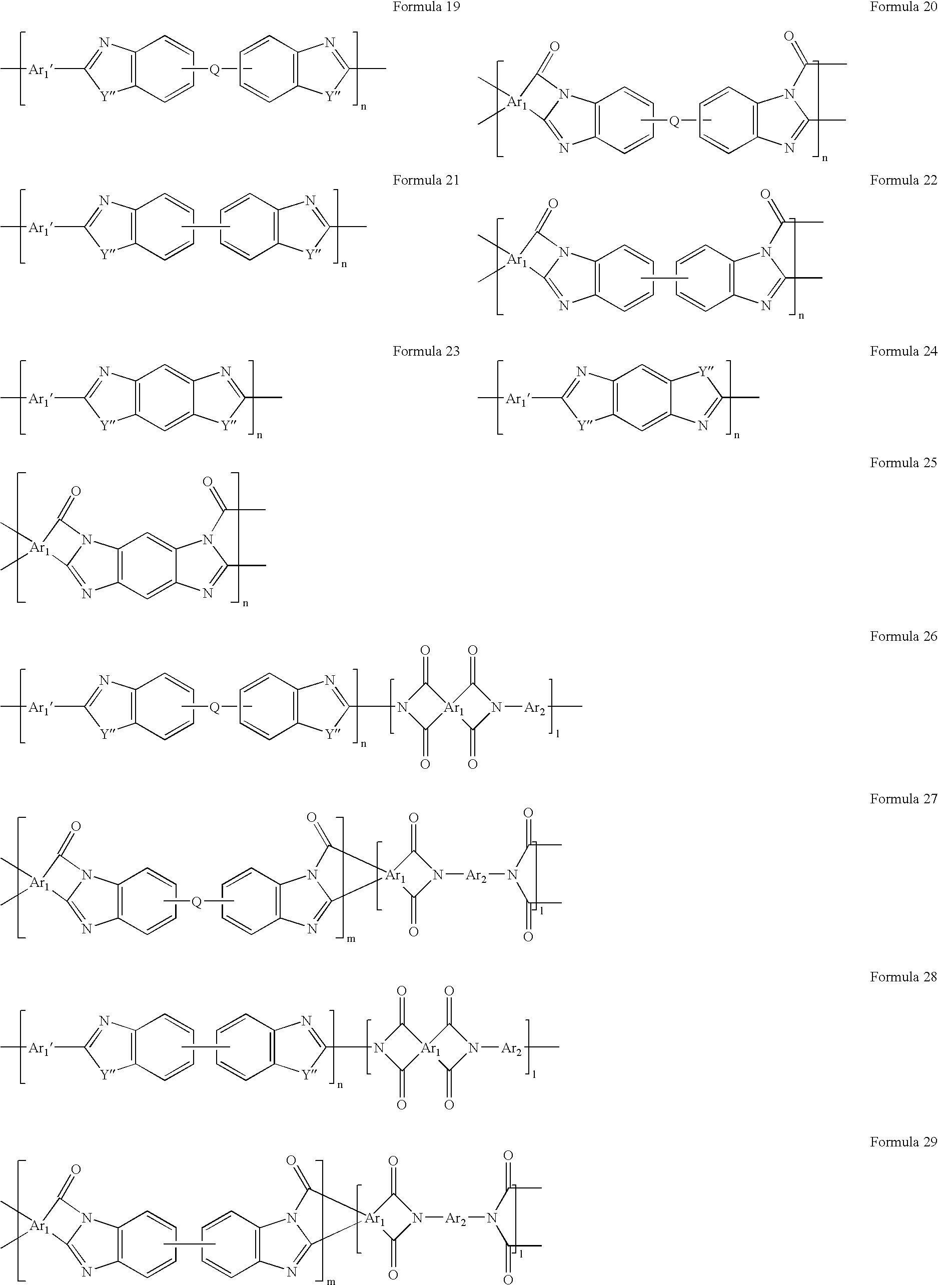 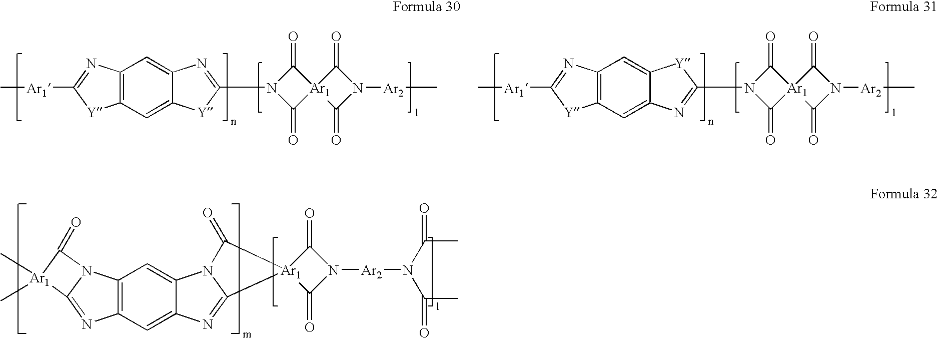
In Formulae 19 to 32,
Ar₁ is a tetravalent C₅-C₂₄ arylene group or a tetravalent C₅-C₂₄ heterocyclic ring, which is substituted or unsubstituted with at least one substituent selected from the group consisting of C₁-C₁₀ alkyl, C₁-C₁₀ alkoxy, C₁-C₁₀ haloalkyl and C₁-C₁₀ haloalkoxy, or two or more of which are fused together to form a condensation ring or covalently bonded to each other via a functional group selected from the group consisting of O, S, C(═O), CH(OH), S(═O)₂, Si(CH₃)₂, (CH₂)ₚ (in which 1≦p≦110), (CF₂)_{q} (in which 1≦q≦10), C(CH₃)₂, C(CF₃)₂ and C(═O)NH;
Ar₁′ and Ar₂ are identical to or different from each other and are each independently a bivalent C₅-C₂₄ arylene group or a bivalent C₅-C₂₄ heterocyclic ring, which is substituted or unsubstituted with at least one substituent selected from the group consisting of C₁-C₁₀ alkyl, C₁-C₁₀ alkoxy, C₁-C₁₀ haloalkyl and C₁-C₁₀ haloalkoxy, or two or more of which are fused together to form a condensation ring or covalently bonded to each other via a functional group selected from the group consisting of O, S, C(═O), CH(OH), S(═O)₂, Si(CH₃)₂, (CH₂)ₚ (in which 1≦p≦10), (CF₂)_{q} (in which 1≦q≦10), C(CH₃)₂, C(CF₃)₂ and C(═O)NH;
Q is O, S, C(═O), CH(OH), S(═O)₂, Si(CH₃)₂, (CH₂)ₚ (in which 1≦p≦110), (CF₂)_{q} (in which 1≦q≦10), C(CH₃)₂, C(CF₃)₂, C(═O)NH, C(CH₃)(CF₃), C₁-C₆ alkyl-substituted phenyl or C₁-C₆ haloalkyl-substituted phenyl in which Q is linked to opposite both phenyl rings in the position of m-m, m-p, p-m or p-p;
Y″ is —O or S;
n is an integer from 20 to 200;
m is an integer from 10 to 400; and
l is an integer from 10 to 400.

25. The hollow fiber according to claim 24, wherein Ar₁ is selected from the following compounds: 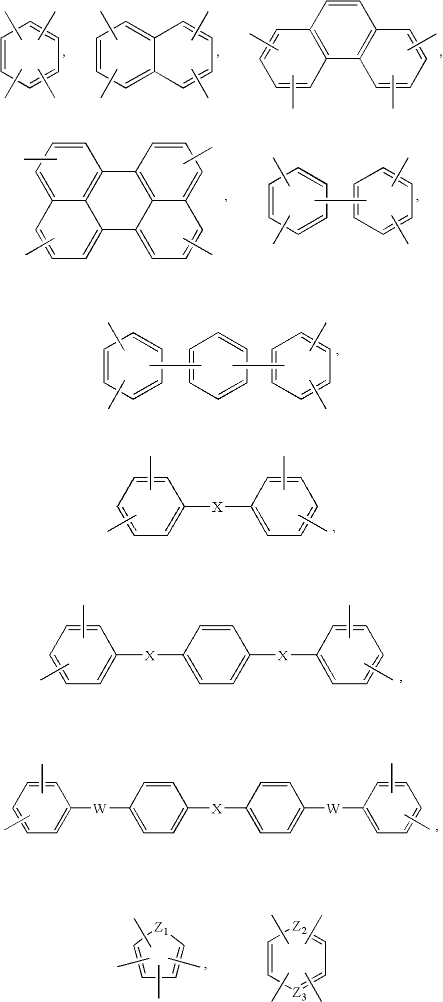
wherein X is O, S, C(═O), CH(OH), S(═O)₂, Si(CH₃)₂, (CH₂)ₚ (in which 1≦p≦110), (CF₂)_{q} (in which 1≦q≦10), C(CH₃)₂, C(CF₃)₂, or C(═O)NH; W is O, S or C(═O); and Z₁, Z₂ and Z₃ are identical to or different from each other and are 0, N or S.

26. The hollow fiber according to claim 24, wherein Ar₁ is selected from the following compounds:

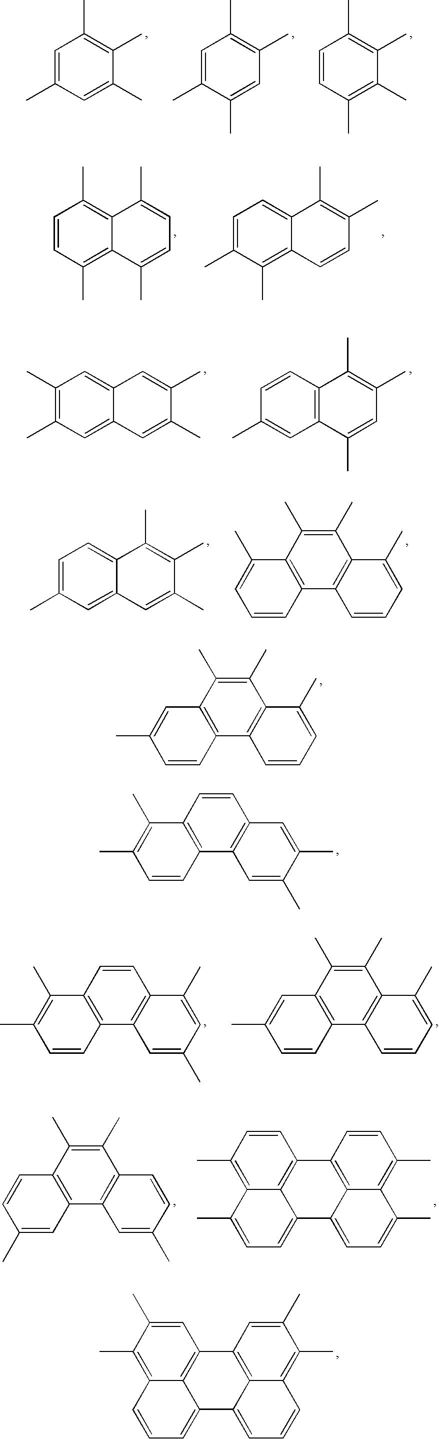

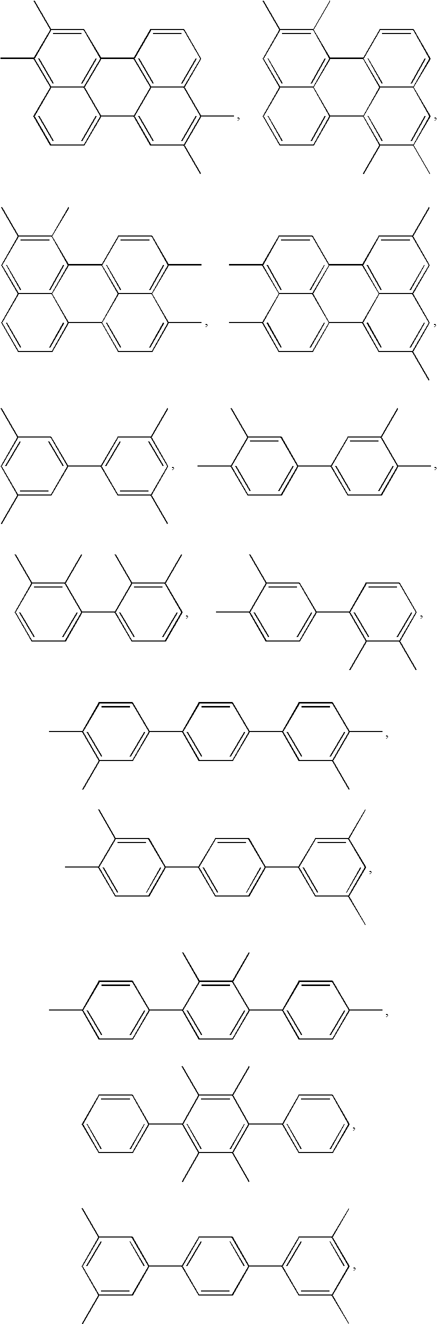

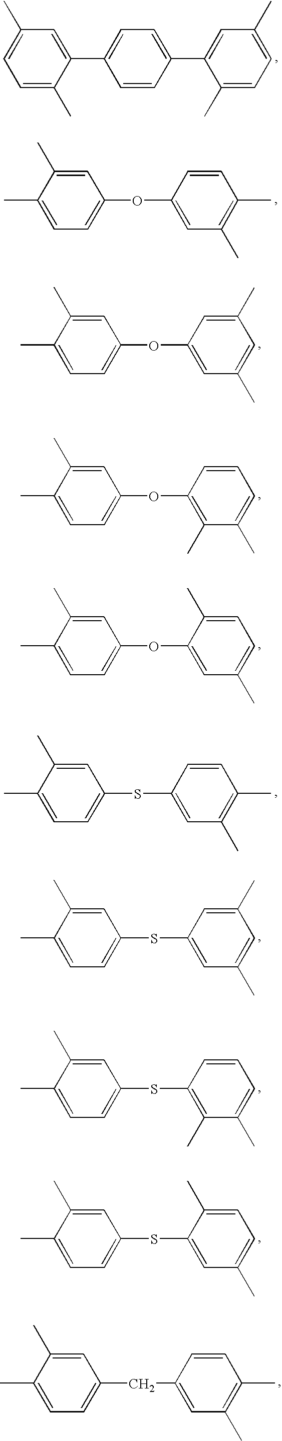

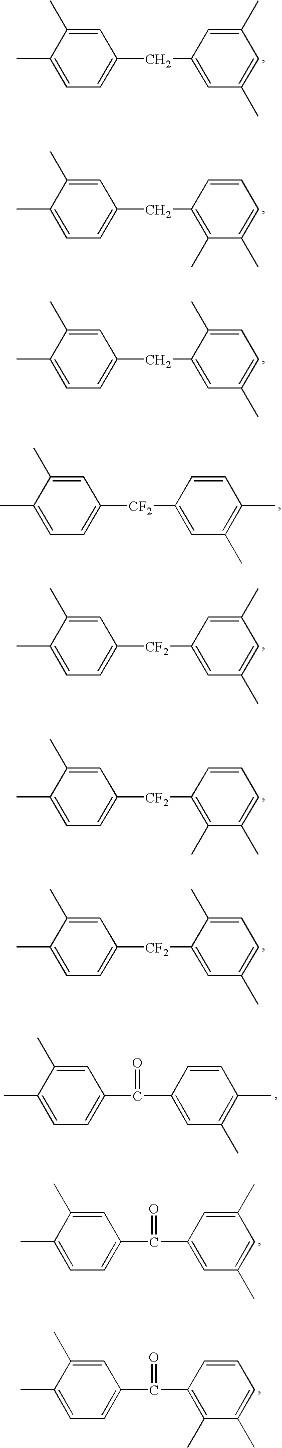

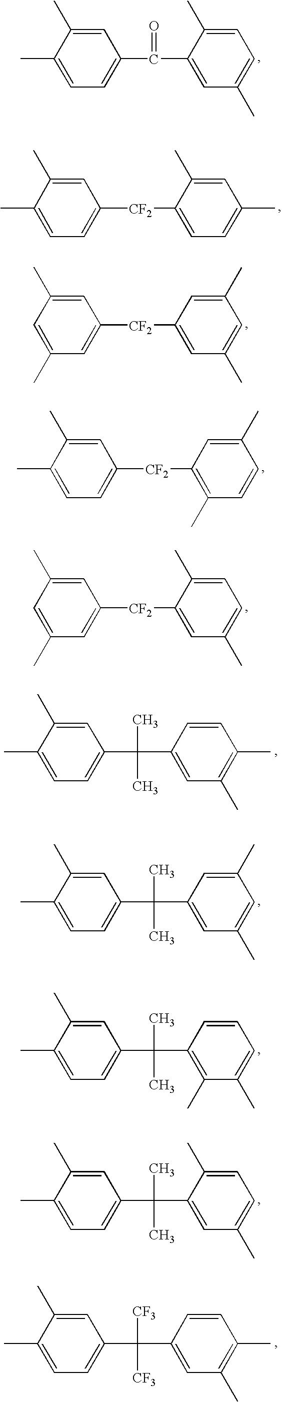

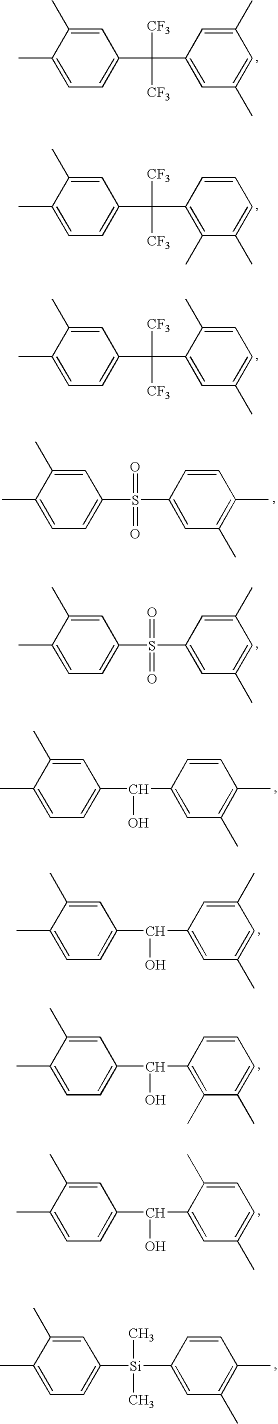

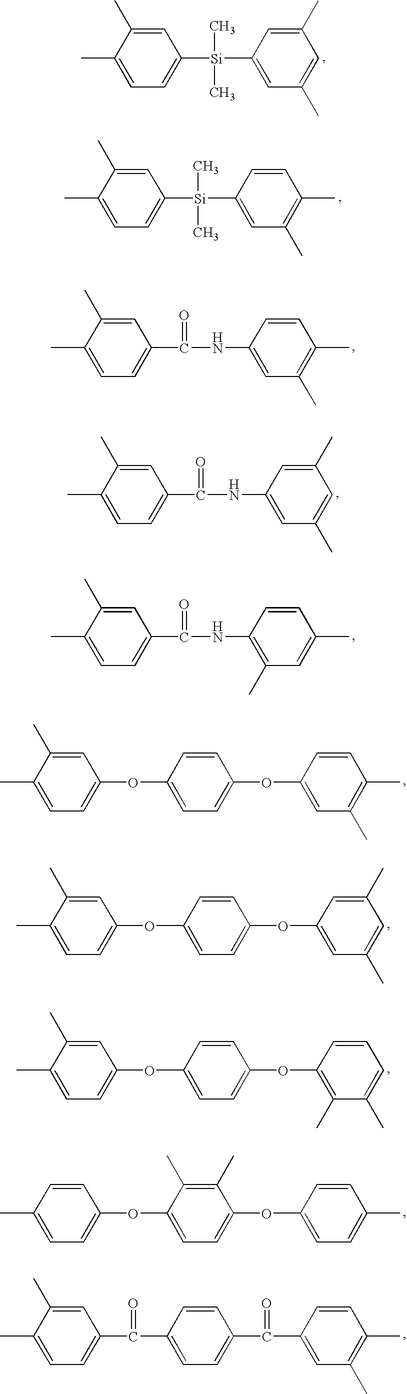

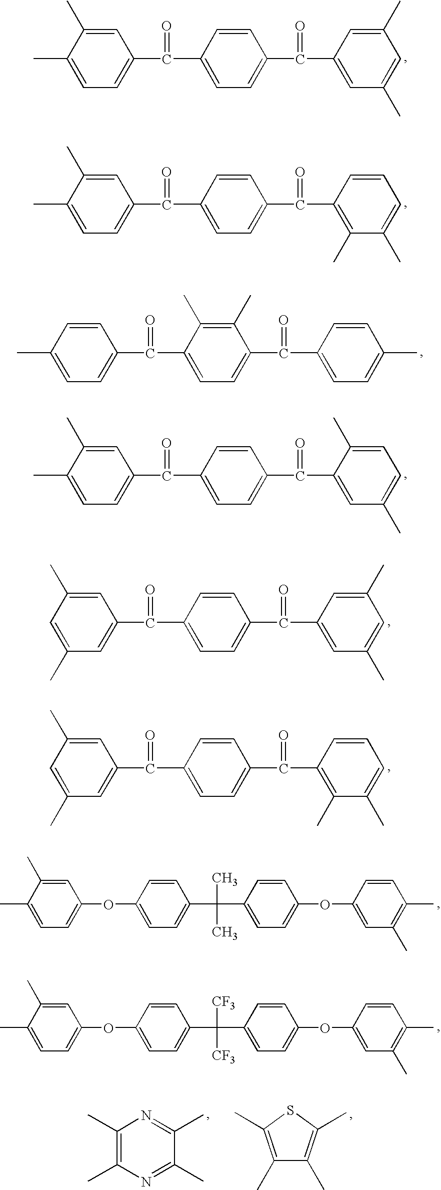

27. The hollow fiber according to claim 24, wherein Ar₁′ and Ar₂ are selected from the following compounds: 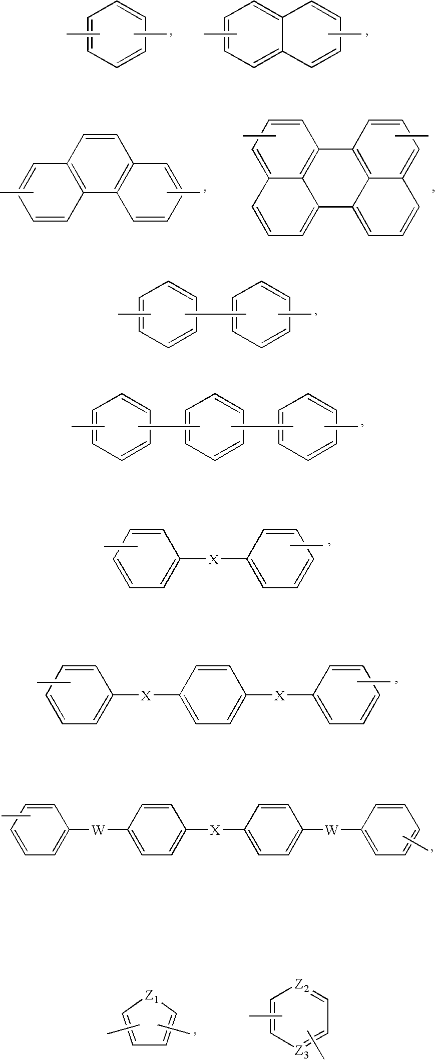
wherein X is O, S, C(═O), CH(OH), S(═O)₂, Si(CH₃)₂, (CH₂)ₚ (in which 1≦p≦110), (CF₂)_{q} (in which 1≦q≦10), C(CH₃)₂, C(CF₃)₂, or C(═O)NH; W is O, S or C(═O); and Z₁, Z₂ and Z₃ are identical to or different from each other and are O, N or S.

28. The hollow fiber according to claim 24, wherein Ar₁′ and Ar₂ are selected from the following compounds:

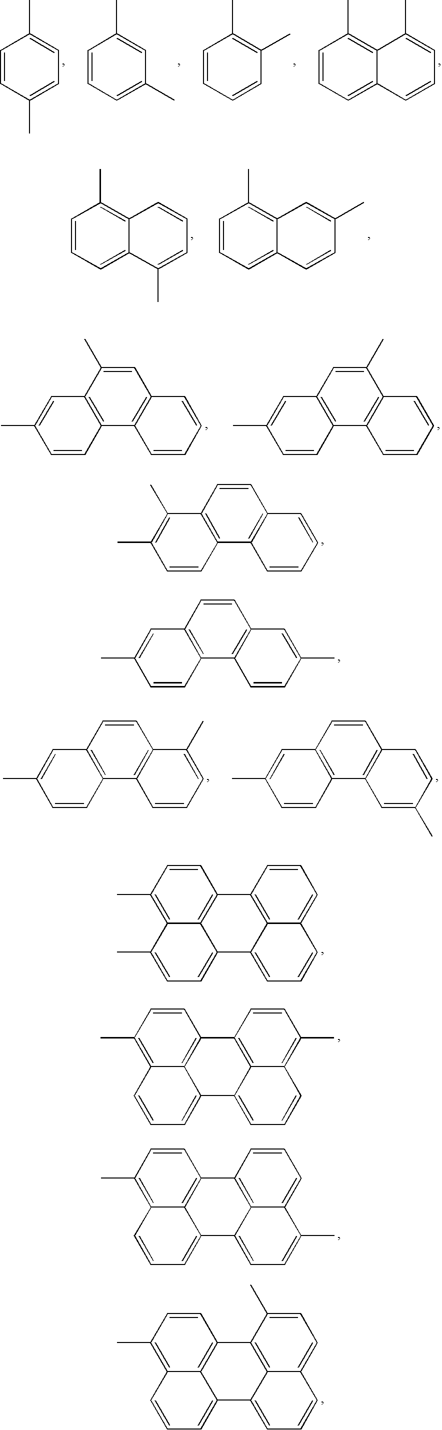

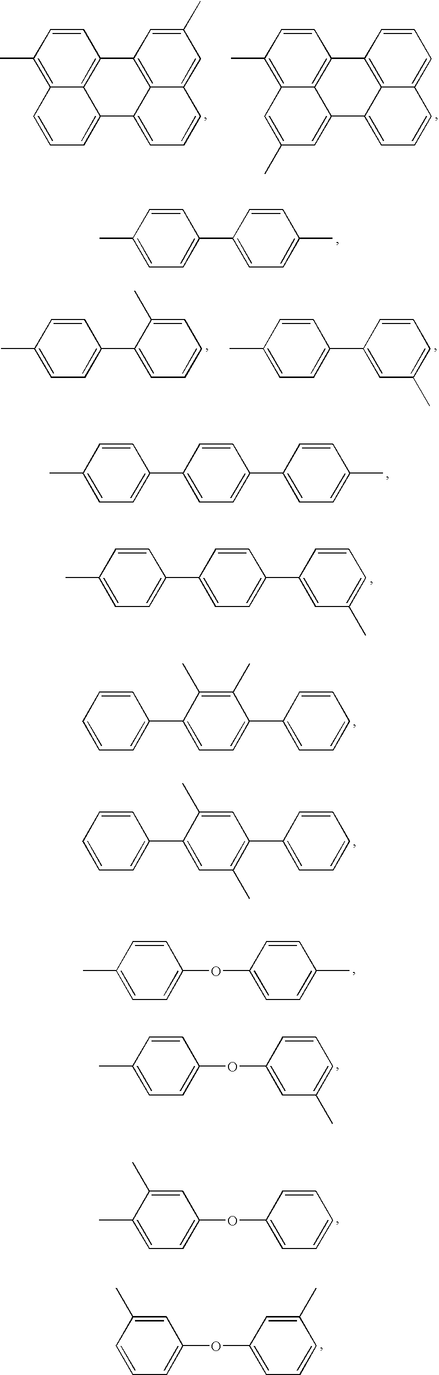

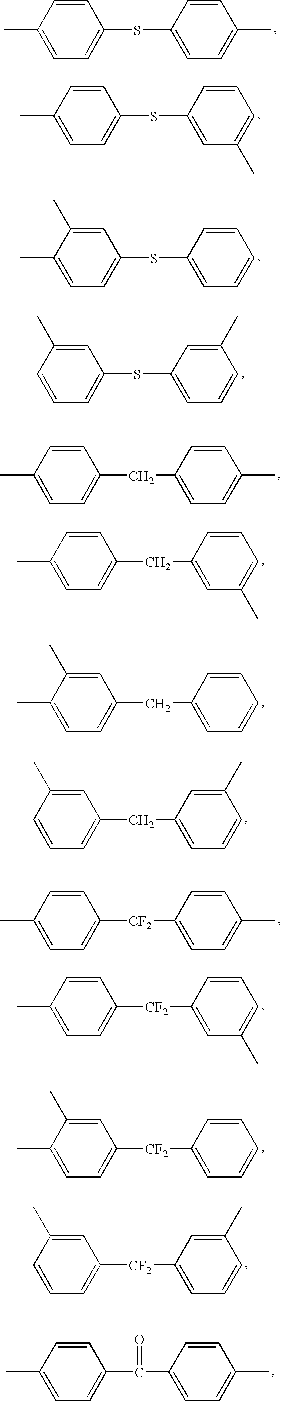

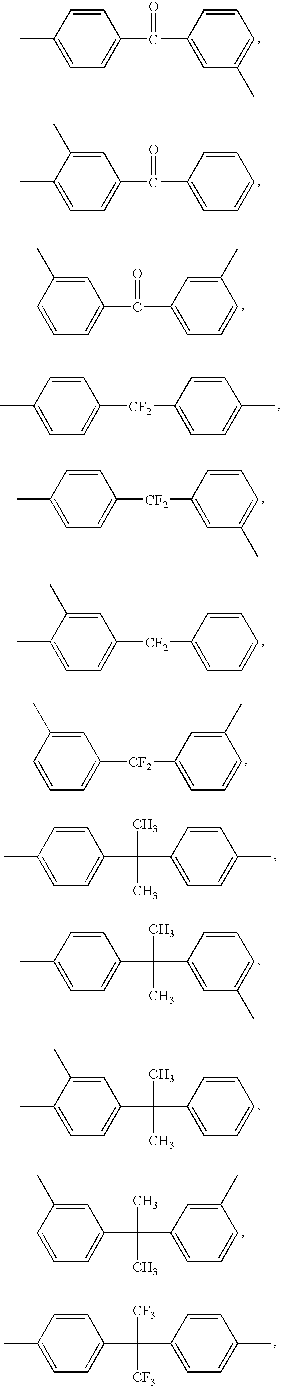

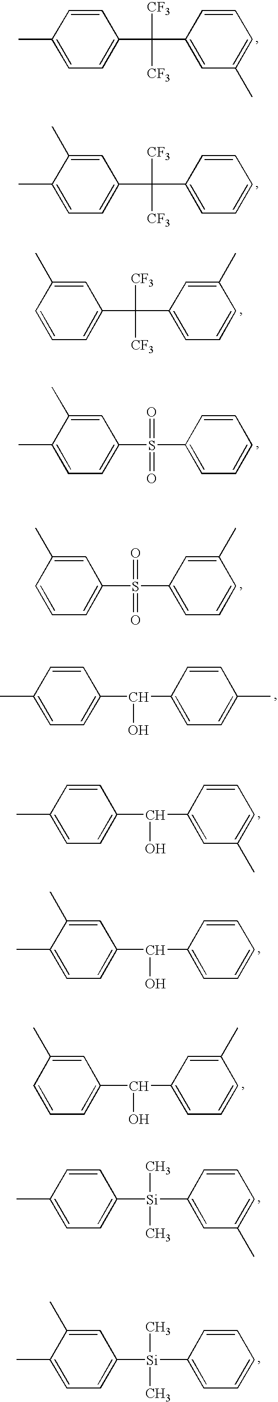

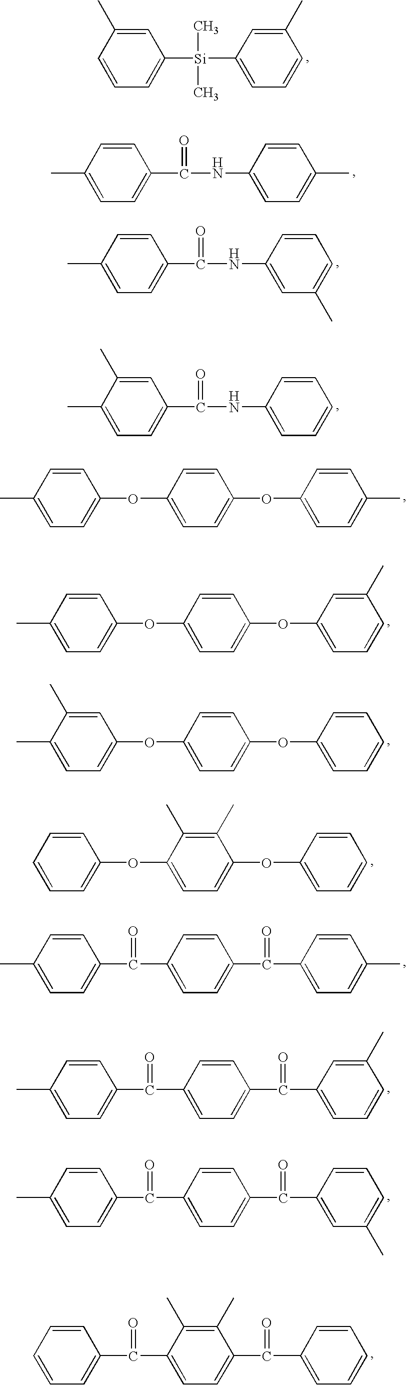

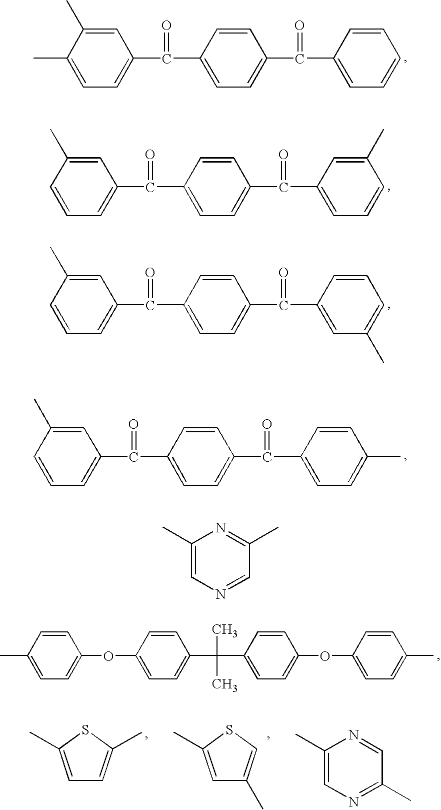

29. The hollow fiber according to claim 24, wherein Q is selected from the group consisting of CH₂, C(CH₃)₂, C(CF₃)₂, O, S, S(═O)₂ and C(═O).

30. The hollow fiber according to claim 24, wherein Ar₁ is 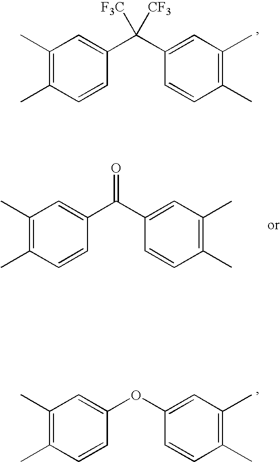
Ar₁′ is 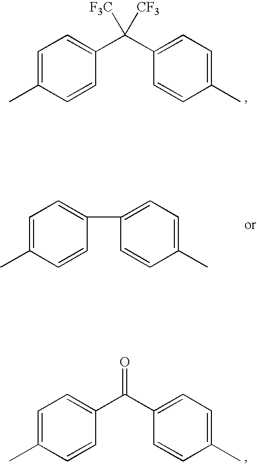
Ar₂ is 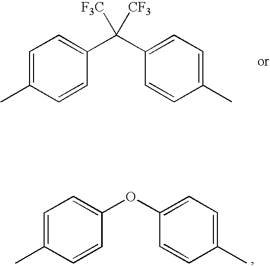
and Q is C(CF₃)₂.

31. The hollow fiber according to claim 24, wherein the hollow fiber is used as a gas separation membrane for separation of mixed gas pair of H₂/N₂, H₂/CH₄, H₂/O₂, H₂/CO₂, O₂/CO₂, N₂/CH₄, O₂/N₂, CO₂/CH₄ and CO₂/N₂.

32. The hollow fiber according to claim 24, wherein the hollow fiber has O₂/N₂ selectivity of 3 or higher and CO₂/CH₄ selectivity of 20 or higher.

33. The hollow fiber according to claim 24, wherein the hollow fiber has O₂/N₂ selectivity of 3 to 30 and CO₂/CH₄ selectivity of 20 to 100.
